(19) United States
(12) Patent Application Publication
(10) Pub. No.: US 2007/0156625 A1
(43) Pub. Date: Jul. 5, 2007

(54) METHOD FOR MOVIE ANIMATION

(75) Inventor: THOMAS A. VISEL, AUSTIN, TX (US)

Correspondence Address: HOWISON & ARNOTT, L.L.P, P.O. BOX 741715, DALLAS, TX, 75374-1715, US

(73) Assignee: NEURIC TECHNOLOGIES, LLC, HOUSTON, TX (US)

(21) Appl. No.: 11/670,959

(22) Filed: Feb. 2, 2007

Related U.S. Application Data
(63) Continuation-in-part of application No. 11/425,688, filed on Jun. 21, 2006.
Application No. 11/425,688 is a continuation of application No. 11/030,452, filed on Jan. 6, 2005, now abandoned.
(60) Provisional application No. 60/534,641, filed on Jan. 6, 2004.
(60) Provisional application No. 60/534,492, filed on Jan. 6, 2004.
(60) Provisional application No. 60/534,659, filed on Jan. 6, 2004.

(51) Int. Cl. G06N 5/00

(52) U.S. Cl. 706/62; 706/45

(57) ABSTRACT

A method for modeling human emotion for emulating human behavior, comprising the steps of recognizing the existence of a condition capable of being sensed at least in the abstract in a surrounding environment in which the human behavior is emulated. A first step comprises representing a plurality of human emotions, each with a temporally varying emotion level. A second step comprises representing the condition as having a predetermined relationship with respect to one or more of a linked one of the plurality of human emotions, the predetermined relationship defining the effect that the recognized existence of the condition will have on the linked one or more of the plurality of human emotions. The step of recognizing results in a temporal change to the temporally varying emotion level of the linked one of the plurality of human emotions, such that the presence of conditions in the surrounding environment is reflected in the temporally varying emotion levels of one or more of the represented human emotions. Thereafter, a final step is provided for utilizing the emotion levels to parameterize the operation of a system.

### CROSS REFERENCE TO RELATED APPLICATIONS

This application is a Continuation-in-Part of pending U.S. patent application Ser. No. 11/425,688, filed Jun. 21, 2006, and entitled A METHOD FOR INCLUSION OF PSYCHOLOGICAL TEMPERAMENT IN AN ELECTRONIC EMULATION OF THE HUMAN BRAIN (Atty. Dkt. No. VISL-27,693), which is a Continuation of abandoned U.S. application Ser. No. 11/030,452, filed Jan. 6, 2005 (Atty. Dkt. No. VISL-27,019), and entitled A METHOD FOR INCLUSION OF PSYCHOLOGICAL TEMPERAMENT IN AN ELECTRONIC EMULATION OF THE HUMAN BRAIN; which and claims the benefit of U.S. Provisional Application for Patent Ser. No. 60/534,641, entitled A NEURIC BRAIN MODELING SYSTEM IN THE MILITARY ENVIRONMENT, U.S. Provisional Application for Patent Ser. No. 60/534,492, entitled METHOD FOR INCLUSION OF PSYCHOLOGICAL TEMPERAMENT IN AN ELECTRONIC EMULATION OF THE HUMAN BRAIN, U.S. Provisional Application for Patent Ser. No. 60/534,659, entitled DESIGN OF THE NEURIC BRAIN, all filed Jan. 6, 2004, now expired, U.S. Provisional Application for Patent Ser. No. 60/764,442, filed Feb. 2, 2006, and entitled USE OF THE NEURIC BRAIN MODEL IN MOVIE ANIMATION (Atty. Dkt. No. VISL-27,537.)

### TECHNICAL FIELD

The present invention pertains in general to artificial intelligence and, more particularly, to defining animation parameters to represent emotion and character movement.

### BACKGROUND

Much of cartoon creation is presently animated, particularly from the standpoint of facial features. For spoken script, the animation computer reads the English script of the cartoon's dialog and generates facial expressions, lip and jaw positions that are consistent with words being spoken and formed. Such software algorithmically translates English words into “cookbook” facial shapes in synchrony with spoken words. Artists read the animation script to create the remainder of the character movement.

Semi-automated systems as this reduce the cost and drudgery of cartoon animation, but suffer in that they don't offer automatic portrayal of emotional expression. Simple cues, such as “?” marks, allow the automated raising of eyebrows when a question is asked, but little content in simple English grammar conveys true emotion. The Neuric agent can bring this capability to the animation movie industry.

The Cost of Animation

There is considerable discussion in the movie industry of the best way to create an animated film, but the future is moving surely to digital animation. Pixar® has played a large role in this effort. For example; while films using computer animation cost as much as 40% less to make than traditional animated films, as only one-third as many staffers are needed, the budgets of Pixar's® pics are still upwards of $75 million.

The founder of Pixar® said, “These films are getting richer and richer visually. The computers are 500 times plus more powerful. Still, it takes three hours to render each frame, the same amount as ‘Luxo Jr.’” While the humans in “Toy Story 2” did look, well, human, Pixar® has no interest in creating photo-realistic animated characters.

### SUMMARY OF THE INVENTION

The present invention disclosed and claimed herein comprises a method for modeling human emotion for emulating human behavior, comprising the steps of recognizing the existence of a condition capable of being sensed at least in the abstract in a surrounding environment in which the human behavior is emulated. A first step comprises representing a plurality of human emotions, each with a temporally varying emotion level. A second step comprises representing the condition as having a predetermined relationship with respect to one or more of a linked one of the plurality of human emotions, the predetermined relationship defining the effect that the recognized existence of the condition will have on the linked one or more of the plurality of human emotions. The step of recognizing results in a temporal change to the temporally varying emotion level of the linked one of the plurality of human emotions, such that the presence of conditions in the surrounding environment is reflected in the temporally varying emotion levels of one or more of the represented human emotions. Thereafter, a final step is provided for utilizing the emotion levels to parameterize the operation of a system.

Photo-realism is not an issue in animation, but the emotion portrayed on the faces of the characters is. Regardless of whether the imagery is cartoon-like or is photo-realistic, facial expression plays an essential role in the communication of the story, and cannot be long ignored. Some representative costs are:
Toy Story: $30M and 100 animators
Lion King: $45M and 800 animators
Garfield: $35M

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a diagrammatic block diagram of the overall animation system;

FIGS. 2a and 2b illustrate a diagrammatic view of an animation sequence;

FIG. 3 illustrates Influence Inclusion—An example of weighted random influence;

FIG. 4 illustrates Implementation of the Brain Emulation—Block diagram of brain emulation;

FIG. 5 illustrates Language Grammar Sample—Example of natural language grammar description;

FIG. 6 illustrates Example Parser Diagnostic Trace—Example trace of grammar parsing;

FIG. 7 illustrates Example Relationals Between Neurons;

FIG. 8 illustrates Organization of Neuron Tables—General organization of neuron memory lists;

FIG. 9 illustrates Table of Neurons—Internal organization of a neuron;

FIG. 10 illustrates Example Relational Record—Contents of inter-neuron relationship record;

FIG. 11 illustrates Event Queue and Memory—Organization of the event processor;

FIG. 12 illustrates Content of an Event—General internal contents of an event record;

FIG. 13 illustrates A Deference Table—Example table of orders of deference;

FIG. 14 illustrates The Layered-Temperament Personality;

FIG. 15 illustrates Characteristic Traits of the Temperaments;

FIG. 16 illustrates The Four Composite Temperament Models;

FIG. 17 illustrates Typical Temperament—Weighting of Parameters;

FIG. 18 illustrates Implementation of Pressure or Trauma;

FIG. 19 illustrates Network-Connected Brain Emulation;

FIG. 20 illustrates Example Battleforce Simulation Cluster;

FIG. 21 illustrates Example Integrated Battleforce Simulation System;

FIG. 22 illustrates sample relational connections;

FIG. 23 illustrates implied relationals in linkages;

FIG. 24 illustrates the “not” relationships;

FIGS. 25a-25c illustrate a diagrammatic view of two different animation sequences utilizing the brain;

FIGS. 26a-26h illustrate the feature points in the facial muscles for an animated character;

FIG. 27 illustrates a diagrammatic view of how the emotion neurons interface with an animation engine;

FIG. 28 illustrates a diagrammatic view of one set of neurons associated with one animation sequence;

FIG. 29 illustrates a diagrammatic view of a second neuron structure for illustrating a second animation;

FIGS. 30a and 30b illustrate timing diagrams for activating both the emotion neuron and the display as a function of the triggering of other neurons;

FIG. 31 illustrates a diagrammatic view of the summation of multiple inputs to a single neuron;

FIG. 31 a illustrates a diagrammatic view of a sequence of triggering events;

FIG. 32 illustrates some typical relational links to an emotional neuron;

FIG. 33 illustrates a timing diagram for the neural structure of FIG. 32;

FIG. 34 illustrates a flow chart for one animation sequence prior to gaining experience;

FIG. 35 illustrates a flow chart for the operation of FIG. 34 with experience;

FIG. 36 illustrates a diagrammatic view of a neuron after construction;

FIG. 37 illustrates a detail of the expectation or anticipation of the neuron of FIG. 36;

FIG. 38 illustrates a diagrammatic view of the concept of an example physical threat;

FIG. 39 illustrates a sequence of events illustrating the evasion animation;

FIG. 40 illustrates a flow chart for viewing new object in environment;

FIG. 41 illustrates a task list for moving ahead in response to perceiving new objects;

FIG. 42 illustrates a flow chart for assessing a threat in the character's environment;

FIG. 43 illustrates a flow chart depicting the task list for evading a threat;

FIG. 44 illustrates the RTC flow;

FIG. 45 illustrates the master state machine;

FIG. 46 illustrates the FSM Decision Process;

FIG. 47 illustrates the FSM implication;

FIG. 48 illustrates the FSM Resolve State Machine;

FIG. 49 illustrates the FSM Sensory Input State Machine; and

FIG. 50 illustrates the Threat Assessment Flow.

### DETAILED DESCRIPTION

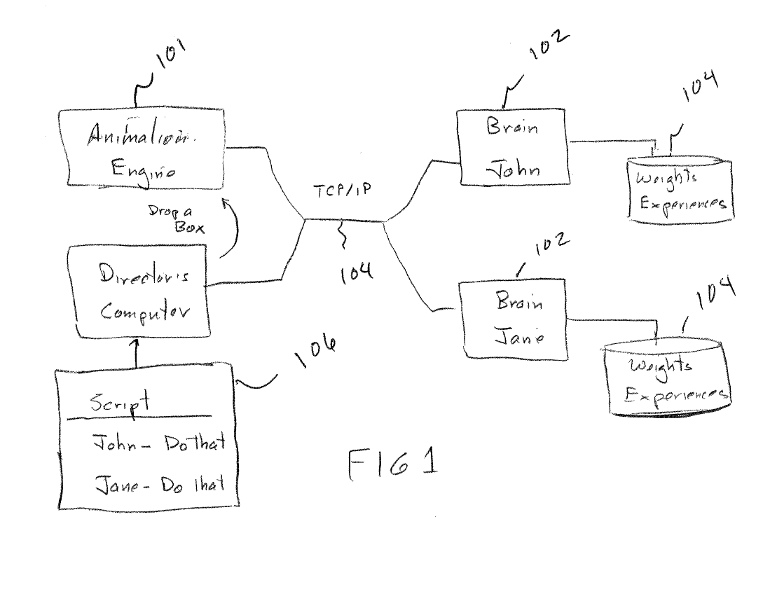

Referring now to FIG. 1, there is illustrated an overall diagrammatic view of the system of the present disclosure. This system is directed toward the concept of controlling an animation engine with an animation engine 101 through the use of central animation brains 102, one associated with a first character named “John” and with a second character named “Jane.” Each of these brains 102, as will be described in more detail herein below, is capable of being trained to express emotion, that emotion being translated into control signals that can be put into the animation engine 101. A communication path 104 is provided for communicating information from each of the brains 102 over to the animation engine 101. This communication path can be any type of communication path, such as a TCP/IP protocol. Of course, it is well understood that any type of communication path can be utilized. Each of the brains 102, after training, will have a character, this character being defined in a memory system 104 associated with each of the characters. In these memories is contained various experiences of the particular character and various weights. These are trained and adaptable. During the generation of the animation, the entire animation is controlled by a director who may tweak the script. The screen-writer's material that is defined in a script 106 basically instructs the particular brain or character to do a particular action or instructs an input to occur in the animation engine 101. For example, as will be described in more detail herein below, the animation engine 101 can be directed to drop a box in close proximity to a particular character. This essentially is in the “virtual world” of the particular character. This action can then be interpreted by the brain and experience is gained from that action through these various inputs. As will be described herein below, this action in the animation engine 101 can elicit various emotional responses, which emotional responses are in direct response to the environmental changes within this virtual world proximate to the character which will then cause the brain to generate outputs to express emotion, this being facilitated by the animation engine.

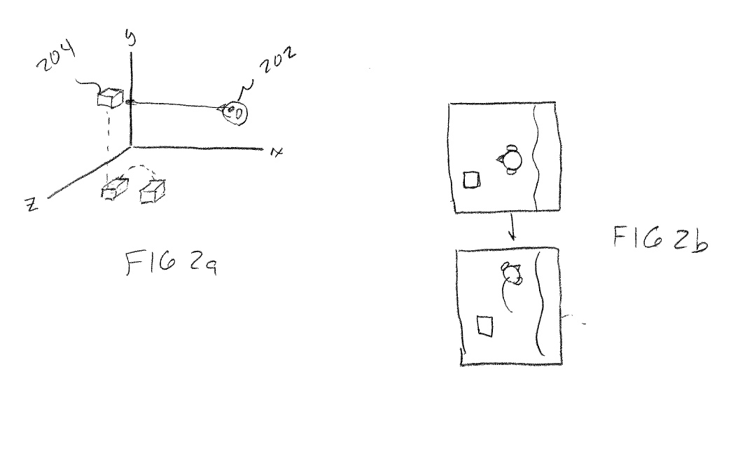

Referring now to FIGS. 2a and 2b, there is illustrated a very simplistic concept of this animation sequence. A character 202 is provided in the virtual world defined as a series of vertices in the x, y and z direction. The character 202 is basically a character that can be represented through various concepts, but has a positional relationship with respect to the environment. There will be a head which can rotate in all directions which will have perception points, those perception points being, for example, the eyes, the nose and the mouth and even the ears. In this example, only the concept of vision will be described. Therefore, there will be two points in the virtual space that represent the vision. These points can be rotated by rotating the head in an animation sequence such that they are oriented in the direction of an object, for example, a falling box 204. The falling box is illustrated as falling from an upper level, down to a surface, and then bouncing. As will be described herein below, the character 202 is animated to recognize the box, move its head to view the box and follow the box to the upper location to the lower location and as it bounces. Further, as will be described herein below, there will be emotion expressed as a result of seeing the box and any actions that may occur with respect to the box in the environment of the individual. FIG. 2b illustrates a situation wherein the individual is aware of the box in the personal environment and in proximity thereto. And, after seeing the box, viewing the box as a threat. Once the box is viewed as a threat, it can be seen that the character, in the lower portion of FIG. 2b, is placed into an animation sequence wherein the character will evade the box and move away from the box to a potentially safe area. As noted, this will be described in more detail herein below.

Core Brain

The central brain of the present disclosure distills the temperament, personality and instantaneous state of a human individual into a series of Brain Parameters. Each of these has a value varying from zero to 100 percent, and is loosely equivalent to a single neuron. These parameters collectively define the state of the person's being and specify matters of temperament and personality. Some parameters are fixed and seldom if ever change, while others change dynamically with present conditions.

Relationships between parameters, if any, are pre-established. The Parameters are connected with the rest of the brain model in such a manner as to alter the decision processes, decision thresholds and the implied personal interests of the underlying model they become a part of.

The exact list of Parameters and their definitions are not germane to the system of the present disclosure, and may include more or fewer parameters in any given implementation thereof. Numerous parameters define certain tendencies specific to certain temperaments. Some define the present emotional state, such as sense of confidence in a decision. Others are place-holders that define such things as the present topic of conversation or who the first, second or third persons in the conversation are. Yet others define physical parameters such as orientation within the environment, sense of direction, timing and the like.

Some brain Parameters may be loosely arranged in a hierarchical fashion, while others are not, such that altering any one parameter may affect others lower in the hierarchy. This arrangement simplifies the implementation of personality.

Example Parameters. Table 1 illustrates a few of several hundred such parameters by way of example. The ‘Choleric’ parameter, 202 for example, is ‘above’ others in the hierarchy, in that altering the percentage of Choleric temperament affects the value of many other parameters. For example, it affects the Propensity to Decide 222. Each can be treated as a neuron that may be interconnected with other (non-parameter) neurons. The parameter neurons may serve in a role similar to an I/O port in a digital computer.

The below table is not a complete set of parameters, but is a representative set of parameters useful for the explanations that follow.

TABLE 1
General Examples of Brain Parameters

| | Parameter | Description |
|---|---|---|
| 201 | Root Temperament | Choleric, Melancholy, Sanguine or Phlegmatic |
| 202 | Choleric, Ratiometric | Percentage contribution of Choleric attributes |
| 203 | Melancholy, Ratiometric | Percentage contribution of Melancholy attributes |
| 204 | Sanguine, Ratiometric | Percentage contribution of Sanguine attributes |
| 204 | Phlegmatic, Ratiometric | Percentage Contribution of Phlegmatic attributes |
| 209 | Gender | Male or female |
| | Sense of Confidence (Decisions) | Degree of confidence in a decision |
| | Sense of Confidence (Motor Skills) | Degree of confidence in present motor skill |
| | Sense of Determination | Degree of determination to continue present plan |
| | Sense of Dread | Present sense of dread being experienced |
| | Sense of Enjoyment | Present sense of enjoyment |
| | Sense of Embarrassment | Present sense of embarrassment |
| 229 | Present need to Defer | Present need to defer to external person's desire |
| 230 | Trauma | State of physical or emotional trauma |
| | Present Goal (1 of n) | Present objective(s), a list |
| | Long Term Goal (1 of n) | Long term objective(s), a list |
| | Topic of conversation (1 of n) | The present subject of conversation, a list |
| | Self Identify | Recognition of identity such as target for |
| | | communications |
| | Present Speaker | Identity of person speaking |
| | Person Spoken To | Identity of person being spoken to |
| | Present Object | Identity of object/person being spoken of |
| 235 | Correlating Facts, status | True of presently correlating information |
| 236 | Hottest Node, status | Hottest-firing node in context pool, for threshold |
| | | scaling |
| 237 | Activity Threshold | Minimum firing level for context pool memory |

In traditional models of the human brain, facts are simplistically represented as a single neuron, each of which may ‘fire’ at some level of 0.100%. The degree of firing is construed as an indication of the present recognition of that fact. These neurons are interconnected by weighted links, based upon the relationship and experience between connected neurons.

Example Decision-Related State Parameters. Some of the key state parameters used in the decision process are detailed below. Some are set by personality traits, some by the context of the moment and are described elsewhere. Several have baseline values established by the Propensity to parameters.

Activity Threshold 237 is the minimum percentage of full-scale that a neuron must fire before it is considered a candidate for inclusion in short-term memory.

Base Decision Threshold 250 is a personality-based starting basis for the decision threshold. Long-term training and learning experience can raise or lower the base value.

Correlating Facts 235 is true if the correlator portion of the analyzer is presently correlating facts, usually in support of an analyzer decision.

Hottest Node 236 points to the hottest-firing neuron in the context pool (short-term memory). The analyzer uses it for scaling decision thresholds.

Importance for Action 215 is the relative importance of making a decision. It is initially based on the propensity for importance of action, and can be scaled up down by the analyzer as the result of recent decisions.

Need for Completeness 260 indicates the relative need for complete (and quality) facts, prior to making a decision. Incomplete facts will cause the Conjector to make suitable guesses, but the resulting ‘facts’ will be of lower quality.

Urgency for Action 216 represents the urgency (not the importance) of making a decision. Higher levels of urgency make lower quality of information (and decisions) acceptable.

Example Temperament-Based Propensity Parameters. A typical set of basic brain Parameters which indicate various propensities based upon temperament are given in Table 2, including representative contribution ratios (given as a percentage). This set of values is by no means complete and is given for the sake of description of the mechanisms of this invention. Other Temperament Parameters may be identified and included in this list, without altering the methods and claims of this patent.

The specific percentages given in Table 2 are representative and typical values used, but are subject to ‘tweaking’ to improve the accuracy of the psychological model. Other values may be used in the actual implementation. Further, the list is representative and is not complete, but serves to demonstrate the system of the present disclosure.

It has been observed (and incorporated into Table 2) that, generally, many of these parameters reflect traits shared primarily by two of the temperaments, with one of the two being greater. That same parameter may also be shared minimally by the remaining two temperaments.

TABLE 2
Examples of Temperament Parameters

| | Parameter | Choleric | Melancholy | Sanguine | Phlegmatic |
|---|---|---|---|---|---|
| 210 | Propensity for Amusement | 10 | 35 | 35 | 20 |
| 211 | Propensity for Completeness | 20 | 35 | 10 | 35 |
| 212 | Propensity for Determination | 35 | 20 | 10 | 35 |
| 213 | Propensity for Enjoyment | 10 | 25 | 40 | 25 |
| 214 | Propensity for Fun | 10 | 20 | 55 | 15 |
| 215 | Propensity for Importance of | 50 | 10 | 35 | 5 |
| | Action | | | | |
| 216 | Propensity for Urgency of | 35 | 12 | 50 | 3 |
| | Action | | | | |
| 217 | Propensity for Patience | 15 | 35 | 5 | 45 |
| 218 | Propensity for Rhythm | 10 | 15 | 60 | 15 |
| | Influence | | | | |
| 219 | Propensity for Stability | 10 | 25 | 5 | 60 |
| 220 | Propensity to Analyze | 10 | 60 | 5 | 25 |
| 221 | Propensity to Care-Take | 5 | 10 | 30 | 55 |
| 222 | Propensity to Decide Quickly | 50 | 15 | 30 | 5 |
| 223 | Propensity to Follow a Plan | 10 | 25 | 5 | 60 |
| 224 | Propensity to Plan | 50 | 35 | 10 | 5 |
| 225 | Propensity to Procrastinate | 5 | 15 | 30 | 50 |
| 226 | Propensity to Second-Guess | 5 | 60 | 10 | 25 |
| 227 | Propensity for Stability of | 10 | 25 | 5 | 60 |
| | Action | | | | |
| 228 | Propensity to Rest Hands on | 25 | 60 | 5 | 10 |
| | Hips or in Pockets | | | | |

The system of the present disclosure presumes the use of a node that defines the desired underlying temperament, and additional nodes that define the desired percentages of the four temperaments. Table 2 is a chart of the selected typical tendencies for each of the temperaments, with each numeric value giving the approximate likelihood of the given trait to be demonstrated by the four temperaments, as a percentage.

The percentages given are by way of example, although they may approximate realistic values. The altering of these values by no means alters the means and methods of this patent, and they may be adjusted to better approximate temperament traits. The list is by no means complete and is given as a set of representative parameters for sake of example.

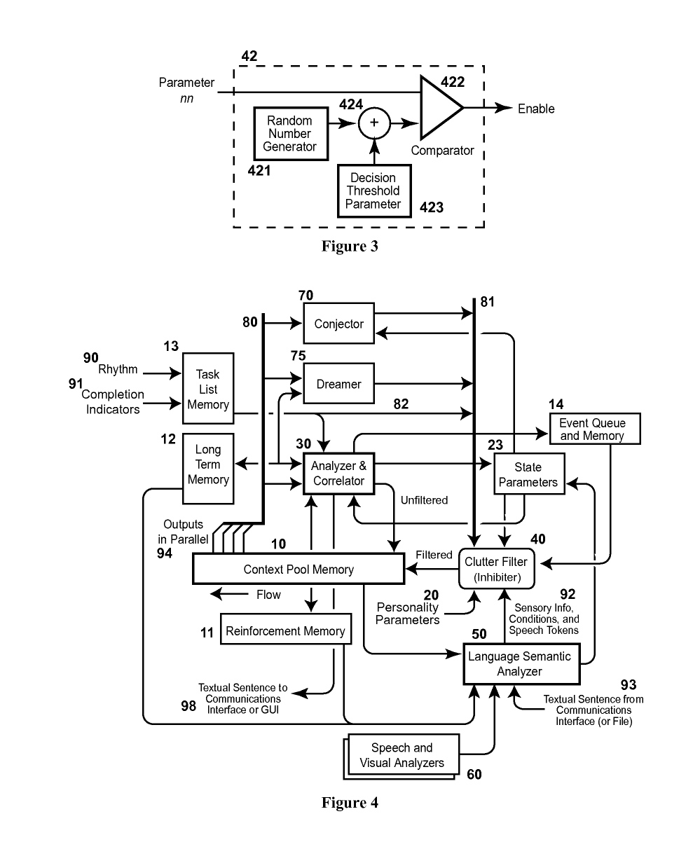

In many, but not all, cases, the overall impact of a temperament is given by the product of the temperament's percentage, as pre-selected to produce the desired personality, and the percentage of likelihood given for each propensity from Table 2. This is demonstrated in FIGS. 4 and 5. These may be augmented by additional variations due to the Gender 201 parameter, accounting for differences in response by male or female gender.

Detail of Some Temperament-Based Propensity Parameters. The samplings of parameters in Table 2 are described below, by way of example of how such parameters are specified and applied. The described settings and applications of these parameters are necessarily subjective, and the relative weightings of these and all other parameters described in this document are approximate and exemplary. One skilled in the art will realize that they may be altered or adjusted without altering the means of the system of the present disclosure.

The Propensity for Amusement 210 is the tendency to be amused. The higher values lower the threshold of what is found to be amusing, triggering amusement sooner. The triggering of amusement may be reflected in the appropriate facial expressions, as provided for in the underlying brain model and skeletal mechanics, if any.

The Propensity for Completeness 211 is a measure of the personality's tendency to need complete facts before making a decision, and is based solely on temperament selection. It is naturally highest for the Melancholy and naturally lowest for the Sanguine or Choleric. While it is normally not altered, the underlying brain model (analyzer) can raise or lower this parameter based upon training or learning.

The Propensity for Determination 212 is the tendency for the brain emulation to be determined, and sets the baseline value for the sense of determination. Over time, it can be permanently altered by achievement (or failure to achieve) targets or goals.

The Propensity for Enjoyment 213 is a measure of the tendency to find enjoyment in issues of life. It is naturally moderately higher for the Sanguine, and is impacted (either way) with a very long time constant (20 days) by the achievement of goals, the completion of plans, and by positive relationship experiences.

The Propensity for Fun 214 defines the tendency of the temperament to make decisions based on the sense of feel-good. It is temperament dependent, tends to be highest for the Sanguine, and heavily influences the impact of Rhythm Influence.

The Propensity for Importance of Action 215 is a measure of the temperament's tendency to find action important, whether or not all the facts needed for decision are available and with high confidence. It is naturally highest for the Choleric and naturally lowest for the Melancholy and Phlegmatic. While it is normally not altered, the underlying brain emulation can raise or lower this parameter based upon training or learning.

The Propensity for Urgency of Action 216 is a measure of the personality's tendency to find action important, at the expense of strong consideration or analysis of the facts. It is naturally highest for the Sanguine and naturally lowest for the Phlegmatic. While it is normally not altered, the underlying brain emulation can raise or lower this parameter based upon training or learning.

The Propensity for Patience 217 is a measure of the overall tendency for patience. The level is normally high for a Phlegmatic and low for a Sanguine, but is also significantly affected by (long term) experience history. Growth is in this trait parameter is very slow and is an iterative process. High levels of Patience 217 cause suppress early termination of action, when faced with repeated failure to meet short- or long-term goals.

The Propensity for Rhythm Influence 28 is a temperament-dependent parameter, and may be altered up- or downward by hyperactivity. It controls the relative effect of rhythm on the decision process. Its baseline value is relatively higher for the Sanguine.

The Propensity for Stability 219 is a temperament -dependent parameter that defines the tendency towards stability. When the value is high, decisions will tend to be made that lead to no net change, in the sense of foot-dragging. It also implies a tendency to procrastinate, and is a strength (or weakness) of the Phlegmatic personality. High levels of Stability 219 lead to strong loyalty towards the context-dependent authority.

The Propensity to Analyze 220 (is determined by temperament and is not affected by other properties, except by external command. Even then, its effect is short term and is rapidly trends back to the base tendency. When very high, there is a marked tendency to analyze and correlate facts before making decisions, and the confidence-based decision thresholds based on the outcome are normally raised.

The Propensity to Care-Take 221 is a temperament-dependent parameter, tending highest in the Phlegmatic and Sanguine. It increases the interest in acquiring people-related facts for short-term memory. The impact of this parameter is established, for example, by altering the parameters of the Clutter Filter for the context pool or short term memory.

The Propensity to Decide 222 is a parameter that is highest for the Choleric and Sanguine temperaments, and influences (increases) the willingness to make decisions with a minimum of facts. For the Choleric, decisions subsequently proven inferior may be altered, while for the Sanguine, the results tend to be ignored. Parameter 222 also increases the tendency to revise decisions as higher-quality facts are available, and decreases the stability in decisions and the tendency to foot-drag.

The Propensity to Follow the Plan 223 defines is the (current) level of tendency to follow a plan. Its core value comes from personality traits, but is altered by such variables as stress, urgency, and external pressure. When pressure is high, as per Trauma parameter 230, there is increased tendency to ignore the plan and to revert to personality profile-based responses. This is accomplished in a manner such as demonstrated, for example, in FIG. 5.

The Propensity to Plan 224 is a measure of the tendency and desire to work out a plan prior to a project or task, and is a function of the temperament profile. If Propensity 34 is high, work on the task will be suspended until a plan of steps in the task is worked out. The propensity to plan does not imply a propensity to follow the plan, per 223.

The Propensity to Procrastinate 225 is a measure of the tendency to procrastinate, deferring decisions and action. The primary value derives from the temperament per Table 2, and is and is then a fixed parameter but which may be gradually altered by experience or training. While procrastination is largely a characteristic of the Phlegmatic, it also occurs in the Melancholy decision-making process, in the absence of complete facts, and is normally very low for the Choleric.

The Propensity to Second-Guess 226 is a measure of the tendency to reevaluate decisions, even quality decisions, and possibly to evaluate them yet again. Temperament-dependent as shown in Table 2, it is highest in the Melancholy and typically lowest in the Choleric.

The Propensity to Stability of Action 227 is a measure of the tendency to maintain the status quo. Largely a Phlegmatic trait, it influences (increases) the tendency to foot-drag, and is implemented by a decreased willingness to alter plans. It may be connected to the underlying brain emulation or model as a part of the clutter or interest filter at the input of the context pool, short term memory or analyzer, suppressing new plans or suggestions that abort existing or active plans.

Propensity to Rest Hands on Hips 228 is a largely Melancholy trait whose more positive values increases the tendency of any attached mechanical skeleton to find a resting place for its hands, primarily on the hips or in the pockets. This parameter provides a control value to the underlying brain emulation or model, which itself is responsible for the motor skill issues that carry out this tendency. That emulation or model actually determines whether or not this tendency is carried out.

Again, parameters in Table 2 are directly controlled by one or more of the four underlying temperament selection parameters. They are scaled by percentages such as those also given by example in Table 2. They are then distributed by the brain model to the appropriate control points, filters and selectors within the underlying brain emulation or model.

Inclusion of Parameter Influence. Throughout the brain emulation, there are many places at which a parameter may or may-not influence the outcome of a decision. The likelihood of the parameter contributing to the decision in some cases are often statistically based. One method of accomplishing this is shown in FIG. 3. A random number between 0 and 100% is generated by 421 and is compared by 422 against the parameter in question. If the parameter value exceeds the sum of a base threshold parameter 423 and a random number, inclusion is enabled.

This type of logic is frequently used in the clutter filter discussed elsewhere.

Derived Brain Parameters. Many parameters derive from the basic Temperament Parameters of Table 2. These values may be a combination of temperament parameters, but as adjusted for learning, training, experience and present conditions. As with other brain nodes and parameters, most of these are expressed in a range of 0 . . . 100%, in units suitable to the technology of implementation.

A typical set of these derived parameters is given in Table 3. Each of these has an additional (signed) value to be added to it which is further adjusted on the basis of learning or training. The list is by no means complete, and is given for the sake of description of the mechanisms of this invention. Many of these relate to matters of emotion, its measure and expression. These, as may all parameters, may be monitored externally to measure the emotional state of the emulated brain.

TABLE 3
Examples of Derived Brain Parameters

| | | Decay Targets | | | |
|---|---|---|---|---|---|
| | Derived Parameter | Choleric | Melancholy | Sanguine | Phlegmatic |
| 250 | Base Decision Threshold | 10 | 45 | 5 | 40 |
| 251 | Concentration Ability | 10 | 60 | 5 | 25 |
| 252 | Docility | 5 | 25 | 10 | 60 |
| 253 | Hyperactivity | 25 | 10 | 60 | 5 |
| 255 | Filter Organizational Detail | 5 | 25 | 10 | 60 |
| 256 | Filter People Interest | 60 | 25 | 5 | 10 |
| 258 | Filter Relational Detail | 10 | 60 | 5 | 25 |
| 259 | Filter Technical Detail | 45 | 5 | 40 | 10 |
| 260 | Need for Completeness | 10 | 40 | 5 | 45 |
| 261 | Patience With Detail | 5 | 60 | 10 | 25 |
| 262 | Procrastination Level | 5 | 25 | 10 | 60 |

These parameters may be derived from temperament, context, environmental and current-condition parameters, for example, although other means will become obvious during this discussion. The parameters of Table 3 are exemplary. Most parameters in this table decay over time to the values shown at the right. These decay targets are nominal and may be altered through preemptive training. They derive from temperament percentages in a similar manner to for Table 2. The list is by no means exhaustive or complete, and others will also become obvious during this discussion

The current derived parameter values are distributed to the appropriate control points, filters and selectors within the brain emulation or model. In some cases, they control decision or stability thresholds, or establish the statistical settings, such as per 42 of FIG. 3, for current-interest filters in the emulated brain, and to other such brain emulation functions. The composite impact of these temperament and temperament-derived parameters determines the composite personality of the emulated brain.

The Base Decision Threshold parameter 250 is the starting basis for many decisions. It is the typical starting decision threshold, and is a measure of confidence or information completeness that must be obtained before a decision will be made. The threshold is given as a percentage, 0 . . . 100%, whose application depends upon the types of decisions being made. In some places it is used as an absolute threshold, or may specify a figure of confidence in the present facts, a figure that must be exceeded before a decision may be made.

The Concentration Ability parameter 251 is a measure of the ability to concentrate. A more positive value raises the threshold of attention to outside distractions, those unrelated to the issues in short term (or current context) memory in the underlying brain model or emulation. It is used by both the analyzer 30 and the clutter filter 40.

Docility 252 is a measure of the overall propensity for stability during external emotional pressure. It contains a long-term filter that decays back to the base value. Positive Docility 252 greatly increases the threshold of attention to emotional trigger events. Docility 252 can be altered over moderate periods of time, but tends to return to its temperament-defined static value. When this value falls lower than its average setting, there is an increasing tendency to ignore learned responses and to revert to personality profile-based responses.

Hyperactivity 253 is a measure of current levels of hyperactivity, as would be normally defined by someone skilled in the art. It is established by a programmable value and subsequently augmented by temperament percentages. Hyperactivity is also influenced by Docility 252 and current emotional stress. These sources are the primary determiners for the base value of hyperactivity, but long-term training or experience can alter the value. Choleric and Sanguine temperaments have relatively higher values, while Melancholy and Phlegmatic values are quite low.

The impact of Hyperactivity 253 is implemented, for example, by introduction of (typically negative) random variations in the magnitude of selected decision thresholds. It also alters the time constants of task-step performance and present rhythm parameters, with additional ultimate impact upon the performance of motor tasks.

Filter Organizational Detail 255 specifies the filtering of organizational detail from incoming information, context pool or short-term memory for the brain emulation. A value below 100% removes the greatest percentage of detail.

Filter Human Interest 256 specifies the filtering of human-interest data from the incoming information, context pool or short-term memory in the emulated brain. 100% removes most human-interest information. The value will be highest for Choleric models and lowest for Sanguine temperaments.

Filter Relational Detail 258 specifies the filtering of detail about inter-relationships between facts from the incoming information, context pool or short-term memory. 100% removes most detail. The value is highest for Phlegmatic and Sanguine models and lowest for the Melancholy models. Higher levels inhibit the correlation of distant facts that are nonetheless related. Lower levels encourage also encourage the analyzer 30 to spawn events to event memory 14. This has the effect of iteratively revisiting the same information to analyze short-term memory for better correlation of data.

Filter Technical Detail 259 specifies the filtering of technical detail from the incoming information, context pool or short-term memory for the brain emulation. 100% removes most detail. The value is highest for Choleric and Sanguine models, and lowest for Melancholy models.

The Need for Completeness parameter 260 establishes the required level of completeness of information before making a decision. A higher value of completeness increases the likelihood of deferring a decision until all the facts are available, sometimes stymieing or stalling a decision . Other parameters related to importance and urgency can alter this parameter. The need for completeness can be altered by a decision of the analyzer 30, and upon external command to the brain emulation, such as through 93.

As the context pool (short-term memory) shrinks over time because of rest, the need 260 drifts backwards to the value set by the propensity for completeness. The need also reverts to the propensity value after a decision has been made. 100% implies the highest need for completeness. It is highest for Melancholy and lowest for Choleric and Sanguine models.

Patience With Detail 261 is the present level of patience. Its baseline value derives from the propensity for patience. It is affected by present conditions and can be commanded to rise. It largely alters decision thresholds, and values near 100% imply comfort with detail. The value is dynamic and tends highest for the Melancholy and lowest for Sanguine and Choleric.

Procrastination Level 262 is a measure of the present level of procrastination. Its base value is set by the propensity to procrastinate, is increased by uncertainty, and decreased by impatience. Procrastination defers decisions and postpones actions that are not otherwise inhibited by circumstances. Decision choices are implemented in a manner similar to 42 of FIG. 3. Higher values of this level postpone decisions, even in the presence of hard facts (high sense of certainty).

While procrastination is largely a characteristic of the Phlegmatic, it also occurs in the Melancholy decision-making process in the absence of complete facts. It is normally very low for the Choleric.

As noted, the parameters described in the preceding tables in no way constitute a complete set of obvious ones, which total in the hundreds. Selected parameters have been presented by way of illustrating the internal processes and considerations for the brain emulation of the present invention.

Implementation of the Brain Emulation. One implementation of the underlying functional model of the brain is diagrammed in FIG. 4. Three primary elements of the model are analyzer/correlator 30, the context pool memory 10, and the English semantic analyzer 50.

Throughout the descriptions, English is always used where the processing of external communications are involved, whether in complete sentences or in sentence fragments. Internally, the system is essentially language independent, except where linguistics, phonics, the spelling of words or the shape of letters used in the language are involved. For ease of initial implementation, English was used, but essentially identical processes can be applied to any human language of choice. The choice of language in no way limits the invention for purposes of this patent. Indeed, the methods of this patent can be applied to autonomously translate one human language to another.

Referring to FIG. 4, various elements are controlled or modified by the state parameters previously discussed. In particular, the Clutter Filter 40 plays a central role in determining what types of information are actually considered in the brain. As are most other blocks in the figure, operation of the analyzer/correlator 30 is controlled or heavily influenced by personality state parameters 22. These same parameters may themselves by the results of analyzer 30, in many cases.

The flow of external information enters through the semantic analyzer 50. This distills content and intent from both English sentences and sentence fragments, and formats the distillate for inclusion into short-term memory 10.

Concept of the Neuron Used Here. This invention makes no attempt to replicate the biological neuron, axion and dendron, their arrangement or interconnections, or their redundancy. Rather, the term neuron in this patent describes the means to remember a single fact or experience. As suggested bio-mimetically, the existence of a single fact is represented simplistically by a single neuron, while the implications of that fact are contained in the arrangement of interconnects between neurons.

In the biological neuron, there is an in-place ‘firing’ of a neuron when the associated fact is recognized. When, for example in a fox's brain, a specific neuron represents a common rabbit, the firing of a biological neuron implies recognition of that rabbit. The degree of firing (or output) represents the degree of certainty with which the rabbit is recognized.

There is no such equivalent in-place firing of the neuron in the emulation or brain model of this invention. In a digital implementation, the entire long-term memory 12 (where facts, relationships and experiences are stored) could be composed of read-only or slow flash memory, because recognition does not involve a change of the neuron's state in that memory.

As an alternative process used here, recognition takes place by the existence, recognition or correlation of data within the context pool memory 10. Any reference to a ‘firing neuron’ is to be construed as placement of a reference to (address-of) that neuron into context pool 10, along with a current firing level for it.

Neurons and Reference Indices. Every neuron records two types of information. The existence of a specific fact is implied by the fact that a neuron to represent that was defined at all. Experiences are implied by the relationships and linkages formed between neurons. Individual neurons are emulated by some fixed-size base information, and a variable number of relational connection records, as shown in FIG. 9. Relational conditions may be conditional, predicated upon the state of other neurons, and reference the ID indices of both their target neurons and condition triggers.

All neurons have a unique address, but it may be change from time to time as memory is reorganized. Further, the very existence of some neurons is tentative. They may disappear unless reinforced over a period of time, and are located in the reinforcement memory 11. Because their precise locations are unstable, references of one neuron by another could be problematic. Further, the relative size of a neuron can vary widely, depending upon the inter-relationships and context with other neurons.

To handle these matters gracefully, a unique and unchanging index is allocated for each neuron created. References between neurons use this permanent index to inter-reference each other. If a neuron is deleted (in reinforcement memory 11), the index is reclaimed for later reuse. A specific bit within the index value indicates whether it refers to a normal permanent neuron or to the reinforcement memory 11. A fixed subset of the indices to the reinforcement memory ‘tentative’ neurons are also be reserved, used to indicate information block type and format within the context pool 10.

Neurons in the reinforcement memory 11 that have been reinforced over a period of time are made permanent by the analyzer/correlator 30. The analyzer then moves them to permanent memory 12 and alters all references to its index to show that it has been so moved. References within that neuron may themselves not survive the reinforcement process, and may be deleted during the transfer. Refer to Table 4 for data stored with the individual neuron.

Content of Neural Reference Structures. The analyzer/correlator repeatedly scans context pool memory 10 for both unprocessed information and for activities suspended while awaiting occurrence of certain events or conditions. It also updates brain parameters both to keep them current and to check for relevant changes of substance.

Within the context pool, information is organized into variable-sized blocks, with all of it pre-classified or typed prior to submission. Some blocks contain inferred intent from sentences. Others contain commands, propositions, conjecture and other miscellaneous material. In its degenerate form, a ‘block’ may simply be a reference to a single neuron, and its firing level.

TABLE 4
Neuron Structural Content

| Neural Content | Description |
|---|---|
| Basic Information | Basic information may include references to explicit spellings (e.g., a |
| | walk-back index to the text-tree for the word), pronunciation |
| | exceptions, visual-object descriptors and the like. Certain flags and |
| | start-indices for lexical matters and the like are also included here. |
| Relational Linkages | The weighted and conditional influence of this neuron upon another is |
| | defined by relational linkages, of which there may be up to 1000 or |
| | more, for some neurons. Each new experience and relationship learned |
| | has a relational linkage created for it. |
| | Initially, these relationships are created in the reinforcement memory, |
| | where they remain until later validated and moved to long-term |
| | memory (or are deleted). Relationals in reinforcement memory may |
| | refer to neurons in either memory, but those in long-term memory may |
| | refer only to other neurons in long-term memory. |
| | The Analyzer tracks the allocation, aging, validation, and ‘garbage- |
| | collection’ processes, and these are discussed in detail elsewhere. |

Individual neurons are emulated by some fixed-size base information, and a variable number of relational connection records. The latter may be conditional, predicated upon the state of other neurons, and reference the ID indices of both their target and conditional neurons.

Context PoolMemory 10. The core of all emulation occurs in the context pool (short term) memory 10 and the analyzer/correlator 30. All information of immediate awareness to the emulator resides in that context pool. Neuron-like firing is implied by the very existence within the context pool of a reference to a neuron from long-term memory 12. Information (blocks) enter the context pool serially, as it were, but are processed in parallel by the analyzer 30.

Referring the context pool 10 in FIG. 4, data flows from right to left, as it were. Unless reinforced, all neuron data in the pool gradually ‘leaks away’ or dies away during its travel, aging it. Should the context pool fill, oldest (or left-most) data is simply lost, a case of information overload. Any data remaining in the context pool that has aged without reinforcement can eventually decay to a zero-firing state, at which point it is simply removed from the pool.

Data may be placed into the context pool from a number of sources, the initial one of which is often the semantic analyzer 50. Except for inputs from the analyzer 30, all context pool information is filtered by a clutter filter 40, which largely keeps irrelevant or non-interesting data from reaching the context pool.

Data in the context pool take the of form block-like structures of predefined format. A block arriving from the semantic analyzer 50, for example, contains the intent of a sentence, independent clause or sentence fragment. A one-word reply to a question is fully meaningful as such a fragment. Such a sentence block may contain references to a speaker, the person spoken to, and possibly, references to the person or object discussed. Many combinations of this and other sentence data are possible.

Blocks from analyzer 50 frequently includes the purpose of the sentence, such as query (and expected type of answer), command, factual declarations, observations and the like. This type of data is discrete and readily identifiable by the semantic parse.

Other implied emotional information may be inferred from use of superlatives, exclamatories, and tone (if derived from an auditory analyzer 60). Auditory sources yield the speaker's nominal fundamental frequency and infer stress or emotional excitement by short or long-term pitch deviations accompanying spoken speech.

The length of the context pool is determined empirically by the application, but is nominally sufficient to handle a number of hours of intense study, or approximately a day of casual interaction. To put sizes into context, this represents roughly a megabyte of conventional digital storage, although selected size does not alter the means or methods of this patent.

During sleep times (or emulated extended rest), the context pool 10 gradually drains, with neural firings gradually fading to zero. As neural references fade to zero, they are removed from the context pool, as suggested bio-mimetically.

New information may be introduced during sleep by the dreamer block 75. Dreamer-derived information created during deep sleep decays rapidly when awake, at rates different from normal context pool data decay. If the sleep time is insufficient, yet-active neural firings remain into the following wake cycle, and are handled as previously described.

Language Syntax Analyzer 50. A language semantic analyzer 50 accepts communications in the natural language of implementation, English, for example. It breaks down sentences, clauses, and phrases to derive intent and purpose from the sentence. It uses the context of the current conversation or interaction by polling the analyzer 30, long-term memory 12 and reinforcement memory 11. Access to present context is obtained indirectly from the context pool via analyzer 30. Interpretation of language words is weighted by the presence of their associated neurons in the context pool, yielding context-accurate interpretations.

While language semantic analyzer 50 could be hard-coded in logic, it is beneficial for many applications that it be implemented as an embedded processor. This method is not required for the purposes of this invention, but is a convenience for the parse and interpretation of languages other than the initial design language.

Because all humans are essentially the same regardless of their national language and its grammar or semantics, the parameters described herein remain constant, while semantic analyzer language 50 language description script would change.

For convenience, statements emitted by analyzer 30 through interface 98 are created in analyzer 30. However, this function could be separated into a separate unit for convenience in altering the language of choice from English.

For a given language, semantic analyzer 50 recognizes a set of words that are an essentially invariant part of the language, such as with and for, in English. These play a substantial role in defining the grammar for the language. Nouns, verbs and adjectives readily change with the ages, but the fundamental structural words that make up the underlying grammar rarely do.

In addition to these invariant ‘grammar’ words, the structure of sentences, clauses and phrases define the remainder of the grammar. Analyzer 50 uses this overall grammar to interpret the intent of the communications.

Computer languages (non-natural languages) are often parsed by separate lexical and grammar parsers, using such commercial tools as Lex and Yacc. These were deemed burdensome and unwieldy for parses within the system of the present disclosure. For natural languages, an alternative parser (Lingua, a commercial parser and not the subject of this invention) was created. Using Lingua, a highly complete description of English grammar was defined and serves as the basis for language semantic analyzer 50. The intellectual property contained therein is a definition of English grammar itself, although it is also not the subject of this invention.

In the prior art, custom analyzers using large corpuses or dictionaries of words have also been employed for the parsing of English text. Unlike them, semantic analyzer 50 makes use of context-dependent information for a more accurate rendering of intent from the text.

Semantic analyzer 50 takes in natural language sentences, clauses, phrases and words, and emits blocks of decoded neuron references and inferred intent. In large measure, the non-changing and fundamental grammar words are discarded after they have served their purpose in the parsing. Similarly, structural constructs within sentences are often discarded after their implications have been gleaned. Finally, pronoun references such as he and it are replaced by references to neurons representing the resolution targets, such as “David Hempstead” or “rabbit”.

The semantic analyzer indirectly references both long term 12 and the “21-day” reinforcement memory 11, and can extract relational information from either, to determine meaning and intent of specific words. It places greater weight on words whose neural references are already firing within the context pool 10.

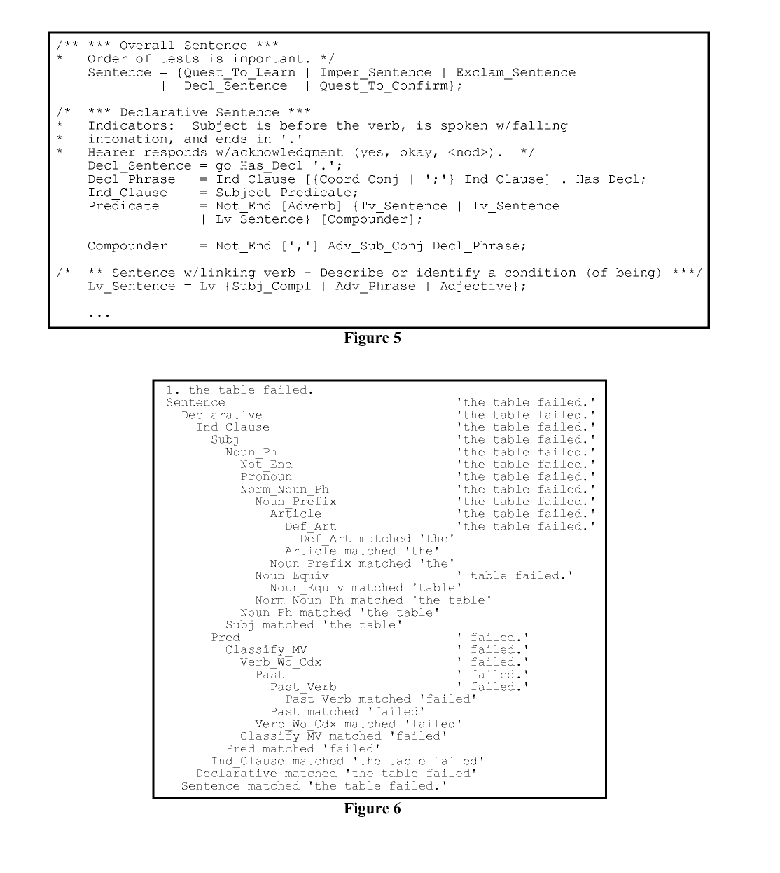

The definitions of English (or other natural language) grammar are contained in a definition file in a variant of the Baccus-Nauer Format (BNF). Refer to FIG. 5 for an example fragment of such a definition. The example was implemented using the Lingua compiler, a commercial product of Neuric Technologies. An example of diagnostic results obtained from parsing the sentence, “The table failed.” is given in FIG. 6, showing the iterative nature of the parser used in the commercial Lingua product.

It can readily be seen by one skilled in the art that the language analyzer 50 can be implemented variously without detracting from its placement and efficacy in the system of the present disclosure.

Sentence Blocks. For sentence processing, context pool 10 data may be blocked into inferred facts and data. Preprocessing in semantic analyzer 50 will have already converted sentence fragments into complete sentences, or will have flagged the fragments for expansion by the Conjector.

Each sentence block is usually a complete sentence, with subject and predicate. Implied you subjects have had the subject resolved and appropriate neuron reference substituted. The implied It is prefix, that turns a noun-clause (e.g., an answer to a question) into a full sentence, would also have been added as needed. All sentence blocks are standardized in form, with inferred sentence information reordered into that form.

The blocks are of variable length, with flags that indicate the sentence data being stored. Some of this information is gleaned from state parameters. The sentence type dictates which items are optional. Types include Declaration, Question, Exclamation, Observation, Accusation, Answer to Query, and yet others. Other sentence data may include the following (and other) information:
Subject
Subject Person: (1st, 2nd or 3rd)
Subject Count: (Singular, Plural)
Subject Gender: (Male, Female, Object)
Action or Step to Take
Verb
Object (including Person, Count, Gender)
Target of Action (including Person, Count, Gender)

All noun-like items also contain the person, count, and gender flags. These sentence blocks are interpreted by the analyzer/correlator 30 and the conjector 70 as commands for interpretation. Some of these are described in the discussion about Table 7 contents.

The Sentence Recognition Process. Regardless of whether the sentence was obtained through written text or from auditory speech, recognition and understanding of sentence content is roughly the same. The greatest differences are the additional cross-checks, validations, and filters imposed on spoken speech. For extracting intent from sentences, a general communications triad is defined: The speaker, the person/object spoken to (e.g., the receiver of commands), and the person, object or subject spoken of. Most of this information can be inferred from sentence content, from the present context pool 10, and from state parameters 20 and 23.

The basic process is:

1. Parse—Parse the sentence using language grammar rules, such as in FIG. 5.

2. Extract the Triad Corners—Identify shifts in the communications triad, if any. For identified shifts, advise correlator 30 by suitable command notifier in the context pool 10.

3. Extract any Qualifiers—Compile qualifier clauses. If a definitive sentence, store the compilation, but otherwise evaluate the clause's probability to a single neuron, extracting both neuron references and data sufficient to create additional relational connections 1252.

4. Extract Structural Elements Extract key structural elements, discarding semantic information. Store the data in appropriate blocks or neuron references for use by the correlators 30 and 75.

5. Compile Definitives—Compile any definitive sentences into relational and qualifier constituents, storing the relational associations (if any) with the relevant fact neurons. This is done indirectly by submitting an appropriate directive to the context pool 10.

The above basic process is exemplary of a portion of the typical activity for parsing a sentence and generating information or command blocks for inclusion in the context pool 10.

Clutter Filter 40. Clutter filter 40 acts to limit entry of certain types of information into context pool 10. Information entering the context pool must pass through the clutter filter, except for that emitted by analyzer 30. The purpose of the filter is to remove extraneous neurons, such as language or grammatical tokens and non-significant gesture information. The clutter filter follows preset heuristics which may either be fixed or adaptable.

The result of the filter is to maximize the consideration of relevant information and to minimize ‘mental clutter’ and things of little interest to the personality being modeled. Choleric temperaments, for example, do not thrive on human-interest information as the Sanguine does. Data so identified may be removed in keeping with current parameter conditions. This may occur during the course of conversational exchange, during which time semantic analyzer 50 or other sources flags the data on the basis of the topic of discussion.

The clutter filter is a substantial contributor to the emulation differences in right-brained and left-brained activity, second in this only to the work of analyzer/correlator 30.

During interaction with the outside world, a large number of neurons are referenced from memory and submitted to the context pool 10 for analysis, correlation, conjecture and dreaming. The filter considers the type and groupings of neurons being submitted, as well as some of the inhibitor factors, and may opt to discard them instead forwarding them to the context pool 10. During normal (non-sleep) activity, outputs from the dreamer 75 are given very low priority, unless overall levels of neural firings in the context pool 10 are very low.

Neural phrase results from the analyzer 30 always enter short-term memory directly, bypassing the clutter filter. By the nature, analyzer/correlator governs overall thought (and memory) processes and normally does not produce clutter.

The filter also prioritizes incoming information. Entire contents of answers to questions are also likely to be passed through, whereas the same material might not ordinarily be.

The primary basis of determination of what constitutes ‘clutter’ is the personality parameters 20, a subset of the state parameters 22. (In FIG. 4, they are shown separately from other parameters for emphasis and clarity, but are essentially are the same.) Logic such as that of FIG. 3 demonstrates one means by which the clutter determination may be made. It will be obvious to one skilled in the art that the clutter filter as described here can be augmented with additional rules and heuristics without altering the basic inventions of this patent.

Analyzer/Correlator 30 The analyzer/correlator 30 is the heart of the emulated brain, and is the primary center of activity for thought processes. It is also the primary means for updating of all dynamic brain parameters and is the only means for initiating permanent storage of information.

Decisions are normally based upon ‘solid’ facts, information of high confidence or firings. Generally speaking, higher perceived quality of the source information yields higher quality decisions. In the absence of good information, analyzer 30 uses information from conjector 70, although results using the latter are also of lower quality.

Thought and decision processes are performed by the analyzer block, with supporting prompts and suggestions from conjector 70 and dreamer 75 blocks. The heart of the analyzer's work is done in context pool memory 10, such that all processes are performed within the context of the moment.

Entry of a neuron reference into the context pool memory 10 initiates a sequence of events unique to the neuron and its associated relational (experiential) linkages, or ‘relationals’. Detailed later, these often make use of the event queue memory 14 to handle the implications of their connections.

Initial Activity Upon Awakening. When awakened in the morning, the rested mind (that is, the context pool 10) is usually quite empty. Thoughts and cares of the past day are gone, or are so diminished as to not be readily recalled. Fragments of sentences, fleeting observations and incomplete or illogical ideas of the previous day have been purged, the mind uncluttered. This is the context upon awakening.

Daily activity in this brain emulation begins in a similar way. The initial tendency is to resort to routine, established lists of actions, usually by the timed fulfillment of events from the event queue 14. Activity can also be started by other external means in both human life and in this brain emulation. Table 5 lists some example ways that activity begins in the morning, but the list is of course by no means inclusive:

TABLE 5
Example Start-of-Day Activity Indicators

| Event | Activity Initiated |
|---|---|
| Hungry for Breakfast | For the human, some form of routine that is normally undertaken, even |
| | if only the process of waking up, getting dressed and eating breakfast. |
| | Such a simple process is still a learned list, equivalent to one stored in |
| | the task list memory 13, though it also may not be consciously present |
| | in the mind. If nothing else occurs during the initial state of fogginess, |
| | the physical body soon makes known its need for food, and that |
| | initiates a tentative routine. If the emulated brain is connected to a |
| | robotic skeleton or vehicle, an equivalent for hunger might be depletion |
| | of fuel or electrical charge. |
| Conversation or | Sometimes the day is begun by someone else who interrupts the sleep |
| Telephone Call | with a request for attention, asking a question. This is equivalent to |
| | wake-up via external communications 93, or through speech or visual |
| | analyzer 90. The sequence initiated by the conversation is a part of the |
| | thought processes. The sentence may be a command, a question or an |
| | observation. |
| Uncompleted List | Lists of things to be done at the close of the previous day are not |
| | always purged by sleep. They remain part of active context 10 of the |
| | brain. Carried into the next day with reduced clarity or importance, |
| | they are a basis for the first thoughts of the day. Timed or conditional |
| | items emitted to the event queue 14 may also be waiting. |

Any of the above conditions places blocks of neuron references that take the form of sentences, event-based commands and other information to be processed. One skilled in the art will recognize that the analyzer/correlator 10 can be implemented as hard-coded logic, a form of command interpreter, or as an embedded processor without altering the means of this invention.

Outcomes of Analyzer/Correlator Activity. As a consequence of its operation, analyzer/correlator 10 may include any of the activities of Table 6. The list is indicative of the types of outcomes and is not all-inclusive, but may be extended for the convenience of implementation. One skilled in the art shall realize that this does not alter the means of this patent.

TABLE 6
Outcomes of Analyzer Activity

| Action | Description |
|---|---|
| Fire a Neural | In context pool 10, initiate (or increase) the firing of a neuron for each |
| Reference | new reference to it. Multiple references in the context pool 10 to the |
| | same neuron thus increase its influence. |
| Reinforce Neural | Neurons in t reinforcement memory 11 that have been freshly |
| ‘Keep’ Count | referenced are reinforced. Their time-weighted reference (‘keep’) |
| | count is maintained with the neuron in memory 11. |
| Decay 21-day | Periodically (e.g., during sleep intervals) decay the ‘keep’ count for all |
| References | neurons in the reinforcement memory 11, to enforce the need for |
| | reinforcement of learned information. |
| Create a Permanent | Neurons in reinforcement memory 11 that have satisfied their reference |
| Neuron | count level are made permanent by moving them to long-term memory |
| | 12, updating their references, and removing them from short term |
| | memory. |
| Initiate an Event | Certain conditions, particularly due to neuron relationals, and some |
| | types of sentences, cause events to be queued to the event memory 14. |
| | The queuing is normally for execution after specified delay, awaiting |
| | the meeting of the conditions pending. |
| Ask a Question | Based upon need for more information, ask a question, formatting and |
| | emitting it through interface 98. |
| Perform I/O or | Initiate appropriate motor skill lists or handle computer-like I/O related |
| Motor Skills | to the application. |
| Update a State | Update relevant state parameters 20 based upon changes in internal |
| Parameter | conditions created by analyzer 30. |
| Trigger Other Neural | Initiate action in other blocks such as the task list memory 13, to |
| Blocks | initiate motor-skill activity or to perform memorized steps. |
| Decayed-Neuron | When firing value for a neural reference in context pool 10 has been |
| Removal | decayed to zero, remove the reference from the context pool. |
| Neural Reference | Periodically throughout the active day, neural references in context |
| Aging | pool 10 are aged, reducing their influence. This aging is accelerated |
| | during periods of sleep. |
| Conjecture Clutter | Commands or references created by the conjector 70 are correlated for |
| Removal | relevance, and discarded for low relevance to the target subject(s). |
| Dream Clutter | While awake, information and command fragments from dreamer 75 |
| Removal | are rapidly decayed. During sleep periods, perceived accuracy of these |
| | items is increased and treated as ordinary and factual information, but |
| | motor-skill related commands are suppressed. |
| Expand Fragment | Command the conjector 70 to expand a sentence fragment into the |
| | closest equivalent full sentence. |

Besides the items of Table 6, analyzer/correlator 30 maintains and updates numerous lists, such as present subjects of conversation or inquiry, the status of pending answers to questions issued, maintenance and completion status of motor skill activity, and the like. Its primary source of information and commands comes from the present contents of the context pool 10.

Context Pool Commands. Within context pool 10, information and facts are stored in the generic form as neuron references, neural indices. Both state parameters 20 and context pool commands are encoded as dedicated lower values of neural indices. The commands are variable in length, with their index followed by length and supporting information.

Many synthesized commands derive from the parsing of sentences by language analyzer 50. Sentences may be distilled into multiple commands, each complete with neural references. Implied subjects, verbs or objects are resolved with references to relevant neurons. For sentences with multiple subjects, verbs or objects, the sentence content is replicated, with one copy per item in the subject list, for example.

Some commands found in context pool 10 are given in _Ref90637160˜. The list is exemplary and not exhaustive. One skilled in the art will realize that the list may be extended without altering the means of the system of the present disclosure.

TABLE 7
Example of Context Pool Commands

| | Command | Remarks |
|---|---|---|
| | Initiate Motor Skill | From a command or a list item |
| | Await Completion | Suspend topic activity, awaiting completion. |
| | Await Factual Answer | Question was asked that expects factual information. |
| | Await Affirmative Answer | Question was asked that expects a yes/no answer. |
| | Seek Information | Ask a question to resolve ambiguity or missing |
| | | information. |
| | Correlate Answer | Process anticipated answer |
| | Initiate Definition | From definitive sentence |
| | Execute Command | From imperative sentence |
| | Repeat Until Condition | Perform an iterative operation or analysis. |
| | Note Declarative | Handle declarative sentence or observation, setting |
| | | relevant expectations. |
| | Note Exclamatory | Handle exclamatory sentence, updating relevant emotional |
| | | states. |
| | Update/Add Topic | Refresh list of topics and update relevance of the list |
| | | items. |
| | Update the | Update the list(s) of who is speaking (speaker), who is |
| | Communications Triad | being spoken to (target) and the object(s) of conversation. |
| | Note Accusation | Handle accusatory statements, updating emotional state |
| | | and emitting conditional events to queue 14 to prep |
| | | answers to implied questions. |
| 231 | Declarative | Command to handle state of being, remarks or |
| | | commentary |
| 232 | Imperative | Command to self to do something |
| 233 | Definitive | Command to define something |
| 234 | Interrogative | Command to respond to a question |

For convenience, all data structures in the context pool look like neuron references.

Execution commands are always flagged by their source, such as a speech or grammar analyzer, the Analyzer or Correlator, the Conjector, Dreamer and so on. The Analyzer later considers the source when applying the command during its thought or decision processes. Exemplary commands from semantic analyzer 50 are given below, these particular ones being based upon sentence types.

Declarative 231 This is an instruction to consider a present condition about the subject. It may also be a part of an experience process, ultimately culminating in the creation of a neuron-to-neuron or neuron-to-state-parameter relationships. This command is usually created by the parsing of a sentence, but can also be created by thought processes within analyzer 30.

Declaratives may result in a remembered relationship, in time and with reaffirmation, and through conjector 70's action. That is, declaratives are ‘taken with a grain of salt’, and consider confidence in the source of the observation. They differ from the definitive 233 in that the latter is already presumed to be a source of facts, and only the reliability of (confidence in) the information needs to be confirmed before remembering it.

For example, “Four cats are sufficient to eliminate mice from large barns,” is a declarative that proposes how many cats it takes to get the job done. Before analyzer 30 assumes the statement to be factual and remembers it, it will consider its confidence in the source of the remark, and whether or not the information is reaffirmed.

Imperative 232 instructs analyzer 30 to the brain emulation to do something, such as to consider a proposal, pay attention, recall something, or to conjecture an answer to an issue with insufficient information. It is a command for action of some type, directed towards the brain emulation.

A command such as ‘Come here!’ must be evaluated in the present context. It implies activation of a motor-skill list to begin physical motion, and targets the location of the speaker. The latter may not be in the context pool, but is maintained in a state parameter. In this case, analyzer 30 directs the motor skill via task list 13. It can then, for example, issue an await-on-completion event 142 and dismiss the command from memory. It will later receive a completion message (or a notation that it encountered a brick wall or other impediment to carrying out the instruction), closing the command.

Definitive 233 indicates definition of a fact (in reinforcement memory 11), and may include auxiliary conditional relational information. Example, “A cat is an animal with have four paws, of which the front two are commonly called forepaws,” is a compound statement. The statements share a common subject, and have separate definitive 233 (“A cat is an animal with four paws”) and declarative 231 (“The front cat paws are commonly called forepaws”) clauses. Semantic analyzer 50 separates the compound into separate commands for each clause.

Declarative 231 portion, “A cat is an animal with four paws,” defines these neurons if they are not already known: Cat, Animal and Paws. Even if the meanings of Animal or Paws are unknown, they can still be remembered, and the suitable relationals later formed between them. These are all recorded in reinforcement memory 11, if not already there and not known in long-term memory.

If already in reinforcement memory 11, their existence is reaffirmed to encourage possible permanent recollection. If the veracity of the speaker is high, less time is required to reinforce the facts. If the system is in preemptive training mode, these are assumed to be pristine facts, perhaps from God, and are immediately and permanently remembered.

The declarative 231 portion, “The front (cat) paws are commonly called forepaws,” also forms a definition, but must be reaffirmed to a greater degree than for the definitive clause. (Because parsing has already been performed, the explicit subject defined at the start of the sentence has already been associated with the trailing clause, too, by semantic analyzer 50.)

Because ‘The’ is present, the clause is declarative 231 rather than definitive 233. This is because the reference is to a specific cat, rather than to the generic cat animal. One skilled in the art is aware of these subtleties of English grammar, and how that grammar may be used to determine the intention and type of sentence.

Interrogative 234 poses questions and requests. These are normally injected into context pool 10 by the grammar semantic parser 50, but may also be queries from other sources. Many (but not all) questions are simply a declarative statement with a question indicated, and are often formed by a restructuring of a simple declarative sentence.

The parser 50 sorts questions into those seeking affirmation (yes/no) or seeking specific information, and presents them to the context memory as declaratives 231 marked for validation or as an imperative 234 demanding an informative response. In either case, analyzer 30 only sees data constructs for the latter forms, and so marked as questions so that it can form its response to the question.

Other internal commands are also added for sake of convenience, analyzer 30 loosely taking on the form of a von Neumann processor, with the ‘program’ being the command stream from the English parser, or from other blocks.

In communicating with brain emulators that share common memory 12, their analyzer 30 can forward ‘digested’ command blocks directly to the context pool of this emulator. If communicating with the outside world via external interface 98, analyzer 30 reformats the command block into an English sentence for parsing there, and receives English back via interface 93.

Neurons and the Context Pool. Conditionals expect a specific neuron (or combination of neurons) to be fired. State parameters 20 and 23 are pseudo-neurons, and preexist all allocated neurons. They are treated as neurons, and are assigned the lowest index ID numbers, but have no relational (experiential) links created for them. The ID of every firing neuron (except for state parameters), along with some information specific to the neuron, is maintained in the context pool, including the degree of firing.

Aged neurons in context pool 10 that are no longer firing are eliminated from the pool memory, usually while ‘sleeping’. Neurons yet firing but are not being reaffirmed or re-fired in the context pool have no effect, other than to establish the context of the moment. For example, they may be the subject of a conditional test, or may alter the contextual meaning of a sentence being parsed.

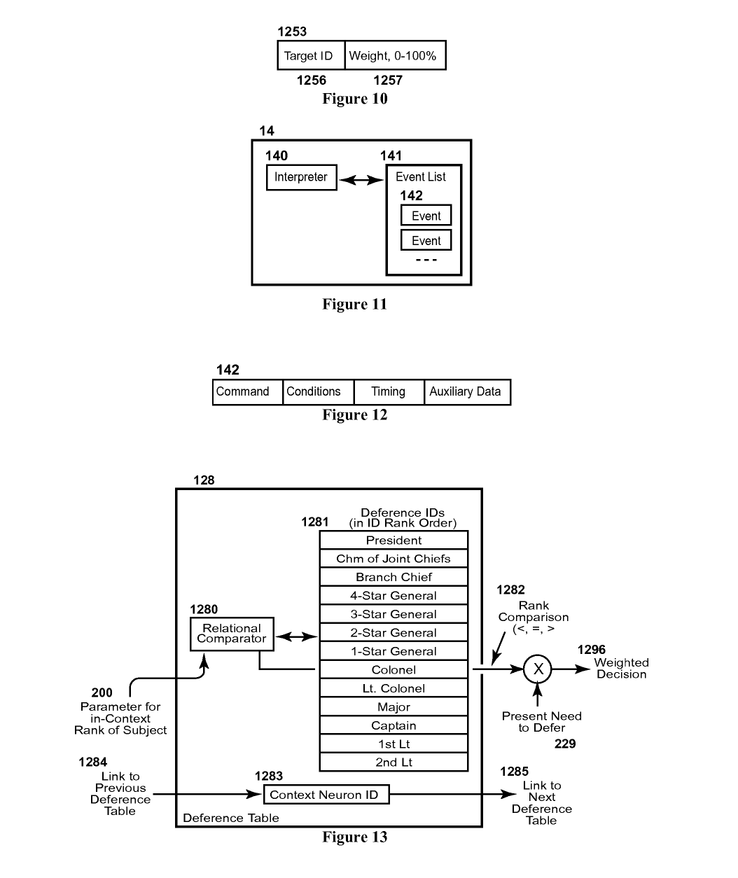

Unidirectional Relationals. Where relationships are unidirectional, a relational attached to the ‘causing’ neuron issues an event, but only if the specified condition is true. For unidirectional relationships, A implies B, but B does not imply A. In either case, the relationships may be conditional, predicated on other neurons also firing. Referring to FIG. 10, a relational link 1253 is created within the neuron impacted by the relationship.

Bidirectional Relationals. Where relationships are bidirectional, neurons or state parameters at both ends of the relational will issue events. If any conditions specified are not met, no event is fired off. For bidirectional relationships, A implies B, and B implies A. In either case, the relationships may be conditional, predicated on other neurons also firing. Referring to FIG. 10, a relational link 1253 is created within the both neurons in the relationship, each referring to the other.

Relationals that Emit Events. When a neuron initially fires (or is reaffirmed), analyzer 30 scans its list of attached relationals. They are organized as AND-connected lists optionally separated by OR markers. Consecutive relationals are evaluated until one of them fails or until an OR marker is encountered. If a relational fails, subsequent relationals are ignored, to the next OR mark or end of the list.

On failure, encountering an OR marker resets the failure condition, the OR is ignored, and testing resumes at the relational just beyond the OR.

If the end-of-list is found first after a failure, no event is generated. Finding an OR (or finding an end-If-list, with all previous tests successful) implies that all AND-connected relational conditions were met, so an event is created. Conditional relationals may be flagged with a NOT, implying that the converse of the condition must be true for the relational to succeed.

Other Internal Lists. Analyzer/correlator 30 maintains other lists of information in short-term memory similar to that of the state parameters 22, which are also treated as blocks of predefined neurons. These have been discussed elsewhere within this patent and include list such as the following:
Topics of Discussion
Motor Activities in Process
Events whose completion is being awaited
Multiple objects to apply sentence to
Multiple verbs applying to the sentence

One skilled in the art will recognize that the above list is by no means inclusive, and the at the logical or physical placement of the above lists may be altered, or the list added to, without changing the methods of this patent.

Walking the Neural Connection. When a new command is added to the context pool 10, it usually contains a reference to a neuron that represents a fact or condition of existence. Usually it will reference more than one. Each such reference either brings the neuron ‘into the pool’ also, or reaffirms neurons already in the context pool.

Simply referencing a neuron causes analyzer 30 to bring it into the context pool, even if not firing very strongly. Some command blocks, such as from a definitive clause, greatly increase the level of firing. Multiple references to the same neuron over relatively short duration, increases the firing level, also, up to the 100% level.

Recognition of a person's face, for example, brings the ID of that person into the context pool, firing the relevant neuron in accordance with the degree of confidence in the recognition. (e.g., “That might be Jackie, over there.”) Shortly thereafter, hearing the same person's voice increases the confidence of the identification. The firing of that person's neuron (ID) may therefore increase from perhaps 65% to 95%. Ongoing interaction with that person keeps his ID alive in the context pool.

Correlation of Relational Information. When in-pool neurons fire, other neurons may be implied by known relationships. For example, Green and Animal might imply a parrot if either Cage or South America is presently in the context pool. Otherwise, if Swamp is firing, Alligator may fire. Analyzer/correlator 30 gathers triggered references into context pool 10, updating neuron firings in a manner specified by the scaled connection weight.

For the case of such relationally-initiated firings, firing level is controlled by the values of the referencing neurons (e.g, Green, Animal or Swamp), and the weight given in the relational connections. That is, the Alligator neuron will fire weakly if Florida (which might imply Swamp) is firing weakly, although nothing else directly activated Swamp. Analyzer 30 effectively acts as a correlator by walking through the connections of all firing neurons, awakening other neurons as long as firings are not suppressed by conditional relationships.

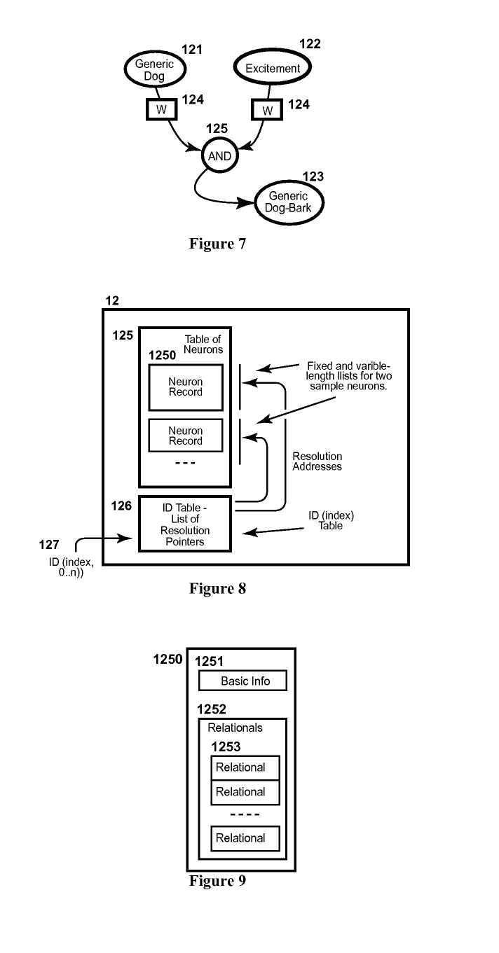

Referring to FIG. 7, if Dog 121 and Excitement 122 are both firing (e.g., information inferred from a parsed sentence), references to them are placed into context pool 10. The relationships of FIG. 7 would set expectations for a dog to bark via neuron 123. Weights 124, which may differ from each other, are multiplied by the firing levels of 121 and 122, respectively. If the resultant firings both exceed some minimum decision threshold, the AND operation 125 causes the generic Dog-Bark neuron 123 to fire. A reference to neuron 123 would then be inserted in the context pool, possibly initiating a motor skill event to cause a bark, for example. It should be obvious to one skilled in the art that many variations of FIG. 7 are possible without altering the means of this invention.

Again, the analyzer 10 causes any neuron not reaffirmed or re-fired over time to gradually decrease its firing level. That neuron is then ejected from the context pool if it goes to zero. It is also dumped from memory if it is still firing but has been there a long time and the context pool is full.

The Long-Term and Reinforcement Memories. Reinforcement memory is a way-point in the process of learning and remembering things. All new information and relationships are established in reinforcement memory, and it serves as a filter for items important enough for later recall. Analyzer 30 handles this process.

The reinforcement memory 11 is a means of eliminating non-essential facts, relationships and incidents otherwise uselessly cluttering permanent memory. The ultimate growth of long-term memory 12 is then moderated, keeping the mental processes and memory more efficient.

Much of the information and experience we encounter is incidental and not worth recollection. For example, paper blowing in the wind is recognized for what it is, but the incident is too insignificant to remember, unless perhaps the context is the distribution of propaganda leaflets. The latter might be worthwhile musing over. Reinforcement memory 11 is the interim repository for this information, while its worth is reaffirmed or forgotten. Analyzer 30 permanently moves validated facts and relationships to long-term memory, as discussed elsewhere.

The long-term memory 12 and the reinforcement memory 11 share a more or less common format. Allocation of neurons and relationals are handled entirely by analyzer 30, and policies that govern permanent retention reside there.

Information is validated by analyzer 30 as ‘memorable’ when was repeatedly referenced over a 21-day period, or repeatedly during exercise of strong emotion or trauma. So validated, the analyzer 30 moves it to long-term memory 12. Referring to FIG. 8, associated relationals are also moved from reinforcement memory 11 to the long-term side. Both memories consist of the following items:
An ID Table 126
A Table of Neurons 125
Other emulator-specific tables

“Other” tables include specialty tables associated with a single neuron and used for recall of motor-skill task lists, aural or visual artifacts or objects, and the like. Their format is specific to the emulator type (e.g., visual, speech or motor-skill) that produces them, but they follow the standard processing and correlation rules for ordinary neurons.

No neuron is special of itself. Rather, it takes meaning and worth from position and interconnection with other neurons. For example, a Laptop neuron is meaningless of itself (except for spelling, pronunciation and visual shape), but has importance because of its relationships to Computer, Portable, and Convenient.

The following sections discuss one specific implementation of emulator structure. One skilled in the art will realize that the technology of implementation is secondary to the means described herein. Many of these items will be tweaked or implemented variously as the underlying technology of implementations varies, such as software emulation, FPGA, gate array, embedded processor, analog relational arrays or optical logic.

The ID Table. Referring to FIG. 8, every neuron is assigned a serial number 127, something of no significance in itself. Each relational connection to another neuron uses that unchanging serial number as an ID. From the ID, spelling, pronunciation and other relevant information is obtained.

When memory is implemented as digital memory, the ID table 126 is located preferably at the base of that memory and consumes a predetermined and finite logical space. It is sized to have one element for every possible neuron. In reality, memory can be resized as more is made physically available, with suitable offsets applied to the resolution value for each ID in the table 126. For each index 127, the corresponding offset into the ID table 126 contains a neuron's address in the neuron table 125.

A vocabulary of 30,000 words is an acceptable working size when words alone are considered. For some people, up to 300,000 unique words are known. Each concept, e.g., “off the wall” to be remembered has its own index, as do words, remembered events or conditions; each corresponds to a unique neuron record 1250 in the neuron table 125.

Experiences may or may-not have their own index, depending on what they are and how they were formed. Because of It is therefore realistic to have an index table 126 of 8-20 million items or more, for example.

Table of Neurons. Referring to FIG. 9, neurons 1250 are emulated by fixed-size information block 1251, and a variable number of relational connection records 1252. The latter may be conditional, predicated upon the state of other neurons. They may reference the ID indices 127 of both their target and conditional neurons. With better-suited hardware memory technology available, such as capable of directly forming relational linkages between neurons, these technology-dependent linkage-pointer structures may be superfluous and may be eliminated or replaced.

Basic information 1251 may include references to explicit spellings (e.g., a walk-back index to the text-tree for the word), pronunciation exceptions, visual-object descriptors and the like. Certain flags and start-indices for lexical matters and the like are also included here.

The relational 1252 is a link between two neurons. It may also be a link between a neuron and a state parameter. Relationals may be unidirectional or bidirectional in nature, and may be performed only if a specified set of conditions are met. Relationals are loosely suggested by the biological neural dendron.

When implemented in digital memory, it is convenient that relationals are allocated in the space immediately behind the fixed-length portion of a neuron record 1251. Normally there a blank space is reserved there in anticipation of relational records insertions. Before inserting a new relational, analyzer 30 checks for sufficient room and reallocates the entire neuron with greater space, if not.

The length of the relational detail block 1252 is variable, depending upon the type and number of relational connections made to other neurons. It not unreasonable that total (digital) memory may consume 16 megabytes to 2 or 3 gigabytes.

Relationals 1252 have an AND-OR organization. AND-connected relational records are grouped together following the fixed-length portion of the neuron.

Referring to FIG. 10, a specific target ID 1256 is generically defined to represent the OR condition, with the remainder of that ‘relational’ record ignored. As stated elsewhere in this discussion, certain neuron IDs are reserved for such special purposes as this. Similarly, certain values of the weight 1257 are reserved to indicate an INHIBIT condition, and the weights themselves may be negative, to reduce the level of recognition, the firing level.

By itself, the relational 1253 is unidirectional. The neuron 1250 it is a part of is fired to the degree that the neuron referenced by target ID 1256 fires. However, the firing of this neuron 1250 does not otherwise affect the target ID 1256. For example, Grass may imply Green, but Green does not imply Grass.

For conditions in which a relationship is bidirectional, analyzer 30 creates a suitable relational for each of the two neurons, each pointing back to the other. This is akin in software to a doubly-linked list.

The weighted and conditional influence of this neuron upon another is defined by relational linkages 1252, of which there may be up to 1000 or more for some neurons. Each new experience and relationship that is learned has a new relational linkage created for it. The garbage collection and management of neuron-relational memory spaces is discussed elsewhere in this patent.

Initially, new neurons 1250 and relationships are created in the reinforcement memory, where they remain until later validated and moved to long-term memory, or are deleted. Relationals 1252 in reinforcement memory may refer to neurons in either memory, but those in long-term memory may refer only to other neurons in long-term memory 12. Analyzer 30 tracks allocation, aging, validation, and ‘garbage-collection’ processes, as discussed in detail elsewhere.

Other Tables. Besides pure neurons or relationals 1250, both reinforcement and long-term memories may hold other encapsulated information. These data blocks are treated and referenced as ordinary neurons, but contain extended structures for efficient later recall of compound and complex entities. Details of each of these are discussed with the description of their relevant neurons.

The neuron process for recognition of sight and sound is by reconstructive correlation, matching a reference image, or sound against a known object or sound. Memory storage is ‘reconstructive’ in that actual sampled sounds or pixilated images are not stored. Rather, sufficient information to reconstruct a reference object (for comparison purposes) is remembered. Stored images and sounds then consist of lists of object artifacts rather than detailed information on them. The degree of match or similarity determines the neuron's firing level.

Refer to Table 8 for a list of some common supporting tables. The list is by no means complete, and one skilled in the art will realize that there are many ways to organize such information into tables without altering the means of this invention.

TABLE 8
List of Some Common Supporting Tables

| Table | Description |
|---|---|
| Task Lists (e.g., | These are lists of actions to be taken, to carry out repetitive or learned |
| Motor Skills | tasks. They are specific to supporting emulators, such as those that |
| | handle motor skills or musical abilities. Task lists are usually coupled |
| | tightly to sensory processes, and can be started, interrupted or stopped |
| | by the main brain model. |
| Aural Artifacts | These are descriptors of basic sounds, including such things as |
| | phonemes, ADSR rules and the like. They are not complete words or |
| | sounds. |
| Aural Interpretive | This is a list-like set of rules for the interpretation of spoken speech, |
| Rules | and augments the algorithmic-based lingual processes. |
| Visual Artifacts | This is an arbitrary set of visual elements used to recognize more |
| | complex objects. The artifacts may include lines at various angles, |
| | facial and nose shapes, alphabetic outlines, and the like. They are |
| | elements used for the reconstruction of visual images, of the minimum |
| | detail needed to perform image correlation matching. |
| Visual Objects | These are descriptions of complete visual objects, but of minimal detail |
| | needed to recognize them. For example, to recognize a specific face, |
| | only a portion of the eyes, nose and chin or cheekbone may be |
| | required. This reconstruction object is connected to the neuron for a |
| | specific person, for example, attaching the face to its identity. The |
| | connection is done via bidirectional conditional link. |

Recognition and re-creation of visual objects are different processes, and must be optimized separately. Biological function suggests that humans do not store detail, such as a bitmap image. Yet, they can certainly recognize a detailed object, and can accurately identify it when exposed to it. A correlation template is recreated from the stored table information and applied to the appropriate correlator. This may be, for example, a vector skeleton for use by the visual correlator for image identification. The neuron fires in proportion to the degree of match.

Event Queue and Memory 14. Events are special-purpose commands issued to a queue 14. They are slated for later execution at a specific time, after a specified delay or after a specified set of conditions are met. They are the means by which unwanted looping over information in the context pool memory 10 is circumvented.

An event is simply a marker or flag set down to remind the system to do something when a specified condition is met. It greatly simplifies the handling of actions that are asynchronous with each other. When the analyzer 30 discovers new information in the context pool 10, it may issue one or more events to the event pool 14. For example, the analyzer may create an event that adds new reference back into the context pool. It could also issue a conditional event to later force the analyzer itself to iteratively rescan the context pool, such as may be done for an analytical temperament such as the Melancholy.

The same mechanism is also used for establishing conditional relationships between neurons, or between neurons and state parameters. Events can be generated by the alteration of state parameters 22. By issuing events for future execution, the analyzer 30 avoids getting side-tracked from the task at hand being worked.

Referring to FIG. 11 and FIG. 4, the event queue 14 consists of an interpreter 140 and an event list 141. Creation of an event causes an event 142 to be inserted in the event list. Events 142 in the list consist of a command field and other optional fields shown in FIG. 12. The interpreter repeatedly scans the event list for events that can be processed. Whether or not they can be processed is determined by the conditions and timing fields. The auxiliary data field, if present, contains information unique to the event type. Once an event has been processed, it is removed from the event queue.

After interpreter 140 has scanned to the end of event list 141, it restarts scanning at the beginning. If no events are left to process, it awaits the creation of a new event. One skilled in the art will realize that the event queue 14 can be implemented as hard-coded logic, as a micro-coded processor, a software emulation, an embedded processor, FPGA, ASIC, optical or other technology of choice, without altering the means of this invention.

Conjector 70. Conjector 70 proposes decisions based upon incomplete or partial facts, or facts of low confidence. While the analyzer 30 is the main thinking facility for the emulator, it takes advice and proposals from both the conjector and dreamer 75 blocks. Proposals from the conjector are filtered by clutter filter 40 on the basis of temperament and personality.

During the processing of sentence data in the context pool, analyzer/correlator 30 acts on the sentence block to determine a suitable course of action where appropriate. If it ‘comes up dry’, the analyzer invokes the conjector suggest a valid meaning. If the resulting quality of the conjector output is too low, analyzer 30 may direct the communications interface 98 to ask for clarification. It sets an appropriate parameter flags to await an answer to the question of clarification.

Conjector output is similar to any normal neuron reference or sensory nerve that is firing at a relatively low level for the topic. Other than being flagged as coming from the conjector, output of conjector 70 is essentially identical to data inferred from sentences by semantic analyzer 50.

The conjector behaves in a similar manner to the analyzer 30, except that it only looks at material in the present context pool. It is not bound by the same needs for hard facts as the analyzer is, and effectively offers subjective information for consideration. Its proposals are largely ignored by the analyzer, except for cases such as the following:

Information is missing or incomplete.

Questions posed by the analyzer through the communications interface 98 are yet unanswered within the expected interval.

Overall level of confidence (firing) levels of information in the context pool 10 is low. In effect, when answers are not available to the analyzer 30 from existing information, the analyzer turns to the conjector to fill in the blanks.

For its operation, conjector 70 reviews outstanding questions or issues, as defined both in the context pool, supporting tables and appropriate state parameters 23. Some state parameters track the present topical subject(s), questions being asked, and information presently being sought by analyzer 30. On the basis of this material, it scans even low-firing neuron references and commands within the context pool 10 and proposes (conjectures) answers for the analyzer.

Respect by analyzer 30 for conjecture is implied by the weighting placed on it. Proposals are ignored if they conflict with other information, or if better (stronger firing) information becomes available. Conjectures age rapidly and are soon forgotten from the context pool, whether or not acted upon. The analyzer considers the source of the conjector's ‘information’ and its levels of confidence (firing levels). It then establishes its own need for the proposal, and its own level of confidence in the data. Rejected conjecture is immediately deleted.

One skilled in the art will realize that conjector 70 can be implemented as hard-coded logic, as a micro-coded processor, a software emulation, an embedded processor, FPGA, ASIC, optical or other technology of choice without altering the means of this invention.

Dreamer 75. Dreamer 75 functions as the ‘right side’ in the brain emulation of this invention. It peruses neuron references in context pool 10 and uses different weightings for state parameters than used by analyzer 30 for its inputs and decision processes.

The dreamer influences the analyzer primarily by injecting fired neuron references into the context pool, rather than just structured commands such as from the semantic analyzer 50. Where pre-existing information in the context pool comes from visual or aural sources 60, or from visual neuron correlations, the dreamer may output proposals in the form of command blocks.

Similarly to correlator-analyzer 30's processing methods, the dreamer generates new references and commands based upon existing neuron firings. However, when traversing the neuron relational chains, lower regard is given to relational conditions 1252, as in FIG. 9. The resulting outputs are of low reliability, as indicated by both their source and its firing levels. When analyzer 30 is otherwise inactive or is in sleep mode, the dreamer may indirectly alter the subject topics by issuing events to event queue 14. Due to the ‘noise’ levels involved, the dreamer may rapidly flit from topic to topic. The dreamer also remains active when the brain emulation is otherwise in a ‘sleep’ mode.

When subsequently processing context-pool data created by the dreamer, analyzer 30 does not create new neurons or relationals in the reinforcement memory 11. Upon awakening from sleep mode, the analyzer 30 also rapidly purges residual dreamer-generated ‘information’ remaining in the context pool.

The dreamer therefore behaves as a ‘movie-maker’ of sorts, unconstrained by relational logic. It creates new ideas loosely based on the context of the moment, ideas that also have very rapid lifetime decays. While this firing of neurons is not in a logical or cohesive way, it still influences decisions and analyses made by the analyzer.

Dreamer 75 is algorithmically based, statistically ignoring strong-firing neurons and applying logarithmic weighting to firing neurons as a part of its own processes. In this way, dreamer peruses the context pool, effectively giving weight to neurons barely firing.

The impact of the additional neuron firings in context pool 10 is that the dreamer places greater overall weight on neurons than the analyzer would have. During the course of activity, the firing of some neurons will be enhanced because of the multiple references to those neurons. Analyzer 30 appropriately weights information flagged as coming from the dreamer, and continues to apply its normal logic to the data. Where it is seeking new ideas, it will weight dreamer-induced references higher than it ordinarily would.

Because dreamer 75 operates at lower effective thresholds than useful for analyzer 30, it is more prone to ‘noise’ and error than is the analyzer. While its outputs are less reliable insofar as decisions go, its purpose is different. During non-sleep operations, dreamer pseudo-information passes through clutter filter 40 where it may be rejected by the personality and temperament filters. During non-sleep operations, the clutter filter rejects more dreamer output by altering rejection filter thresholds.

One skilled in the art will realize that dreamer 75 can be implemented as hard-coded logic, as a micro-coded processor, a software emulation, an embedded processor, FPGA, ASIC, optical or other technology of choice, without altering the means of this invention.

Speech and Visual Analyzers 60. The emulated brain of the present invention may be applied to a mechanical system, whether a skeleton or vehicle, and list-based motor skill learning functions are used. Interfaces from task list handler 13, event handler 14 or analyzer/correlator 30 can be used to control external hardware. These interfaces can be used to apply specific levels of force, when used with closed-loop feedback, or a specific mechanical position, with or without feedback.

Sensors used for the feedback systems are determined by the application. For example, placing one's hand on a table requires either a’ priori knowledge of the table height and position, or requires feedback such as derived from the eyes. Suitable sensors might be a pressure sensor for the nose (so one don't bump into a wall more than once) or for the hand. Aural sensors provide feedback to ascertain the proper formation of sounds, such as to sing on key with existing music.

The methods of this invention create correlation templates or proposals, visual or aural objects presented for correlation against visual images or sounds. Binary search methods are used to select the proper template for correlation, to rapidly determine degrees of recognition. The correlation method constitutes a processed sensor, a sensor with internal ability to ascertain degrees of recognition.

Non-processed sensors are simple temperature, pressure, humidity or light intensity measurement devices, whose outputs are simply formatted appropriately for input to an interface. Processed sensors require interpretation and possible correlation before they can develop meaningful signals. For example, using any number of algorithms, a visual sensor takes a template image and returns the degree of correlation in the present image. Similarly, processed aural sensors take a prototype, such as for a phoneme, and return the present degree of correlation. Phoneme variations may be proposed if a matching word has its neuron firing in context pool 10.

Speech and visual analyzers 60 use task list or other memory such as 13 to retrieve the next sequential image templates for correlation as proposed by analyzer 30. These are conveyed as present settings of the relevant state parameters. For example, some motor skills demand visual feedback for the recognition of a table, its upper surface position, and the position of that portion of the hand to be placed there. These separate objects that must be recognized in turn by the visual correlation processes.

When the table top has been identified, its position must be reported to the context pool 10, as is the position of a suitable landing site on it, the proper area prescribed by the analyzer 30's intention and desire. The outputs of visual correlation are conveniently made relative to the location of the skeleton's eyes, such that correction for hand motion can be made.

Particularly for the visual recognition processes, motor skills require feedback for position, rate of travel, distance and the like. From a single sensor (e.g., a pair of camera ‘eyes’), multiple streams of feedback can be derived, with the information forwarded as command or event packets to context pool 10.

Visual and aural cues aid in confirmation of recognition, delivering feedback for required motion control. These are needed, for example, to rotate and tilt the head properly and to then direct the eye yaw and tilt so the detailed center of the foviated vision is centered on the portion of the scene of interest. These matters are handled interdependently by list processor 13 and visual/aural analyzer 60.

The speech analyzer 60 dumps its output into the semantic analyzer 50 to actually parse spoken material into items suitable for the context pool 10 memory.

Obviously, many technologies for such processed sensors exist, as known by one skilled in the art. The present invention permits interactive presentation of template information with the sensor, in concert with the functions of this brain emulation. One skilled in the art will realize that visual analyzer 60 itself can be implemented as hard-coded logic, as a micro-coded processor, a software emulation, an embedded processor, FPGA, ASIC, optical or other technology of choice, without altering the means of this invention.

Memory Garbage Cleanup and Collection. Garbage collection refers to the reclaiming of unused fragments of memory. During this process, the fragments are sought out and objects in surrounding memory are moved up or down, coalescing unused fragments into a larger block. Coalesced blocks are remembered for later reuse.

Cleanup is a catch-all phrase to cover all things that need to be done to the memory to optimize it. As noted below, it is used to resize certain areas of memory to optimize usage, reclaiming previously reserved space that could better be used elsewhere.

Memory garbage collection and cleanup processes usually involve the movement of information in memory, with suitable updates to indices and pointers to properly reflect the movement.

Expansion of Relational Linkage Blocks. When a neuron originally assigned and given an ID by analyzer 30, empty area for the relationals 1252 is reserved behind the basic neuron information block 1251. Refer to FIG. 9 and FIG. 10. As new relationships are formed, relational records 1253 are appended to the end of the above linkage list. Eventually, this free space is exhausted, an there is no room to add the relational, between the end of the present linkage block and the start of the next neuron. Something must be explicitly done to fix this.

‘Sleep-Time’ Cleanup Activity. Sleep is used to remove clutter from short-term memory, half-formed fragments of thoughts, conjectures, and certain other items of information. This process enables the next day to start out fresh, just as with a human. It is a suitable low-risk time to perform optimization of memory. During periods of ‘sleep’, the inactive state of the brain emulator can be used to advantage to handle movement of validated facts from reinforcement to long-term memory. This process leaves unused holes in reinforcement memory 11, which are also cleaned up.

During the reallocation of the neuron in long-term memory, or when moving a relational from reinforcement memory 11 over to the associated neuron in long-term memory 12, it is possible there is no room left for the relational. For this reason, a neuron's space in long-term 12 must sometimes be expanded.

For this, reinforcement memory 11 is scanned to determine what neurons are eligible for transfer. If transfer would be impeded by lack of space, the associated long-term neuron memory record 1251 is resized upwards.

When available reinforcement or long-term memory has diminished below threshold, neuron space can also be resized downwards during ‘sleep’ times, to optimize it. Neurons 1251 with significant free space behind them can have some of that space reclaimed. Heuristics determine whether or not to downsize. Sparse separation of neurons in memory is always faster, so reclamation is only done if required.

Incoming information 93. The implementation of deference between two modeled individuals takes place in analyzer 30. The position of the present individual being modeled within a hierarchy of individual, political or institutional structures is also kept in parameters 23.

All information except that from the analyzer/correlator 30 first passes through the clutter filter 40, where it may simply be ignored and scrapped. Clutter filter 40 uses personality-specific parameters 22 to determine whether the composite personality is even interested in addressing the information, which has been pre-classified. For example, a Choleric temperament is likely to completely ignore human-interest information, whereas a Sanguine temperament readily devours it.

The filter 40 is a catch-all area to pass preliminary judgment on data, including judgment of its source. The filter is controlled by a number of dynamically-changing parameters, including the current state of patience. When context pool 10 is full, filter 40 drops information, bio-mimetic to someone in the state of “mental overload.”

Preemptive Training. The brain emulation of this invention learns over time, influenced by underlying temperament. Normal human learning processes are used by the emulated brain. Nothing is retained in permanent memory 12 by the analyzer 30 unless it has been reinforced for approximately 21 days, avoiding an accumulation of ‘clutter’ facts and relationships. Facts learned are normally interpreted under the influence of the root temperament, which has its implicit filters and analytical processes (or limited analytical processes, as in the case of the Sanguine).

The brain emulation may be ‘trained’ by a method preempting normal temperament-and-time processes, to rapidly absorb facts, control and environmental conditions. The process is therefore described here as preemptive training. It is assumed in this case that the ‘facts’ and relationships presented are previously determined to be true and factual, “from God,” as it were.

Preemptive training may be turned on or off at will, externally to the emulator. It can be turned on to affect rapid training of these pristine facts and relationships, bypassing temperament-related decision steps and levels of analyzer 30 and clutter filter 40. In this training mode, access is given to state parameters and controls not otherwise permitted. When training is completed, these may be returned on. The modified parameters then immediately effect the personality.

When in preemptive training (‘setup’) mode, the entire contents of memories, one or all, and selected or all state parameters may be copied to external storage. This has application for both the commercial marketing of the information as “intellectual property”, and for military purposes as discussed elsewhere. Such ‘snapshot of being’ may be replicated elsewhere and used as the basis for additional training.

Facts and Relationals. Under preemptive training, new facts and preliminary relationships between them can be defined using declarative monolog in a text file, or a verbal narrative if a speech analyzer 60 is present. These are described in English prose format. The grammar is interpreted by the English Parser, but it is not filtered or further interpreted by analyzer 30 or conjector 70. Normal processes for grammar interpretation are followed, but the information undergoes no further temperament-based interpretation or filtering. This approach lets the brain emulation query the trainer for information that is unclear or not understood, and the training process becomes similar that of a knowledge-hungry human being.

Religious Belief and Personal Conviction. Religious beliefs and personal convictions may be established by preemptive training. As with all preemptive training, the brain emulation will have no idea of why it has these beliefs or convictions. Even so, they can be overridden by deep (extended and consistent) normal training, thereafter.

The beliefs are set by a prose-style description in a text file, to be read by the brain emulation. If it does not understand something or considers something illogical, it will ask for clarification by the trainer. The prose can subsequently be altered to preclude that question for the future.

There is nothing fundamentally different in the matter of religious belief and personal conviction over other types of facts 1251 and relationships 1252 that may be learned. However, by defining them under preemptive training, the normal analytical checks by the analyzer 30 for consistency and factual basis are bypassed, making them an integral part of the emulated brain's basis of understanding. Religious beliefs or personal convictions are established they could also be trained (non-preemptively) over extended time.

Specification of Control Parameter Values. The many control parameters 23 and their default values may also be preset by preemptive training. This can also include specific emotional responses to be evoked when defined conditions are met. The result is again that the brain emulation does not know why (he) responds that way, but he simply does. This is useful to preset human-like likes and dislikes for specific things, for accurate emulation of a person.

Preemptive training is the method by which the temperament of the brain emulation is specified, including both the base temperament type and the upper-level composite of temperaments. These settings will directly affect the outcome of responses and decisions made by this emulation.

The time frame over which the brain emulation learning reinforcement occurs is nominally 21 days, but defaults to somewhat different durations on a temperament-dependent basis. Table 9 gives some representative default reinforcement intervals. ‘Permanent’ learning also takes place during times of emotional stress or trauma, during which the interval of this table is proportionately decreased.

TABLE 9
Temperamental Learning-Reinforcement Intervals

| Temperament | Duration |
|---|---|
| Choleric | 21 days |
| Sanguine | 18 days |
| Phlegmatic | 15 days |
| Melancholy | 21 days |

When the time is reduced (it does not effect preemptive training), the brain emulation is more likely to retain trivia and insignificant information. After the emulation is turned operational, those presets become an intrinsic part of its responses. They define the settings from the present time onward, until altered.

While in preemptive training mode, memories 11, 12, and 13 and other tables may be saved to external storage, upon command. This includes facts and relationals 1251 and 1252, and relevant parameter settings 22 and 20, and their defaults. In short, anything trained can be restored to the memory it came from. One skilled in the art will realize that the methods of saving memory and parameter states are dependent upon the technology of implementation, and that variations in these methods do not materially alter the system of the present disclosure.

When using a brain emulation of this invention to model a specific person (e.g., a foreign national for military purposes), the emulation's memory and parameter settings can be “snap-shotted” to enable a simulation re-run under new conditions or parameter settings. Anything learned between the snapshot and the time of their later reloading is lost and may not be incrementally recovered and reapplied, unless it was also snap-shotted.

Degreed Deference. A concept that plays a necessary role in human relationships is that of deference to another person something. Deference is not ‘black-and-white’, but exists by degree. Normally the human makes decisions that suit himself under the present conditions, without regard to other people. However, he/she will have particular regard (deference) to some people, such as parents, bosses, military chain of command and the like. The brain emulator uses degreed deference to emulate this implied relationship. Referring to FIG. 13, the Present-Need-to-Defer parameter 229 provides the weighting.

Multiple deference tables 128 may be created in memory 12, that apply in a specific context 1283 (e.g., military, political, social order, class). All deference tables are chained together using the links such 1284 and 1285. The analyzer 30 scans the deference tables to alter a tentative decision, if it conflicts with an external command, such as inferred from an imperative sentence in semantic analyzer 50.

Analyzer 30 seeks a deference table matching one or more active contexts of the moment, as maintained in state parameters 23. Finding one, it specifies the parameter for the rank self-identity. If the subject being measured for deference is another person, that person's ID 200 is used instead. The relational comparator 1280 makes its decision as the deference output 1282. The decision weighting 1296 is further adjusted by the present need to defer 229. Signal 1296 is then used to determine if any decision should be made at all. In this manner, the analyzer 30 defers to commands of authority it is subject to, or weights the decision outcome if the conflicting command was merely a recommendation of external authority.

The deference tables 128 therefore supply a realistic influence by external authority upon the brain emulation. When used in a military environment, for example, a simulation manager in charge of the brain emulator(s) can exert real-time control upon the brain emulations, if the manager's ID is placed at the top of all deference tables.

Preemptive training establishes the set(s) of hierarchical tables 128 for relationships between this emulator and others (or other people). The same prose-style description is used to describe the ‘chain of command’ and where the current brain emulation fits within it.

Establishing a down-line deference (i.e., a condition where another emulator or person should defer to this brain emulation) is permissible. It sets the emulator's expectations of that other emulator or person. Response to a violation of those expectations is dependent upon the base temperament specified for the present brain emulator, and may also be defined during preemptive training.

The Implementation of Temperament. Certain assumptions made by any such model of human psychological function, including this one, enable or simplify the understanding of brain functions. Properly done, they permit ready creation and implementation of a synthetic brain based on that model. They may be right, wrong or erroneous, but such assumptions permit rapid creation of a ‘baseline’ implementation. Such assumptions do not effect the overall means of this invention.

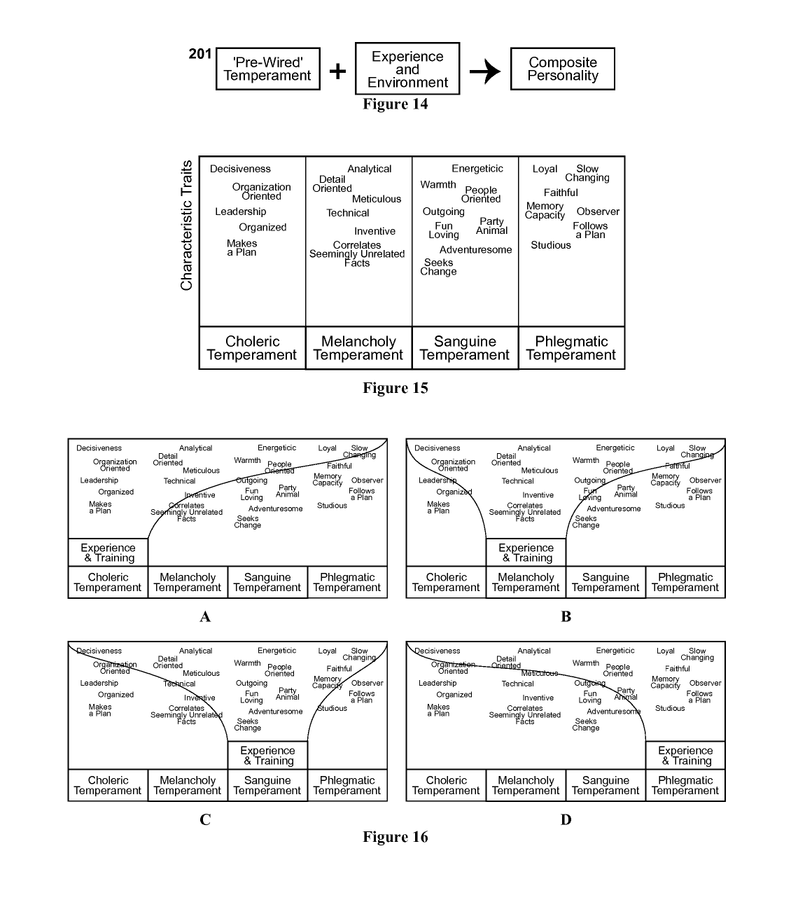

The FIG. 14 depicts one such assumption, the makeup of composite personality. The assumption is made that each person is ‘pre-wired’ at birth with a specific set of pre-dispositions, one of four basic types well known to those skilled in the state of the art. These include the Choleric, Melancholy, Sanguine and Phlegmatic temperaments, as categorized and defined among the basic tenants of classical psychology.

To these basic predispositions (temperaments) is added a set of experiences and training, learned from the environment in which the individual lives. The from-birth predispositions are collectively defined as a ‘base temperament’, as used here. The sum of that temperament and the set of experiences is used by the present invention to define the composite personality.

FIG. 15 depicts another assumption used by the present invention and model, approximate traits exhibited by the four classical temperaments. The above ‘pre-wired temperament’ 201 of FIG. 2 are replaced by the actual classical temperament names, in FIG. 15 and FIG. 16.

FIG. 15 illustrates typical traits (largely, but not fully) specific to one temperament type, as indicated above each temperament. FIG. 16 represents the composite personalities of people, each based upon one of the four underlying predisposition temperaments.

Through experience and training, the personality of a given underlying set of predispositions may ‘reach out’ to intentionally assimilate desirable characteristics of the other three temperaments. The result is a broader composite personality. The individual being modeled here, a Melancholy of FIG. 16b, for example, may embrace decisiveness or leadership traits more characteristic of a Choleric.

Another assumption made here simplifies the understanding of human behavior, and the implementation of this realistic brain emulator. It is that every person has one and only one basic underlying temperament, regardless of past or present experience or training. When placed under emotional or physical trauma, or under extreme pressure, the actions, behavior, interests and decisions made by the person (or emulation) tend to revert to those characteristic of the person's base temperament.

Obviously, other assumptions could instead be made about the origin and development of temperament and personality, ones which may be equally valid. These could be used here instead by way of examples, but do not, however, effect the present invention or its embodiments. The above assumptions provide a vehicle for the description of the present invention, and provide a means for visualizing an otherwise complex matter.

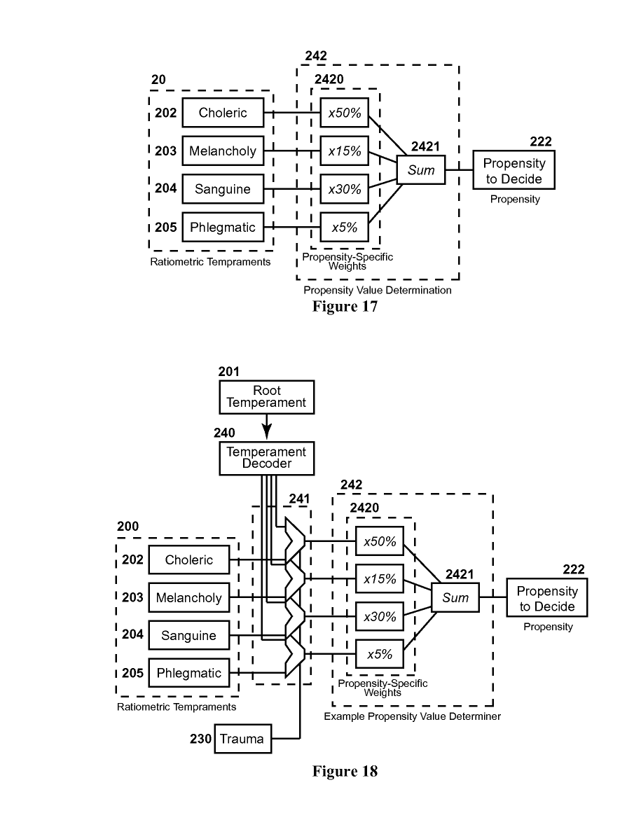

Weighting of Brain Parameters. FIG. 17 depicts the Choleric parameter 202 in its relationship to the Propensity-to-Decide parameter 222, noted earlier. The actual value of parameter 222 is the sum-of-products 2421 of the current values of all four temperament-controlling parameters, each with its own weight. The values of the weights 2420 applied are selected and fixed in the emulation, but the controlling temperament parameters may themselves be adjusted as desired.

It is desirable for one mode of operation that all of the four temperament parameters such as Choleric 202 have values of 0 or 100%, such that they are mutually exclusive. It is desirable for other modes of operation that the percentages of all four temperament parameters may be non-zero, but shall total 100% when summed. An example means to implement this is illustrated in FIG. 17.

It may be convenient, for example to ‘synthetically’ force the sum of percentages of the four temperament parameters to be 100%. Using weights 2420 given by the example of FIG. 17 the setting of the Propensity to Decide parameter 222 is given by the equation:
Propensity to Decide=50%*Choleric+30%Sanguine+15%*Melancholy+3%*Phlegmatic.

By ignoring how the ‘pseudo-neuron’ temperament parameters are set, they may be treated as normal neurons in a neural network.

A useful assumption made by this invention is that human beings (being emulated) have a root, or base, temperament at birth that gives the human certain propensities for behavior. Experience, training and growth may cause the human to take on selective traits found predominately in one or more of the non-baseline (‘pre-wired’) temperament.

Implementation of Trauma. A part of this invention is the implementation of the human response to emotional pressure or to physical or emotional trauma. Such response is modeled here, for example, as the reduction of impact of such experience, training and growth, such that the personality temporarily is dominated by the ‘pre-wired’ temperament. This is depicted in FIG. 18.

In FIG. 18, the elements of FIG. 17 are augmented by a selector 241, which takes as its output either of its two inputs, one or the other in its entirety, or a percentage of each input as selected by a determining control input. In this case, the normal operation and description depicted by FIG. 4 is altered under emotional or physical trauma or extreme pressure, as noted by parameter 230.

In this case, selector 241 is interposed between temperament sum 2421 and the Propensity to Decide parameter 222, such that when under trauma, that decision behavior is instead determined by the ‘pre-wired’ root temperament 201. The base temperament is pre-chosen as one of the operational set-up values for the brain emulation and is presumably unchanged for ‘life’, although nothing prevents such change.

Trauma parameter 230 is triggered and set by sensing other parameter or neuron conditions that indicate levels of extreme emotional pressure or trauma, or physical trauma or shock, for example, trauma 230 is configured to automatically decay with time, using a linear, logarithmic rate or other rate to its nominal ‘off’ (unperturbed) state or value. It is normally triggered by a change of the above conditions and can be re-triggered if the condition is sustained or recurs, and can be designed to decay immediately if the condition is removed.

The conditions triggering Trauma parameter 230 are not depicted in FIG. 18, but are presumed to exist, and consist of a sum-of-products of parameters and brain nodes from whose values the trauma can be sensed.

Handling of Gender. The basic methods of FIG. 18 are extended to differences of activity between male and female people. For this case, processing flow is augmented with additional multiplexor and weighting tables such as 241 and 242. These would be driven by the Gender parameter 209, instead of Trauma 230, for example. Where appropriate in the decision and thought processes, these additions are incorporated to account for gender-related processing differences.

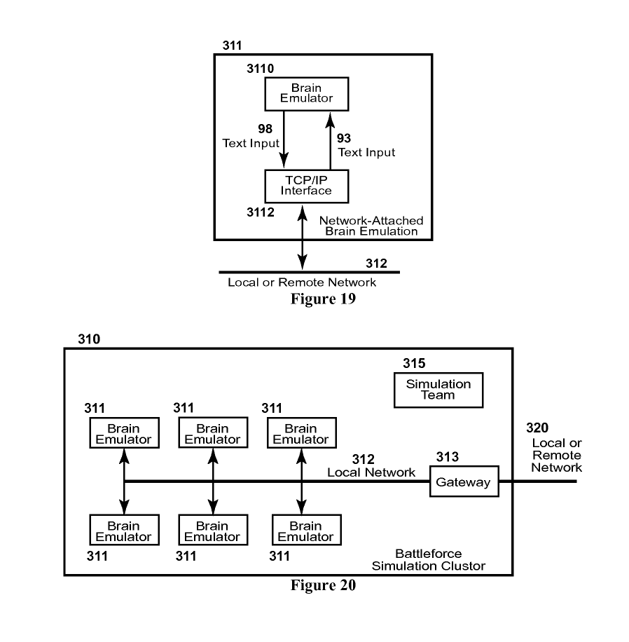

Use in Military or Political Simulations. Because this invention is capable of accurately emulating human behavior, the brain emulation finds use in many military applications. Using prior means, it is difficult to obtain accurate predictive modeling of combat force decisions, particularly those motivated by religious belief systems and belligerent political ideologies. In the present environment of asymmetric warfare, the ability to forecast combatant decisions becomes critically more important. The means of the present invention provide this capability. Refer to FIG. 19 and FIG. 20.

Brain emulator 311 as described previously can be configured to receive ‘verbal’ input in the form of a text stream 93 and to emit conversational output text 98. By the addition of a TCP/IP interface 3112, or other interface such as for the 1553 bus, the brain emulation 3110 can be network-connected to a local or remote network 312. It becomes a network-connected brain emulation 311. It should be evident to one skilled in the art that many variations of interface 3112 are possible without changing the system of the present disclosure

It is now possible to configure a cluster of these emulators together to form a team. In FIG. 20, these are demonstrated as a Battleforce simulation cluster 310, such as may be used to predictively model combatant forces. The same configuration can also be applied, for example, in an Unmanned Arial Vehicle (UAV) ‘cockpit’ to emulate a conventional flight crew, each individual specifically trained on for his task role within the crew. It can likewise be applied to an unmanned underwater vehicle, to make autonomous mission decisions when disconnected from the host vessel.

When used as a battleforce simulation cluster, a simulation team 315 of human operators can be assigned to upload intelligence to emulators 311 to accurate emulate key individuals in the modeled battleforce. As new information becomes available on the modeled combatants, preemptive training can be used to update the models.

The emulations 311 used in the simulation cluster can use the port concept of the TCP/IP protocol to restrict conversations among themselves. Such specific local-communications ports can be precluded from access by other such clusters via conventional internet gateway 313. Cluster 310 can then be used to emulate an enemy combatant force (e.g., a ‘Red’ force), an unknown combatant force, coalition or friendly (e.g., ‘White’ or ‘Blue’) forces, secure from each other.

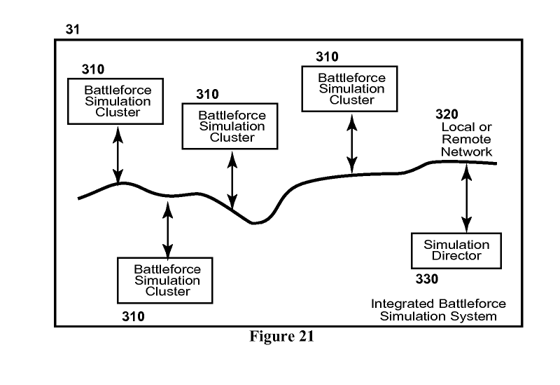

Multiple clusters 310 may be interconnected to form an integrated battleforce simulation system 31 as shown in FIG. 21. Simulations would be under the overall direction of a simulation director 330. The director 330 can have secure access to internal conversations within the battleforce clusters 310 by mans of a dedicated encrypted port that gateway 313 replicates and encrypts the local busses 320. This configuration permits independent simulation teams 315 to work independently of each other but under the scenario proposals and directions of the director 330.

The simulation director 330 can remotely take snapshots of the memory and brain parameters of all brain emulations in the system 31. By taking such periodic snapshots, the simulations can be ‘rewound’ and restarted with different scenarios, intelligence information or updated personality profiles.

Simulation teams 315 may preferably consist of psychologists and people with knowledge about the personalities, governments or composite forces they are responsible for emulating. This invention permits realistic inclusion of religious belief, moral convictions (or lack of them), chains of command and authority, and other relevant personal information required for accurate predictive modeling of people systems.

The simulation system 31 may be located in a local region or may be distributed across the world. Results of such simulations can be made available to the actual warfighters as a part of C41SR.

Parsing of Human Language

Definitives Versus Declarations

There are many alternative organizations for the process that separates definitive sentences from declarations. This is generally controlled by the structure of structure defined in the Baccus-Nauer Format (“BNF”) file that describes the natural language (e.g., English).

The Language Definition

The parser itself is created in a top-down description of the language, and the description (a “.BNF” file) is then translated by the Lingua compiler into a C++ class that serves as a parser. At run-time, that class parses the sentence in accordance with the language definition in the BNF file. Incoming sentences are parsed according to that definition, and the constituent parts are pushed onto a stack.

The BNF is written in top-down fashion, such that a sentence is defined as a Subject and a Predicate, while a Subject is a Noun Phrase, which itself is an optional ‘a/an’ determiner, a set of optional adjectives and a noun-equivalent. This process progressively defines sentence parts in more detail, and includes all realistic variations that a sentence may have.

The Parsing Stack

As parsing progresses, information from the sentence is tossed onto a stack in a first-in, first-out order. Where the parser has attempted to parse something as a Clause when in fact it is not, all information related to the (suspected) clause is discarded and later replaced by the correct data.

For the sake of convenience, significant portions of the sentence such as Subject, Predicate, Independent Clause and others are bracketed on the stack by begin/end markers.

Identifying a Definitive Sentence

A ‘definitive’ sentence defines something. The brain supposedly remembers the definition of a word, and possibly makes associations or relationships with it. In practice, definition of a word or topic may begin with a definitive sentence, but the definition is elaborated with declarative commentary afterwards.

Generally speaking, it is possible to know whether or not a sentence is a definitive (a “DEFN”) strictly from structure of its grammar. If all sentences were well-formed, it would be reasonable to identify the DEFN entirely within the BNF description of a definitive.

In practice that places significant and unreasonable burden on the BNF. Further, the BNF cannot identify subsequent declarative topic expansion being defined as definitive. It must be ascertained in a step to follow.

The parser should be as streamlined and fast as practical. Currently the majority of the process load is caused by efforts to differentiate between definitive and declarative statements. A lot of recursion occurs as one pattern match is attempted, fails, and another is tried. Additionally, other sentence types calling on these same patterns have to go through this extra recursion as well.

In the real world, many problems arise within us when we, as people, get “declarations” pushed into our ‘DEFN centers,’ giving ideas more import than they deserve. Racism, bigotry and hatred seem to all occur when a declaration gets handled as a definition. I think we need to be very choosy on what we let come through as definitions. IMHO, the best way to handle that would be post-parsing. As a note, I believe we would be better off erring on the DECL side by missing a DEFN. This seems to be less catastrophic than pushing a false DEFN.

The brain's following parsing system could be used to assist post-parsing:
1. All statement patterns get pushed to the stack as declarations.
2. The parser throws clues to the stack to help post parsing determine how to handle the statement. Modifiers (e.g., all, some) and determiners (a, an, the) in the subject and verb types (is, are) are primary elements useful to determine if a statement is definitive. An interface function can rule out a DEFN by checking for a set of these conditions. A token can be pushed saying: a. DECL, or b. POSSIBLE_DEFN.
3. Such tokens can be pushed within each independent clause.

Post parsing can more readily look forward within the stack to help determine a DEFN versus DECL, because we are not restricted to any cases or sub-patterns of the statement pattern. This system is more efficient, and in the end enables us to accurately differentiate between DEFNs and DECLs.

Ascertaining a Declaration

Modifiers (e.g., all, some) and determiners (a, an, the) in the subject and verb types (is, are) are primary elements useful to determine if a statement is definitive. Absence of a direct object is also a possible indicator of a definitive sentence. The original methods devised to determine a DECL were:

TABLE 1
Some Conditions for Definitives

| | Remarks | Vb Suffix | Examples |
|---|---|---|---|
| Pres-Simple | | | |
| Forms: | | | |
| A. ITV | | | Dogs bark. |
| B. IRR - PRES | | | Dogs unwind. |
| C. Vos | Gerund | | dogs enjoy hunting. |
| E. Vos | Adj | | Dogs act strange. |
| F. Vos | Noun_Ph | | Dogs resemble their |
| | | | owners. |
| IS-BE Forms: | | | |
| A. Is_Be | IRR_PPART | | Houses are built/broken. |
| B. Is_Be | IRR_PRES | ers, ed | Dogs are forgivers. |
| C. Is_Be | Noun_Ph | | Dogs are animals. |
| D. Is_Be | Adj_Ph | | Dogs are slimy. |

These are now replaced with the following:
These 3 conditions must be met for the statement to be a possible DEFN:
Is_Declaration—The statement must parse via the declaration pattern.
!Decl_Deter—This flag is set off by pronouns in the subject, demonstratives in the subject or a definite article (“the”) in the subject.
(Is_Be∥Pres_Vb)—Is_Be indicates the verb is an Is_Be verb. Pres_Vb is set for all present verbs.
   If all 3 of these conditions is met, we possibly have a DEFN.
1. Dogs are animals.
2. Parsed by the DECL pattern.
3 No pronouns in the subject (she is blue), no demonstratives in the subject (that dog is blue), no definite articles (the dog is blue).
4. “is”=Is_Be verb.
   Dogs are animals. =POSS_DEFN

If any of these 3 conditions is not set, we have a DECL.

1. dogs are animals.

| | | |
|---|---|---|
| Stack + 0 | BEG_CLS | <CLS> 0 |
| Stack + 1 | POSS_DEFN | dogs are animals. |
| Stack + 2 | BEG_SUBJ | <SUBJ> |
| Stack + 3 | T_NOUN | dogs (1639) |
| Stack + 4 | END_SUBJ | </SUBJ> |
| Stack + 5 | SUBJECT | dogs |
| Stack + 6 | BEG_PRED | <PRED> |
| Stack + 7 | T_VERB | are (1000) |
| Stack + 8 | ACTION_PRES | (action in present) |
| Stack + 9 | VB_PLURAL | (plural) |
| Stack + 10 | T_NOUN | animals (1626) |
| Stack + 11 | VB_GER | animals |
| Stack + 12 | CONVEY_ONGOING | (progressive) |
| Stack + 13 | ISNT_CNDX | (1626) |
| Stack + 14 | END_PRED | </PRED> |
| Stack + 15 | PREDICATE | are animals |
| Stack + 16 | END_CLS | </CLS> 0 |

Parse-to-Neuron Mappings

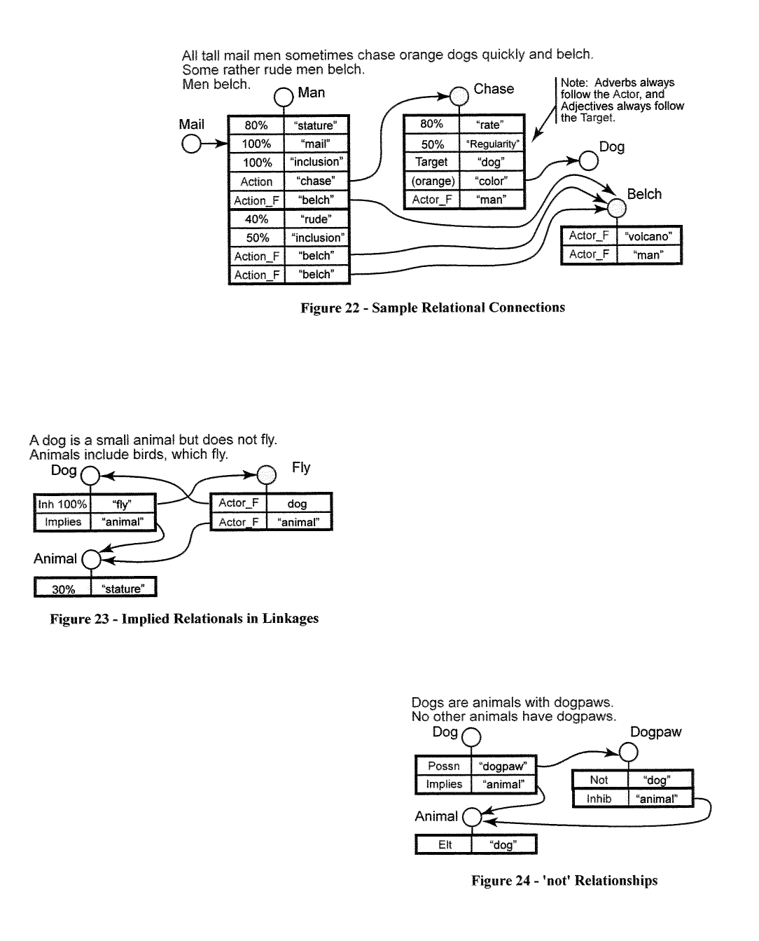

Referring to FIG. 22, there are illustrated sample relational connections. The following example sentences are parsed (as definitive sentences) and are then used to permanently create neural relationships. The groups of boxes, the Man and the Chase neurons, are relational connections stored with the respective neuron.

This example shows how two sentences on the same general topic (e.g., men), defining what certain men are like. It also demonstrates what/who is known to be capable of belching (whatever that means).

FIG. 22 uses some of the values from Table 1 below.

Table of Relational Commands

TABLE 1
Interpretation of Relational Weights

| | Neuron | |
|---|---|---|
| Weight Item | Index | Remarks |
| (See Remarks) | “how” | |
| (See Remarks) | “what | |
| | manner” | |
| R_ACTION | Verb | Used by any neuron to specify action to take if |
| | Neuron | relationals enable. This must be the last relational |
| | | of an AND set. |
| R_ACTION_F | Verb | Same as R_ACTION, but terminates a list subset. |
| | Neuron | |
| R_ACTOR | Noun | Used by verb neuron to indicate who fired this |
| | Neuron | relational set. This must be the last relational of |
| | | an AND set. |
| R_ACTOR_F | Verb | Same as R_ACTOR, but terminates a list subset. |
| | Neuron | |
| R_CDX ±0 . . . 100% | Emotion | Degree of influence/coupling. −100% is full |
| | Neuron | suppression. |
| R_CDX, ±0 . . . 100% | “regularity” | 0 == Never, 50% == Sometimes, 75% == Often, |
| | | 100% = Always |
| R_CDX, ±0 . . . 100% | “inclusion” | 0 == None, 15% == Few, 50% == Some, |
| | | 100% == All. If the level of inclusion is 100%, |
| | | relational is superfluous and may be removed. |
| R_CDX±0 . . . 100% | Wiring | Degree of influence/coupling. −100% is full |
| | Neuron | suppression. |
| R_DO | Verb | Direct Object indicator |
| | Neuron | |
| R_ELT | Noun | Membership in a class (e.g., on ‘dog’ for “dog is |
| | Neuron | an animal”. |
| R_GAMUT (0-31) | Any Neuron | Gamut table of 1-32 entries follow. |
| R_IDO | Verb | Indirect Object Indicator |
| | Neuron | |
| R_IMPLIES±0 . . . 100% | Any Neuron | % degree of similarity to the target neuron. |
| | | (“Dogs are animals” ==> 100%, “Cows may fly” |
| | | ==> 30%). |
| R_INHIBIT±0 . . . 100% | Any Neuron | % inhibition of firing target neuron, even if other |
| | | relationals enable it. |
| R_NOT | Any Neuron | Complements present composite conditions set. |
| R_POSSN, ±0..100% | Noun | % of ownership. (“Dogs mostly have hairy |
| | Neuron | coats.”); |
| R_PREP | Verb | Preposition (see examples below) |
| | Neuron | |
| R_PREP | “when” | May be BEFORE, AFTER, etc. 50% ==> now. |
| R_PREP | “where” | May be IN, OUT, UP, DOWN, ABOVE, |
| | | BELOW, etc. |

Examples of Implies and Possession

Other examples of relationships established using the relational records of Table 1 is shown in FIG. 23, particularly illustrating the R_IMPLIES (100%) case and the NOT (inhibitor) case. The linkage codes may be intermixed within either the noun or verb neuron relationals.

Example of not (Negation)

Use of negation is primarily an ‘inversion’ operation. For example, in FIG. 27, dogs are established to be animals (via Implies), and to have ‘dogpaws’ (via Possn). The constraint is put on dogpaws (via Not) that inhibits ‘animals’ from turning on unless ‘dog’ is hardly firing.

That is, Not complements (subtracts from 100%) the present recognition level of ‘dog’. If we don't think the object we're looking at is a dog, i.e., the firing level for ‘dog’ is only 20%, use of a Not then inhibits ‘animal’.

Sleep-Time Cleanup

For a given neuron, there may be many sub-lists of relationals that are identical, replicates of each other learned for the same fact re-learned at a later date. There may also be sub-lists that are virtually identical, except perhaps for a relatively small difference in the weights used.

To condense such sub-lists an reclaim the space, a ‘background job’ can be run while the brain is sleeping or otherwise not occupied. This operation can go in and remove the redundant linkage, adjusting the weights to other neurons to a suitable compromise value.

Animation of Emotion

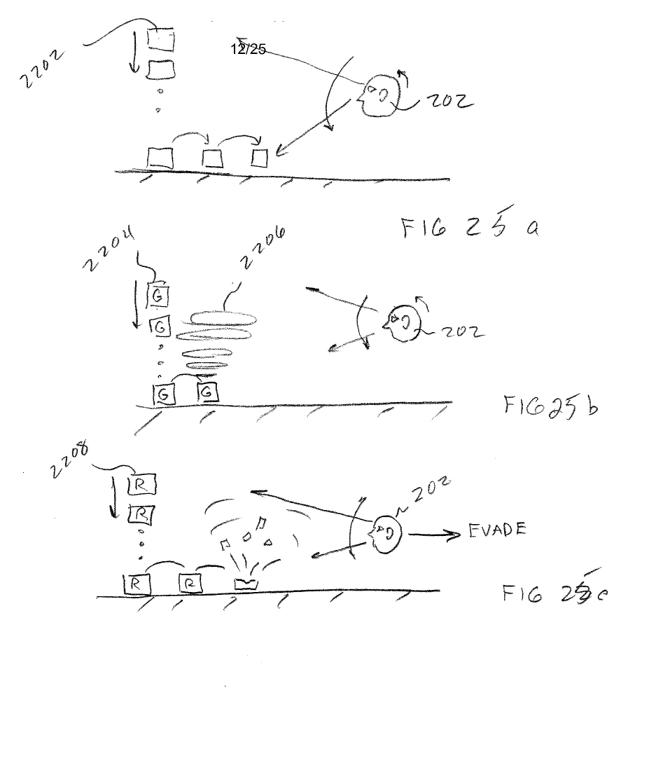

Referring now to FIGS. 25a-25c, there is illustrated a sequence of animations that illustrate the initial concept of imparting emotions to a character. In the animation of FIG. 25a, a box 2502 is dropped into the environment of the character 202. This box is a generic box and will elicit nothing more than curiosity. This emotion of curiosity will be reflected (although not shown in detail in this figure) by some type of facial expression change. This could be opening of the eyes, tightening of the lips, etc. Further, the eyes of the character 202 are first directed upward toward the box 2502 at the upper portion of the screen and then are animated to follow the box to the bottom surface and then as it bounces along the surface. The character 202, at this time will exhibit nothing more than curiosity as the box bounces and may indicate this as some type of pleasant experience. However, this is generic.

With reference to FIG. 25b, there is illustrated a diagrammatic view wherein a specific instance wherein a green box 2504 is dropped from a height and bounces one time and then the animation generates a “Christmas tree” morph 2506. This Christmas tree morph is indicated to the user by a predetermined indication, as a pleasurable experience. The character 202 will come as with FIG. 25a, move the visual access with the green box and will recognize the box as being green. Based upon prior experiences, the recognition of the box 2504 as being green will result in the expression of an emotion of pleasure on the animated face of the character 202. This may be just a slight expression indicated primarily in the fact that it considers the box beautiful. Whenever it considers the box beautiful, it indicates a certain amount of morphing to express a response to beauty. However, when the morph 2506 occurs, then the expression of pleasure is animated onto the face of the character by a particular morph and the strength of this pleasure is a function of the size of the morph 2506, the distance of the morph from the user, etc. This will be described in more detail herein below. Thus, the expression can change as the box 2504 falls, as the recognition is generated that it is a green box, and there may also be an anticipation or expectation that the morph 2506 will occur. This, of course, as will be described herein below, depends upon prior experiences. If the user had a prior experience that the box 2504 would morph into the Christmas tree morph 2506, then the character 202 would anticipate some type of pleasure as the box bounced the first time and there would be an expression of pleasure, albeit probably small, before the morph 2506 occurs. When the morph 2506 occurs, a much more pleasurable morph would occur. This morph could be an increased smile, an opening of the eyes, drawing back of the cheeks, etc. As will also be described herein below, this morph is basically the control of various facial muscles in the animated face of the character.

Referring now to FIG. 25c, there is illustrated an alternate embodiment wherein an un-pleasurable event occurs, this being an un-pleasurable morph. This is illustrated with a red box 2508 falling into the environment of the character 202. The character 202, with the animated version thereof, will move its visual access from the upper portion down to the lower portion and watch the box 2508 bounce twice before it explodes. This explosion will induce the emotion of fear which will be morphed onto the face of the user and this will also cause certain animated movements in the character 202. This is termed an “evasion” response. In the simplest matter, the evasion may be a turning away of the head. The evasion and the emotion are basically two different things, but they are morphed together. Initially, when the character 202, based upon past experience, recognizes that the box is a red box, the character 202 may have an initial indication of the emotion of fear. This will be expressed in possibly a slight morphing of the face to represent fear. This could be a tightening of the lips and opening of the eyes. At this point, the emotion of fear is a minimum morph, as a red box could be interpreted as many things, for example, a Christmas present, etc. However, a prior experience indicated to character 202 (by assumption) that red boxes explode, especially when they fall from a certain height. Also, there is an expectation that this particular red box will explode on the second bounce. Thus, as the box falls, and after two bounces, a predetermined delay, fear will increase somewhat as a result of an expectation, this being before the actual explosion of the box. When the box explodes, then fear is intensified. All of this intensity is accumulated and will be expressed by the control to the facial muscles of the animated face of the character 202. Further, there will be an evasion animation to the movement of the character. As the intensity increases, the eyes may open wider and there may be a “grimace” on the face. This grimace will increase and the head will turn away from the explosion as a result thereof. If the explosion were in front of the character 202, the character might turn and retreat. Whether it is right or left is not important. However, if it was interpreted that the box fell to the right of the character, the animation would cause the character to turn to the left and move to a point of safety in its environment.

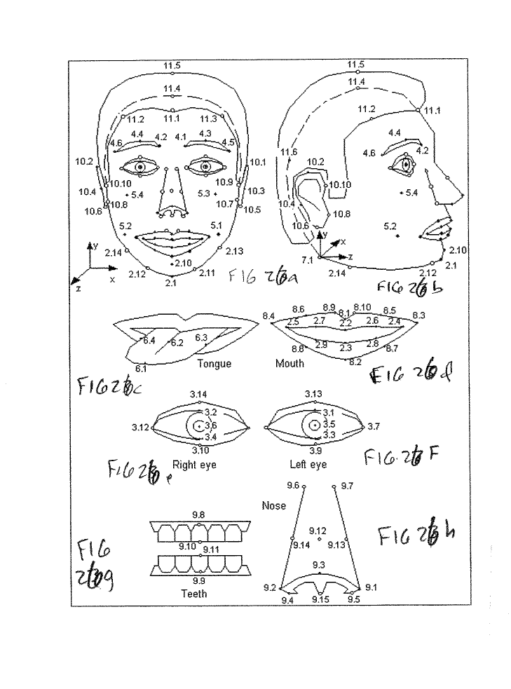

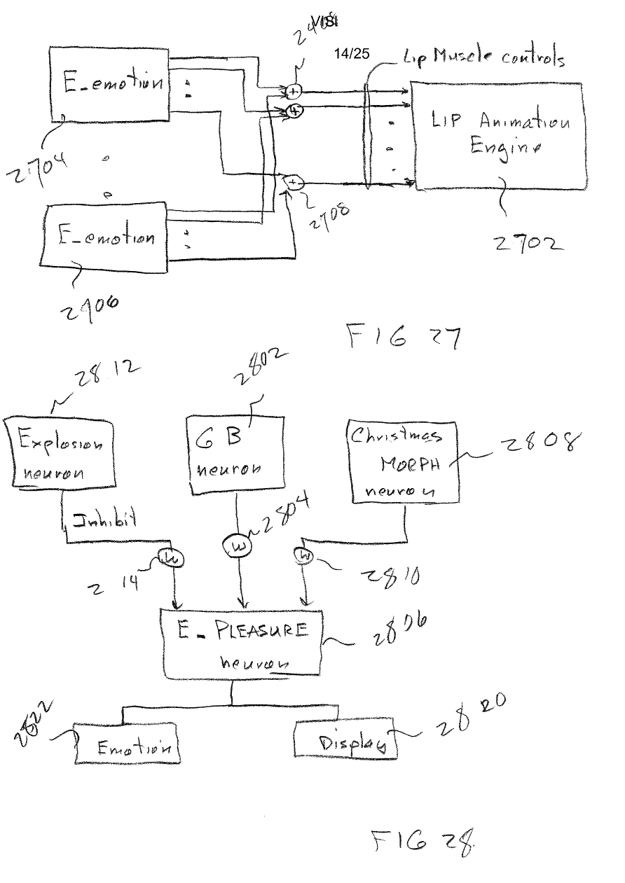

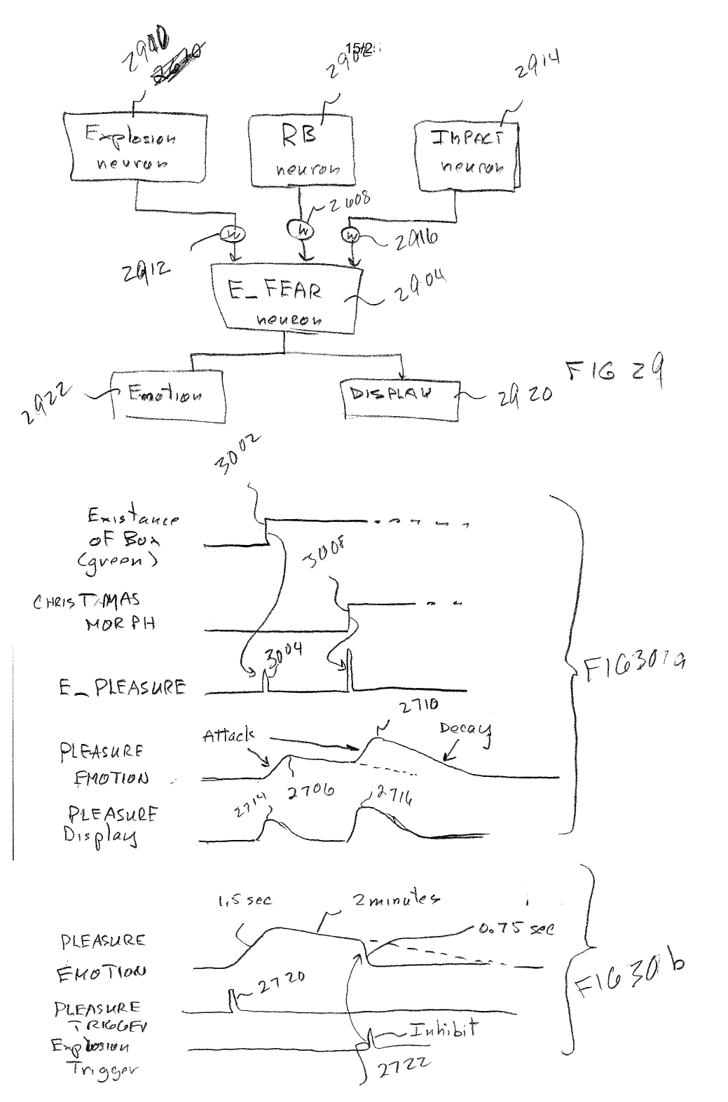

Referring now to FIGS. 26a-26h, there are illustrated various animated portions of the face. Typically, the face is comprised of a plurality of geometric points which are typically defined by the vertices of triangles. These define the various “hooks” that can be correlated to muscles in the actual human face. Typically, these animation engines utilize some type of geometrical representation of a 3D model of a character and they provide various points on each feature that can be moved in three dimensions. Typically, these points are moved relative to a common reference axis, such as the center of the head. As the head moves, the relationship between this particular point and the center is maintained. For example, if all that was required to express emotion was to move the left corner of the lip upward to create a smile, that point would be moved up relative to some reference point in the head and this would be maintained when it was moved. In one standard, the MPEG-4 standard, the face is defined as a node in a scene graph that includes facial geometry ready for rendering. The shape, texture and expressions of the face are generally controlled by the bitstream containing instances of Facial Definition Parameter (FDP sets) and Facial Animation Paramater (FAP sets). Upon initial or baseline construction, the Face Object contains a generic face with a neutral expression, the “neutral face.” This face is already capable of being rendered. All it needs is the various controls to effect particular feature points. The FAPS will produce the animation of the face: expressions, speech, etc. If FDPs are received, they are utilized to transfer the generic face into a particular face determined by its shape and (optionally) texture. These are all very standard procedures and many of the procedures can be utilized and are anticipated, although not described.

Returning to FIGS. 26a-26h, it can be seen that FIG. 26a illustrates a forward profile of a face with the various feature points disposed thereabouts for cheeks, lips, nose, eyes, eyebrows, etc. FIG. 26b illustrates a side view. There is illustrated a point “7.1” that represents a vertice of the various axis of movement of the head itself. This is a reference point upon which substantially all of the points are referred. FIG. 26c illustrates the feature points for a tongue, which is a morph that can be created, whereas FIG. 26d illustrates the feature points for the mouth, i.e., all of the points of the lip. FIGS. 26e and 26f illustrate the right and left eyes and the various morphs, such that the eyes can be opened and closed. FIG. 26g illustrates the feature points for the teeth, such that the teeth can be opened and closed. FIG. 26h illustrates a feature point illustration of the nose with the various points that can be moved. In general, the parameters that control this, the FAPs are based on the study of minimal perceptible actions that are closely related to muscle action. In this one embodiment disclosed, which is indicated as not being limiting, as are many other aspects, there are typically 68 parameters that are categorized into 10 groups related to points of the face. This is illustrated in Table A.

TABLE A
FAP groups.

| | Number of FAP's |
|---|---|
| Groups | in the Group |
| Visemes and expression | 2 |
| Jaw, chin, inner lowerlip, cornerlips, midlip | 16 |
| Eyeballs, pupils, eyelids | 12 |
| Eyebrow | 8 |
| Cheeks | 4 |
| Tongue | 5 |
| Head rotation | 3 |
| Outer lip positions | 10 |
| Nose | 4 |
| Ears | 4 |

The FAPs represent a complete set of basic facial actions, including head motion, tongue and mouth control. They allow the representation of natural facial expression. They can also be used to define facial action units.

In general, the FAPs define the displacements of the feature points in relation to their positions in the neutral face. In particular, except that some parameters encode the location of the whole head or the eyeballs, a FAP encodes the magnitude of the feature point displace along one of the three Cartesian Axes. This is illustrated in, for example, Table B.

TABLE 2
FAP description table.

| | | | | | | | FDP |
|---|---|---|---|---|---|---|---|
| | | | | | | | Sub |
| | | | | Uni/ | Pos | | Grp |
| # | FAP Name | FAP Description | Units | Bidir | Motion | Grp | Num |
| . . . | . . . | . . . | . . . | . . . | . . . | . . . | . . . |
| 3 | Open_jaw | Vertical jaw Displacement | MNS | U | down | 2 | 1 |
| | | (does not affect mouth | | | | | |
| | | opening) | | | | | |
| 4 | Lower_t_midlip | Vertical top middle inner lip | MNS | B | down | 2 | 2 |
| | | displacement | | | | | |
| 5 | Raise_b_midlip | Vertical bottom middle inner | MNS | B | up | 2 | 3 |
| | | lip displacement | | | | | |
| 6 | Stretch_l_cornerlip | Horizontal displacement of | MW | B | left | 2 | 4 |
| | | right inner lip corner | | | | | |
| 7 | Stretch_r_cornerlip | Horizontal displacement of | MW | B | right | 2 | 5 |
| | | right inner lip corner | | | | | |
| 8 | Lower_t_lip_lm | Vertical displacement of | MNS | B | down | 2 | 6 |
| | | midpoint between left corner | | | | | |
| | | and middle of top inner lip | | | | | |
| . . . | . . . | . . . | . . . | . . . | . . . | . . . | . . . |

Thus, all that is required is some type of control that determines a change in position with respect to a particular feature point. As noted herein above, for example, if a smile were to be desired, the feature points in FIG. 26d, the left corner “8.3” and the right corner “8.4” would be moved upward and backward relative to the face and relative to the reference point of the head. This would cause a smile. Of course, also there would be some movement of the cheek, for example, the point “5.2” and the point “5.1” in FIGS. 26a and 26b. The intensity of this movement, i.e., the amount of the “muscle pulled” is defined by the amount of the emotion that is to be expressed. An alternative to use of FAPs is to map the emotional expressions directly to one or more facial muscle

Referring now to FIG. 27, there is a block diagram illustrating how an emotion can be mapped into a various portion of the animation engine. In this example, there is referred to a single engine as merely the lip animation engine, an engine 2702. This lip animation engine is operable to represent the various facial muscles illustrated to control the lips for the purpose of a smile. Of course, there will also be a cheek animation engine, a teeth animation engine, and an eye animation engine, among others, in order to express any particular emotion. For the purpose of this disclosure and for the purpose of simplicity, only the lips will be discussed with respect to multiple emotions.

There are illustrated two emotions, although there could be many emotions that would provide some type of muscle control to the lips. These are an emotion 2704 and an emotion 2706. The emotion 2704 may be pleasure and emotion 2706 may be fear. Each one of these emotions will provide multiple outputs, one for each muscle in the lip animation engine 2702. For example, in one embodiment, there are 44 muscles or “feature points” in one exemplary animation system just for the purpose of controlling the face. If the pleasure emotion, for example, emotion box 2704, wanted to express a certain amount of emotion, then the intensity of certain muscles would be generated. This is in effect a mapping function of an input into a, for example, “smile.” Each of the outputs would provide a certain level of “intensity” to the muscle that would be input into an associated summing node 2708, there being one summing node 2708 for each of the outputs. The second box 2706 may represent a different emotion, for example, fear. This may result in different muscles being manipulated in a different direction, some in a negative direction, some in a positive direction. This would be for the purpose of generating, for example, a “frown.” Additionally, each of the emotion blocks 2704 and 2706 could represent different emotions. For example, there might be the concept of beauty and pleasure that resulted from a particular sequence occurring within the proximity of the character 202. Each of these would affect the muscle in a slightly different manner, and the summing nodes 2708 will sum up the intensity levels. For example, it might be that the pleasure emotion results in a certain intensity to the smile to raise the left corner of the lip upwards. The beauty emotion node may result in the same expression of emotion, which, when summed, will increase the level of “pull” on the left corner of the lip. This pull will be increased as the sum of the intensities of both emotions which one would expect in a normal human's expression of the combination of two such emotions.

Referring now to FIG. 28, there is illustrated a diagrammatic view of the various neurons that may be associated with the green box falling into the space. There is provided a green box neuron 2802. This green box neuron is a neuron that has associated with it various relational aspects to other neurons in the system that it had learned to be linked to or related to. As will be noted herein below, this neuron is not necessarily linked to any other output neuron, such as the pleasure neuron, the fear neuron, etc., unless there is some reason to be linked thereto. However, there is some prior experience in this illustration, wherein the green box neuron 2802 was linked to the pleasure neuron. There will be a weight 2804 associated therewith, this weight being for the purpose of modifying the output of the green box neuron. This weight is essentially a multiplier. The output of the green box neuron is a representation of a level of recognition of the green box neuron. For example, if the green box neuron were faintly recognized, i.e., it were a shade of green, then the intensity may not be that high. Therefore, the height of this recognition could vary. The multiplier that is part of the weight 2804 is utilized to basically modify how strong the link is between the green box neuron 2802 and an emotional neuron, a neuron 2806 defined as the neuron associated with pleasure. The strength of this multiplier is a function of multiple things. There may be a predetermined expectation (not disclosed in this figure) that sets this weight to a certain level. Pleasurable experiences, i.e., history, can also make this multiplier stronger. Further, if a green box were disposed a distance away from the character 202, this multiplier may be decreased also by distance, i.e., this modifies the strength of the link. Therefore, the output of the weight 2804 will be a combination of the multiplicand and the strength of the recognition. This is input to the pleasure neuron 2806. Additionally, the Christmas morph is represented by a neuron 2808. This also will have associated herewith a weight 2810 that can also modify the effect or the strength of the length that the Christmas tree morph has to the neuron 2806. This, again, can have the weight value or multiplicand effective by the distance of the Christmas morph and box, the intensity of the morph, etc.

There is also provided an additional neuron, this associated with an explosion in a neuron 2812. This neuron is a neuron that will have many relationals associated therewith, as will be described herein below, but this will have a learned response or predetermined response that will cause a suppression of emotion to occur. This, as will be described herein below, is different than a trigger feature for the neuron. This inhibit feature may also be weighted by experience, distance, etc., through a weight 2814. In a sense these weight values for weights 2804, 2810 and 2814 are “qualifiers”.

As will be described herein below, there are trigger events that occur when the green box is recognized, when the Christmas morph occurs, and when an explosion occurs. These are all input to the neuron 2806 and result in the output of an emotion, which has other purposes in the system and also for the display of that emotion. These are two different aspects, as they are present for certain periods of time. Thus, there may be a display portion 2820 that determines how the display is expressed and for what length of time and the intensity thereof, etc. This is the aspect disclosed herein above with respect to FIG. 27. There will also be an emotion aspect 2822 that will provide an output that can be utilized for other purposes in the system. The other aspect is a level that represents an internal temporal level that is determined by the trigger inputs which will cause the level to increase for a period of time.

An alternate embodiment, that associated with the red box, is illustrated in FIG. 29. In this embodiment, there is provided a red box neuron 2902 that is linked to a FEAR neuron 2904 through a weight 2908. There is also an explosion neuron 2910 that is linked to the neuron 2904 through a weight 2912. There is noted that this explosion neuron 2910 has a relational link and not an inhibit link, as is the case with respect to the embodiment of FIG. 28. This positively affects fear. There is also illustrated, as an addition, an impact neuron 2914 which is linked to the neuron 2904 through a weight 2916. This could be the situation where, for example, the red box were falling, and it was recognized as a threat and the impact of the box onto the surface had a relational link to the fear neuron 2904 to cause some type of response. The FEAR neuron 2904 is also linked or mapped to the display through a block 2920 and to an emotion output through a block 2902.

Referring now to FIGS. 30a and 30b, there is illustrated a diagrammatic view of how the controls are facilitated through each of the pleasure neuron 2806 in FIG. 28 and the fear neuron 2904 in FIG. 29. First, the first occurrence in time would be the existence of the box, i.e., the green box in this example. This would occur at a point 3002. At this point in time, the brain will go through a recognition procedure in what is referred to as a “visual coretex” portion thereof, to recognize that not only is it a box but it is a green box. This recognition then goes to the green box neuron 2802 and generates a trigger input 3004 that is input to the pleasure neuron 2806 of FIG. 28. The intensity of this trigger is determined by the recognition level of the green box and of the weight. As noted herein above, it may be that multiple occurrences of this green box resulted in a fairly strong weight due to the fact that it had been previously recognized as pleasurable. Thus, there will be the result that a certain level of the trigger will occur. What this will do is it actually will cause the emotion box 2822 to output a pleasure emotion. This causes the output level or intensity level therefrom to rise to a certain level at a peak 3006 and then decay. The purpose of this is that any experience creates an initial indication of pleasure which then fades due to “boredom” for example. However, when the Christmas tree morph occurs, at a point in time 3008, the Christmas tree morph neuron 2808 will trigger. The intensity of this trigger is effected by the recognition of the morph, the size of the weight 2810, etc. However, it is indicated as being a more pleasurable experience than the occurrence with the green box by itself. This creates a trigger with a higher intensity level output from the weight block 2810. This causes a second increase in the pleasure emotion output from the box 2802 causing the level of intensity to increase to a peak at a point 3010 which then will decay off. Again, in order to represent things such as boredom, etc. The output of the emotion box 2822 is operable to provide to the rest of the brain information about that associated emotion. This temporarily varying level can be used to affect various discussion thresholds utilized by various partitions of the brain core. For example, it could affect decision outcomes such as “I feel like it.”

In addition to the output box 2822, there is illustrated the output of a box 2820, that associated with the drive to the display. As noted herein above, when the pleasure neuron triggers, it will be mapped to many feature points on the animated face of the character. These feature points all have a mapping that will be associated with each other in a relative manner. The intensity of all of these features will be correlated with a single output. However, it is noted that emotions will have a longer decay time, i.e., they will exist longer than the actual display or expression of that emotion. Therefore, the expression of a particular emotion may occur faster and decay faster than the actual existence of the emotion. This is illustrated by the fact that the trigger or the existence of the box at the trigger 3004 will result in a faster rise of the output of the pleasure neuron associated with the display, i.e., has mapped to the display at a point 3014. This will decay off relatively fast compared to that associated with the retention of the emotion itself and then it will again rise when the trigger for the Christmas morph will occur, thus rising up to a point 3016 and then decaying. In essence, this is similar to the fact that an individual would begin a smile when it first recognized the box and then the smile would decrease until the Christmas tree morph would occur. However, the emotion of pleasure would be retained and the entire experience would be pleasurable. Therefore, a longer decaying time for the emotion output would be represented relative to the display of that pleasure.

Referring now to FIG. 30d, there is illustrated the concept of the inhibit operation. It can be seen that the pleasure emotion, for a single pleasure trigger 3020 will result in a rise time for the pleasure emotion output from box 2822 at a rise time of, in one example, 1.5 seconds. The decay time for this, with nothing else, might be approximately 2 minutes. After two minutes, the emotional state of the particular character 202 would be back to neutral. However, before such two minute decay has occurred, some event occurs that would inhibit pleasure, i.e., the existence of an explosion. This is represented by a trigger 3022. At this point in time, the pleasure state with the pleasure emotion will be forced to decay at a rate of 0.75 seconds, i.e., fairly quickly. The same will occur with respect to the display, as not only will the inhibit action remove the controls to the facial muscle associated with pleasure, but the fear neuron will cause (possibly) an opposite action for the facial muscles. They will essentially be independent but only in summation. The concept is basically that any control of the facial muscles associated with the pleasure neuron is removed faster than the decay time associated with the diagram illustrated in FIG. 30a.

Referring now to FIG. 31, there is illustrated a diagrammatic view of a summing operation of a particular neuron. Each of the feeding neurons, i.e., the ones that have a relational link with a particular emotional neuron will have the trigger aspect thereof input to a summing junction 3102. Each of these will be input and provided as an output. The output is illustrated in FIG. 31a. This sequence of pulses in FIG. 31a is the result of the summing junction output and these are input to the boxes for generating a display output or an emotion output. The emotion output is illustrated in association with the display box and it can be seen that each of the pulses in FIG. 31a will result in small increases in the facial muscles for a particular display of emotion which all correlate to the pulses. The various intensities of the pulses will affect, of course, the intensity of the control that is passed on to the facial muscles. As noted herein above, all that is required is a single input of intensity which will be mapped through all the muscles in a relative manner, i.e., if there are 44 muscles in the face, a smile will be displayed which will be relative as to the various facial points. Additionally, there will be an inhibit block 3106 that will be directly input to both the emotion block and the display block to affect the operation thereof, i.e., will cause the outputs thereof to be inhibited or moved to zero.

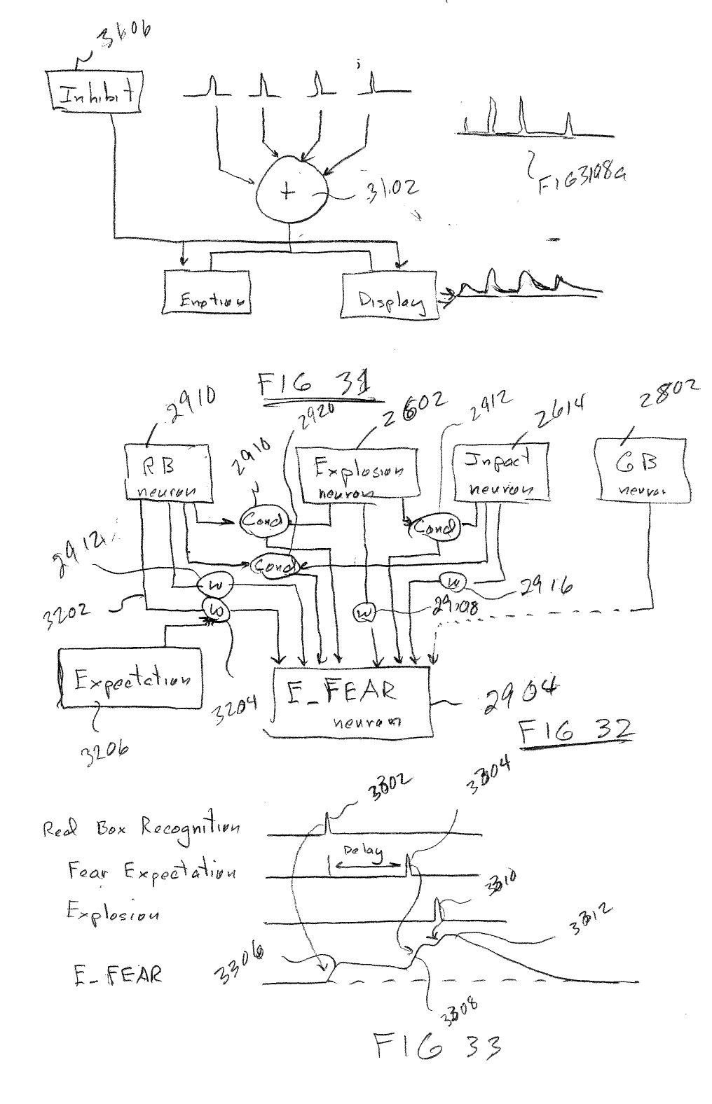

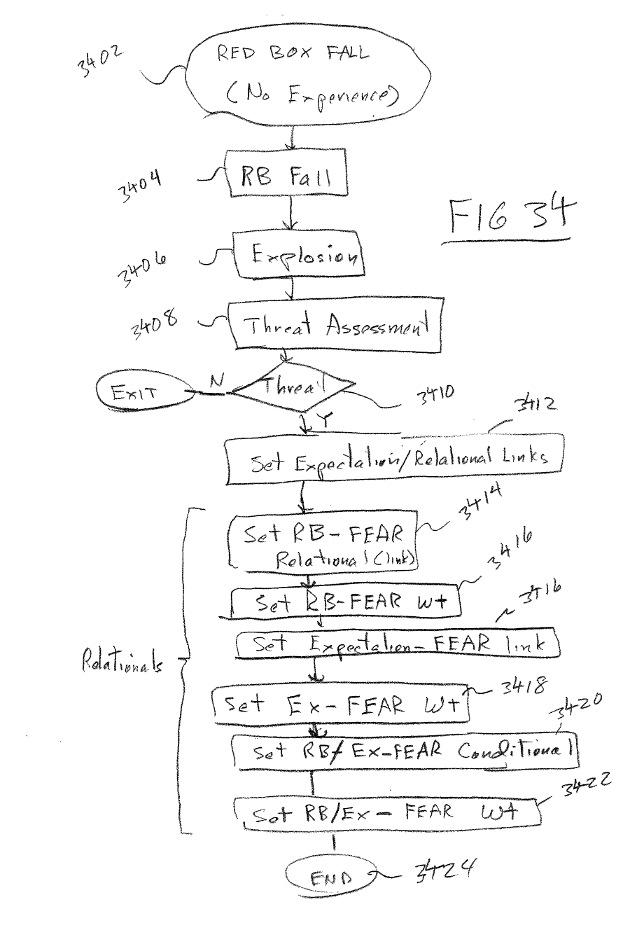

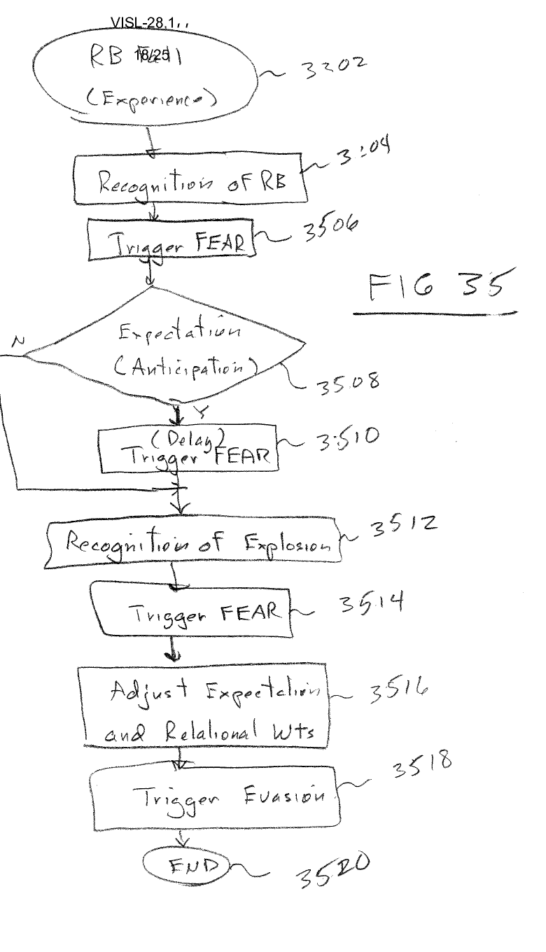

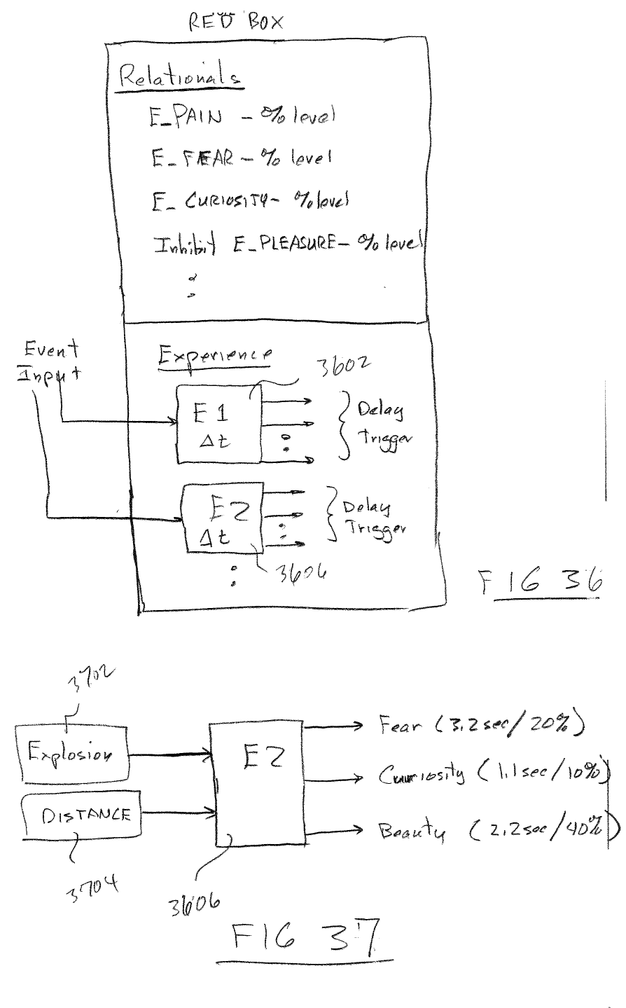

Referring now to FIG. 32, there is illustrated a diagrammatic view illustrating a more detailed view of a group of neurons that constitute input neurons that are linked to an emotional neuron 3204. This illustration is for the red neuron with the explosion and the impact, that was associated with FIG. 33, wherein like numerals refer to like features in the two figures. The red box neuron 3310 is linked to the FEAR in neuron 3304 in multiple ways. There is a direct link through the weight 3308, but there is also provided a link that illustrates an expectation. As noted herein above, there is an expectation that there will be an explosion after the second bounce of the box and this will induce fear even if the box does not explode. It would not be as great as when the box exploded, but there would be some apprehension or anticipation of an event occurring that constitutes a threat. This is provided by a link 3202 through a weight 3204. This is weighted by the weight 3204 which is controlled by an expectation block 3206. This expectation block 3206 will define how much fear will be expressed and “when” the fear will be expressed. This expectation block is typically a delayed feature. For example, it might be that the character 202 is trained with an experience from a previous falling of the red box that occurred 3.2 seconds after recognition of the red box. This would not be as great as the explosion of the red box, but it would still cause an expression of fear, i.e., a slight morphing of the muscles of the face in an animation to represent fear. In a similar matter, the explosion neuron has a direct weight 3114 associated therewith and the impact neuron has the direct weight 3110 associated therewith. However, there is also a conditional neuron an unconditional relationship or link between the explosion neuron 3102 and the red box neuron 3112. In essence what this is, is a link between the red box neuron 3112 and the FEAR neuron that is controlled by the actual explosion itself. This can be expected, since that explosion in and of itself will induce fear which, the intensity which is defined by the weight 3112 and the recognition of that explosion (the input to the weight block 3114), but there will also be some relationship between the fact that it is a red box and an explosion. This is provided by a weight or multiplier block 3210. This basically results in a link between the red box neuron 3112 and the FEAR neuron 3106, the intensity of which is defined by the output of the explosion drive 3102. The reason for this is that the explosion neuron may be recognized but it may be a distant explosion, such as fireworks. Therefore, the red box may also be at a distance and the conditional relationship between the two, i.e., an explosion and a red box, might not be as fearful due to the distance or even the level of the explosion, i.e., a small explosion might result in less fear for a red box. Thus, a conditional relationship between various neurons would exist. There might be a conditional relationship between the explosion neuron 3102 and the impact neuron 3108. This is represented by a conditioned weight block 3212. This may be the fact that an impact neuron, when indicating an impact, would have a stronger effect on fear in the presence of an explosion as opposed to with no explosion. Although not illustrated, there could be an expectation of explosion associated with the impact neuron also. The impact neuron 3108 will also have a conditional link associated with the red box neuron 3112 to create a link from the red box neuron and/or impact neuron 3108 to the fear neuron 3106. This will be weighted by a conditional weight block 3220. This will be the situation where, if there were no explosion, just the fact that there was an impact, i.e., the box suddenly hitting the floor, this would create some threat and, therefore, some level of fear in and of itself.

Referring now to FIG. 33, there is illustrated a diagrammatic view of how expectation in the block 3206 affects the output of, for example, the emotion block 3222. The red box is recognized at a trigger 3302, the intensity of this trigger, again, indicating the level of recognition of the red box and the weight associated therewith, i.e., the fact that the red box is recognized creates some type of output based upon prior experience. Thereafter, there is an expectation of fear that is learned, i.e., the red box had exploded before, had impacted loudly, etc. This will have been learned and, if it occurred a certain period of times, a delay, after the box had dropped before, this will create an expectation of an even that will occur later. This is illustrated by a trigger point 3304 that will output a trigger at an intensity defined by a multiplier and level of recognition. This first recognition 3302 will cause an initial indication of fear at a point 3306 which will rise, peak and then decay. However, before decay occurs, the fear expectation will jump up, be expressed, and will cause a second rise at a point 3308. This will rise upward until the actual explosion, indicated by a trigger point 3310, at which time a second rise in the emotion output at point 3312 will occur. If the explosion didn't occur, the fear will still be expressed (the display aspect is not illustrated for simplicity purposes).

Referring now to FIG. 34, there is illustrated a flowchart for setting the link or defining the link between the red box neuron and the emotional neuron. As will be described herein below, the red box neuron is a neuron that develops basic relational links based upon certain things that happen relative to the environment of the character 202. Until some action occurs to create the relational link, the relational link will not occur in that neuron. In this flow chart of FIG. 34, the initial condition is that there is no experience as to a red box falling creating any output or expression of fear. Thus, after initiation of the flow chart at a block 3402, it flows to a block 3404 indicating the red box falling. Of course, this may have some association with curiosity, it will cause the head to move the visual axis along with the box, causing the head to move. However, there will be no expression of fear. After the red box falls, there will be an explosion, indicated by the box 3406. However, this explosion will still cause no fear as there is no experience that an explosion caused any problem. However, as noted herein above, an explosion could be fireworks and this could be pleasurable, such that it would not be indicated as a threat. Thus, there has to be a determination that a threat exists. This is indicated in a threat assessment block 3408. If it is determined that this is a threat, as indicated by a decision block 3410, then the program will flow along the “y” path to a function block 3412. It should be noted that explosion is normally associated with a threat and this type of neuron, when set off, will be be associated with that type of evaluation. Of course, it could be fireworks and this would not be considered a threat. When the threat does occur, however, there must be some type of expectation or link set. As such, the expectation of an explosion will be created by sitting, first a link and, second, a weight. To do this expectation or linking, the program will flow to a block 3414 to set the red box-to-fear relational link and then to a block 3416 to set the weight value. This weight value is a value that can be modified by the nearness of the box or how far away the box is, such that the weight can be a different value. For example, an explosion more relatively close by and, then the fear would be expected to be higher. The operation will flow to a box 3416 to set the expectation-to-fear link. This is a time delay link that is the function of the relationship between the time that the explosion occurred and the time that the red box fell. It should also be understood that a red box could fall that did not itself explode but there were an explosion from some other source. There will still be some type of expectation but it would be much less than that associated with the situation wherein the red box itself exploded. This level of expectation or the fear that is to be expressed as a result of it will be set by the weight value, indicated by block 3418. Thereafter, there must be defined a conditional link, that associated with the relationship between the explosion and the fact that the red box occurred. This is indicated by function blocks 3420 and 3422. As noted herein above, this conditional link could be strengthened by the fact that it was the red box that exploded as opposed to something in the red box exploding or something behind the character exploding. If it were the red box, it would be the strongest conditional link and, if it were something else, it would be a much weaker conditional link. Once all of the weights have been set, i.e., all the relational links have been set and the expectation or anticipation links, the operations flow to an END block 3424.

Referring now to FIG. 35, there is illustrated a flow chart depicting the second flow through, i.e., the situation wherein the red box falls and the character 202 has prior experience as to what this means. This is initiated at a block 3502 and then proceeds to a function block 3504 wherein the red box is recognized. One recognized, due to the fact that there is a predetermined link between the red box and the emotional neuron, there will be a trigger generated for input to the fear, as indicated by block 3506. Operation flows to function block 3508 to determine if there was any anticipation of some even occurring after the red box fell. This anticipation may be the fact that prior experiences resulted in an impact or prior experiences resulted in an explosion. This will result, if such an anticipation or expectation exists, in the triggering of a fear event, as indicated by block 3510. This will be delayed by a predetermined amount of time. This is a delayed trigger. Operation then flows to function block 3512 for the recognition of an explosion. Once recognized, this will again generate a trigger for input to the fear emotion neuron, as indicated by block 3514. Of course, the recognition of the explosion requires that there be some relationship and/or to provide a trigger to the fear neuron. Operation then flows to a function block 3516 to adjust the expectation and relational weights as a result of the current experience. For example, it may be that the last time the explosion occurred it was at a distance and generated a small amount of fear. This time, it may be that the distance was closer and this would result in an adjustment to the weights, i.e., this distance aspect would be a qualifier to the weights. After this operation, the program will flow to a function block 3518 to trigger the evasion, i.e., the animation of the character to take certain steps to evade this particular unpleasant situation. Operations will then flow to an END block 3520.

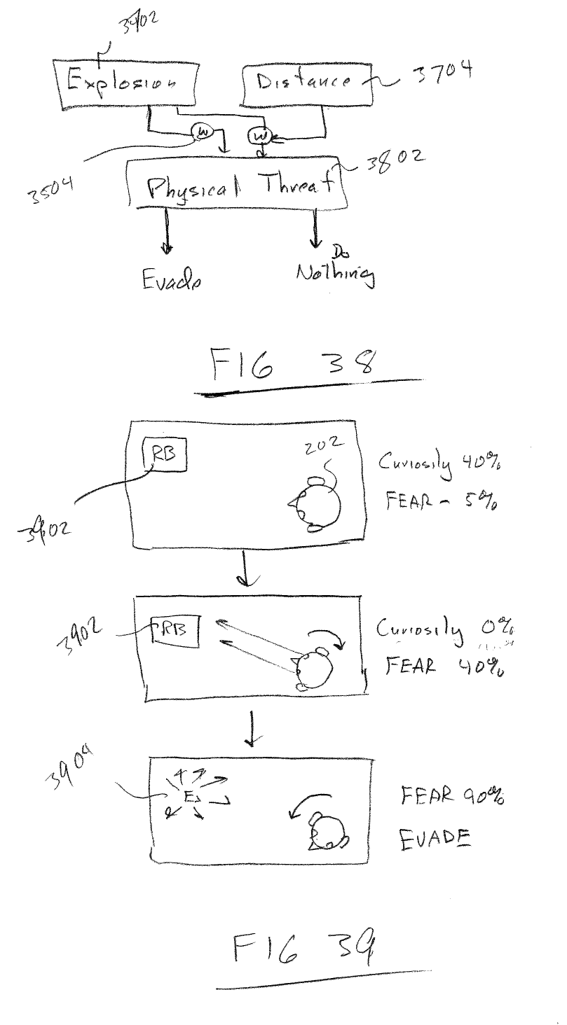

Referring now to FIG. 36, there is illustrate a diagrammatic view of a neuron that illustrates how a neuron looks after it is built. This is illustrated for the red box neuron which basically has a large amount of data or relational links associated therewith. These relational links, as described herein above, only exist once it is learned. In this form, the first portion indicates the inclusion of relationals, this one, for example, will have some possible relationship between pain, i.e., when the red box is recognized, then a pain neuron (previously not described) would be triggered. This pain neuron would result in the expression of pain in the facial muscles, for example. The fear neuron would also be triggered, as described herein above. There is also illustrated a curiosity neuron that would be triggered in a certain manner. Again, it will be triggered when the event occurs, as that is when the relationship is present. Further, this particular relational would possibly have an inhibit neuron that would inhibit the pleasure neuron. Each of these relationals will have some type percent level out of the parameters that may be associated with the particular manner in which the percent level is generated. For example, the recognition level of the particular event may result in the particular percent that will be output. This percent level is a function of the recognition level and the weighted value in association with the experience or anticipation aspect. This aspect is one that is a temporal aspect which typically has some type of delay associated therewith. Once recognized, there will be some delay in an animated expression being morphed onto the character 202. There are illustrated two experience blocks 3602 and 3606, although there could be many more built. Each of these is a result of a particular event input, i.e., an output from an impact neuron or an output from an explosion neuron. Once this input is received, there will be a time delay associated with that particular experience block which time delay will result in the output of a relational link to a particular emotion neuron. Each of these experienced boxes can build a relation with respect to a particular emotion neuron. For example, the block 3602 could have a link to the pleasure neuron, the beauty neuron, etc. Each of these links would occur a predetermined time after the event input occurred, i.e., they would have a delay trigger.

Referring now to FIG. 37, there is illustrated a detail of the block 3606. In this detail, there is illustrated a relational link with the fear emotional neuron, the curiosity emotional neuron and the beauty emotional neuron. When an explosion occurs, as received from an explosion neuron 3702, this will trigger an event. However, the experience neuron can have multiple qualifiers, of which one is illustrated, the distance qualifier in a block 3704. This distance qualifier will define the explosion as occurring near or far. If it is near, this might increase the weight to the fear neuron and it might increase the input to the curiosity neuron, as it is a much closer event. However, if the explosion were not close, i.e., the distance indicated as being far away, then the fear might be at a relatively low level. The fear neuron was initially triggered or created due to the fact that there was an explosion that was assessed as a threat, which threat then created the link. This link was created approximately 3.2 seconds after the explosion had occurred in the prior experience. Thus, there will be a link created that results in a time delay of 3.2 seconds. However, the level of this fear trigger is a function of the distance, i.e., it will be weighted at a level that is a function of the qualifiers. The curiosity neuron may have been trained as a result of some even that indicated that the box created a level of curiosity. This may have occurred, due to a prior experience, after approximately 1.1 seconds. However, a level of curiosity for any box, be it red or green, might be fairly low. The farther the distance, the lower it might be. Beauty, on the other hand, is an emotional neuron that may have occurred in prior experience 2.2 seconds after the occurrence of the explosion, i.e., for example, with respect to a fireworks show. In that situation, if the distance is far away, beauty would be higher, and if it were closer, beauty would be lower. This would be the qualifier that would be created in this situation. In the example illustrated in FIG. 37, the explosion was not very close and, as such, the fear neuron was only at 20%. The curiosity is relatively low but it occurred prior to either of the fear or the beauty neurons being triggered. The beauty neuron was triggered approximately 2.2 seconds after the event, but its level was fairly high, due to the distance being relatively far away. There, of course, can be many different qualifiers and many different links created to a particular emotional neuron.

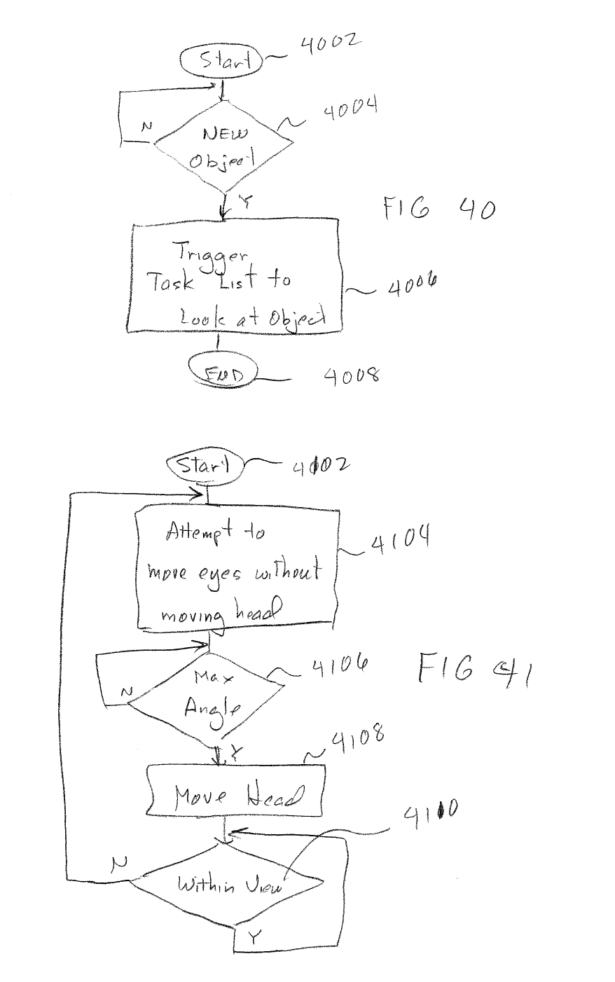

Referring now to FIG. 38, there is illustrated a block diagram of how explosion, from the explosion neuron 3702 can be associated with a physical threat. Explosion, by its nature, is set for a fixed relationship with respect to a block 3802 that assesses the physical threat. The link is created and there is a weight 3804 associated therewith which defines that explosions are physical threats but presets this to a certain level. When the explosion occurs, it indicates to a physical threat neuron 3802 that the physical threat must be assessed. Further, there will be a link that has a strength that is defined by the distance block 3704. In general, an explosion by itself will have a certain level, but this level can be increased or decreased, i.e., varied, by the distance. The closer the distance, the larger the input to the physical threat block 3802. The result of this will be that, since there is a physical threat, an evasion animation must be put into effect. Of course, the physical threat could be assessed as doing nothing, as there is no opportunity to do anything, i.e., there is no place to run or the character is restrained.

Referring now to FIG. 39 there is illustrated a sequence of events for the evasion. In the first block, the character 202 is presented with a red box 3902 which is basically in the environmental space of the character 202. Initially, the character 202 is not looking at the box when it appears but, the appearance thereof will create curiosity at a relatively high level and fear at a relatively low level as there has really been no recognition of the red box. Once the red box is recognized, by turning the head through an animation toward the red box, as indicated in the second animation, and then not find curiosity neuron but, however, increasing the output to the fear neuron to a level of possibly 40%, by example. Thereafter, the red box could explode, as indicated by a morph 3904 and what happens then is that the fear will rise up to a 90% level, as explosion is relatively near. This will then cause an evasion animation to occur wherein the character will be instructed to turn away from the explosion and possibly move to a safer place.

Character Movement

Applying the Brain Model to Emotional Animation

Much of the application of the Brain Model agent to the movie animation field is taken up with the development of training of the agent. A relatively smaller part involves the interpretation and connection of neural emotional content to existing animation software.

Fundamental to the application is that the Brain agents are first trained to be actors that empathize with the script characters, and then act out their roles. This is exactly the same process as for human actors. The best human actors are those which combine talent with the training and focus of that talent. The Brain agent-actors will exhibit skills that vary with the depth of their training.

For this application, training is a multi-layered effort, just as for a child. While the training for each level can be developed in parallel, the training (texts) are applied in the proper sequence. Low-level training is foundational for all training to follow. The training sequence is as follows:
Language and Vocabulary
Experiences and Emotional Responses
Skill-Set Training as an Actor
Training in Story Prerequisites
Training in the Story Line
Training for the Character Role
Performance-Tweaking of the Character Dialog Script

The final step is not truly training, but as for a human, the agent will require specific direction in some cases to deliver the results demanded by the director.

Much of the training, such as that required to be an actor, can be replicated for other agents, to create additional actors.

Applying the Brain Model to Character Movement

Presently, 3D animations are created using automated tools on a frame-by-frame basis. In many portions, the start and ending positions of a character are created, and interpolation is used to move them between those positions over multiple frames.

An application of the Brain Core, in addition to the expression of emotion, is the training of Brain agents, not as actors, but as the specific characters being emulated. There is value in both cases, and the primary difference is one of training. (The actor case is a more generic training that can largely be implemented one time, and then used multiple times.)

The advantage of specific emulation of a character is that the character can also can be instructed (in the script) as to what physical actions to take, in what time and in what sequence. If it does not get it right, the director can indicate how to do it differently on the next take. In this way, considerable time and cost by the cartoon animators can be eliminated. Film creation is no longer frame-by-frame, but event-by-event.

Training of the Brain Agent-Actor

Two different approaches can be taken to implementing the agent-actor for emotion animation. Each has its own value.
Train the Agent to itself be the character of the script.
Train the Agent to be an Actor, empathizing with the script character.

Either of these methods is valid. Training an agent to specifically be the character of the script involves imparting to him/her both the knowledge and emotional experiences of the script character. Many emotional experiences can be added to the training by point-and-click methods. This uses a library of background psychological experiences with their resulting impact on the character's interaction with the world around it.

The downside to this training becomes somewhat more complex, and is based on an interactive scenario-based modeling. It is expected that this will be a somewhat more expensive approach to implement during the production of the movie, but will give more accurate implementation.

The second approach is to first train the agent to be an actor, someone who empathizes with the assigned script character and plays out the script. The agent is then given the script to interpret, and emulates the most-likely emotional response of the character. The training to be an actor can be replicated in other Brain agents, to create additional actors. The downside of this approach is that generated emotion is likely not as accurate, in that is through empathy rather than by direct experience.

Static Training—The Fast-Learning Mod

The normal learning method for a human being is the emotional interpretation of information. It is also subject to present body chemistry. Human learning normally involves reinforcement of that information over a period of several weeks, or the presence of strong emotion that indicates strong importance of the information. The Brain Model operates in the same way (but is not subject to body chemistry).

In this mode, the interpretation of new information is subject to previous emotional experiences with context-related background knowledge. As such, what is trained is not necessarily what is received and remembered. The acquired knowledge cannot be trusted as if it came “from God”, but may be reasonable and have an authentic feel to it.

The Brain Model has a second mode of training that bypasses history and emotional interpretation. It is labeled as static training, and assumes that the original information is pristine an accurate, as if it came “from God.” It is a one-time training that does not need reinforcement or emotional content to make it believable. It is rapid and creates accurate consistent results in the accumulated background knowledge. So learned, the knowledge will still be interpreted or related to in the emotional context of the moment, when the agent brain is in operational mode.

Most training of raw knowledge for the NBM agent is done in static mode, as appropriate.

The following sections describe typical training.

Language and Vocabulary Training

The English language has a structural vocabulary of about 1000 words that are foundational and unchanging from generation to generation. These include the many irregular verbs, verbs such as ‘eat’ and ‘ate’ whose form changes with tense. These structural words are built into the Brain Model and do not need to be trained. They also include prepositions, articles, numbers and other basic word forms.

Likewise, rules of English grammar and the parsing of sentences are built into the Brain Model. They require no further training. However, the vocabulary of routinely-used English words must be trained, along with their relationships to each other. It is the recording of relationships between words that makes upfacts, and these must be trained.

For example, consider the sentence:
A ‘movie’ is a sequence of single-frame pictures that are projected at a rate of 24 or 30 frames per second.”

This defines a set of three facts about movies, including definition of the word. Basic vocabulary words are described like this in ordinary English to train an NBM agent.

Experiences and Emotional Responses

Human beings develop emotional responses to events they experience. The emotional responses of Brain Model agents develop in an identical manner. However, those responses can also be defined by training.

Scores of specific emotions that a human being is capable of have been has tabulated or defined, and has assigned a specific name to each. These can then be tied into the static-mode training of an agent. After such training, the subsequent encountering of a related experience may evoke that emotional response.

For example, consider this static emotion training:
Showing approval of a person increases P_Approval. Approval is shown by positive affirmation (e.g., “Great job!”), by a smile, pat on the arm or a hug.
Showing disapproval of a person decreases P_Approval. It is shown by a frown or scowl, by negative affirmation (e.g., “That was a bad job!”), and by being ignored.

Note: The senses of encouragement and feel-good are also influenced by approval, but the conditional relationships between emotions are implicit in the Brain Model and do not have to be explicitly trained. Therefore, the impacts of approval on P_Feel_Good and P_Encouragement need not be explicitly trained. An agent's gender suitably alters inter-relationships of emotion to the context of the moment.

Skill-Set Training as an Actor

Just as an actor must be trained, the Brain agent must be trained in the skill-set of being an actor. This includes empathy with the script character's background, but in the light of the agent's own experience and training. For this reason, the agent's background training for experiences and emotional responses will sometimes first be altered to allow proper empathy with the character of the script.

The concept of the camera is as central to animation as it is for television and film. Multiple cameras at different positions or focal lengths are used. While this first application of the NBM to animation is for the visual communication of emotion, only the face, eyes and head are involved in the process. The remainder of the animation body is ignored for this purpose. Just as an actor must be aware of his head position and orientation relative to the camera, the NBM actor gets trained to also be aware.

The strength of the Brain Mode is that it learns in the context of the moment; in this case, a central part of that context is that it is emulating a specific character for the script.

A snippet of such training text might be:

When your character is frustrated, roll your eyes upward as he might do. Even so, do not turn your back on the camera unless directed to do so. While engaged in an animated conversation in which both of you are emotionally connected with the content, engage him with your own eyes. The script will cue you as to his position relative to you, and which camera is active. Be aware of this as the script progresses.

Because this initial application does not include body animation and motion, incidental training not relevant to that is simply ignored. Other than that, much of the actor-training script can be relatively stock training materials for human actors.

Training in Story Prerequisites

Any story to be animated requires that the agent-actor will have certain background knowledge.

Example, if an animation was to be done for the film, Mr. Smith Goes to Washington, the agent would need to know something about government and the election process. Here is a snippet of a suitable training script for that purpose. It is given to the agent as a simple text file:
Title: Structure of Government
The positions of people in federal government (in order of decreasing influence) are President, Vice President, Senate Majority Leader, Senator (member of the Senate), House Majority Leader, House Minority Whip, Representative (member of the House). The president and vice president are elected as a team, and serve 6-year terms. Senators are elected for 6-year terms, while Representatives are elected to two-year terms. The Senate Majority and Minority leaders are elected from among the senators in the party caucuses.
Two elected U.S. senators are elected from each state, and one Representative is elected for each 650,000 people, or so. Each state is divided into U.S. Senatorial and House districts for election purposes.

When the agent is given words it does not know, or cannot identify the usage or context of, it will ask for clarification.

Training in the Story Line

The acting out of movie script is done in the context of the story line. This is then relevant to the agent actor, to establish how to react to the overall circumstances of the story. Training script for a portion of the story might look like:
Title: Background of ‘Mr. Smith Goes to Washington’
Naive and idealistic Jefferson Smith, leader of the Boy Rangers, is appointed on a lark by the spineless governor of his state. He is reunited with the state's senior senator, presidential hopeful and childhood hero Senator Joseph Paine. In Washington, however, Smith discovers many of the shortcomings of the political process as his earnest goal of a National Boy's Camp leads to a conflict with the state political boss, Jim Taylor. Taylor first tries to corrupt Smith and later attempts to destroy Smith through a scandal. As Smith's plans collide with political corruption, he doesn't back down.
   Training for the Character Role

An example of training for the character role to be played out by the Brain Model agent-actor might be:
Title: Character Background of Mr. Jefferson Smith
Jefferson Smith is a person of strong moral character. He has a vision for a national camp for underprivileged boys, where they will have a chance to develop in a healthy environment. Jefferson is honest and believes in the general integrity of people. He believes that they are similar to him in these things, and would not do things that are illegal.
Given the opportunity to be appointed to replace a U.S. senator who has died, Smith accepts the governor's appoint without thought that there are strings attached to the appointment. Each time he discovers another aspect of the double-dealing nature of the governor's appointment, he expresses innocent surprise. When he finally comes to a decision of what to do about it, he shows resolve and determination to do what he believes to be right, regardless of what other people might think.

This training is essentially a biography of the character to be acted out. It establishes the context of the acting in the light the character whose role is to be acted out. This training is likely to be done live, not in static mode.

Performing the Character Dialog Script

Performance of the script is likely best done on a sub-scene or sequence basis. The agent is given the script to read, and that same script gives it the cues to place its performance in the time-line of activity by other characters. Previous actor-training gives the essential instruction for how to interpret the script and its cues.

The director can modify the performance in “step time”, giving the agent specific direction in how to alter its interpretation of the script as is normally required for human actors.

Application—Emotional Expression in Animation

The first-stage application of the Neuric Brain Model agent to movie animation is the automated introduction of emotion into facial expressions. The e motions track content and character experiences in the script. In this application, the agent “gets into” the character being portrayed. Like a human actor, the agent anticipates and mimics the emotion that the script character would encounter in the situational context. The agent must be first trained as an actor, and then trained for the script itself.

To manually add emotional expression to the characters, augmenting the positional animations, is presently a meticulous and costly burden on movie production costs. It is a prohibitive expense, so the expression of emotion in an animation is omitted.

Character agents based on the Neuric Brain Model bring a new paradigm for movie creation to the animation industry. It brings value by automating the expression of emotion. It also lays the ground work for full-character movement handling.

Application—Automated Animation of Character Movement

Modern animation uses 3D wire-frame models of the script figures that are suitably “skinned” and clothed to resemble the target characters. The animators use existing key-framing technology to create start-end positions for body parts in each short animation sequence. In the present industry, a large team of animation artists (100-800 of them) manually set these positions, letting software create the frames in between.

The second-stage application of the Neuric agent to movie animation is to train the agent to fully perform all required motions in the 3D wire frame figure models. That is, the script cues that direct the character to open the door, enter the room and take the second chair at the table, it will then automatically do just that. The “motor nerves” of the model now drive the existing animation engine to implement the figure's motions. It is precisely the same as animating a mechanical robotic skeleton, but instead animates the body of the animation figure.

Character Animation

Referring now to FIG. 40, there is illustrated a flow chart depicting what occurs when a new object enters the environment of the character 202. In this scenario, the character 202 exists within a certain environment and then a new object appears in that environment, i.e., there is a perception that something has changed in the environment. The program is initiated in a block 4002 then proceeds to a decision block 4004 to determine if the new object has entered the environment. If so, the program flows to a function block 4006 to trigger the particular task list to control the animation such that the character 202 will look at the object. This particular animation has the flexibility of moving the eyes slightly to look at the object, it being understood that only a certain angle of movement will occur with the eyes before the head must turn. If the eyes move too much, i.e., they max to the right or the left, up or down, then the head will have to move in the respective direction. After the task list has been completed, i.e., the character 202 has been controlled through the animation thereof to appear to look at the object, the program flows to an END block 4008.

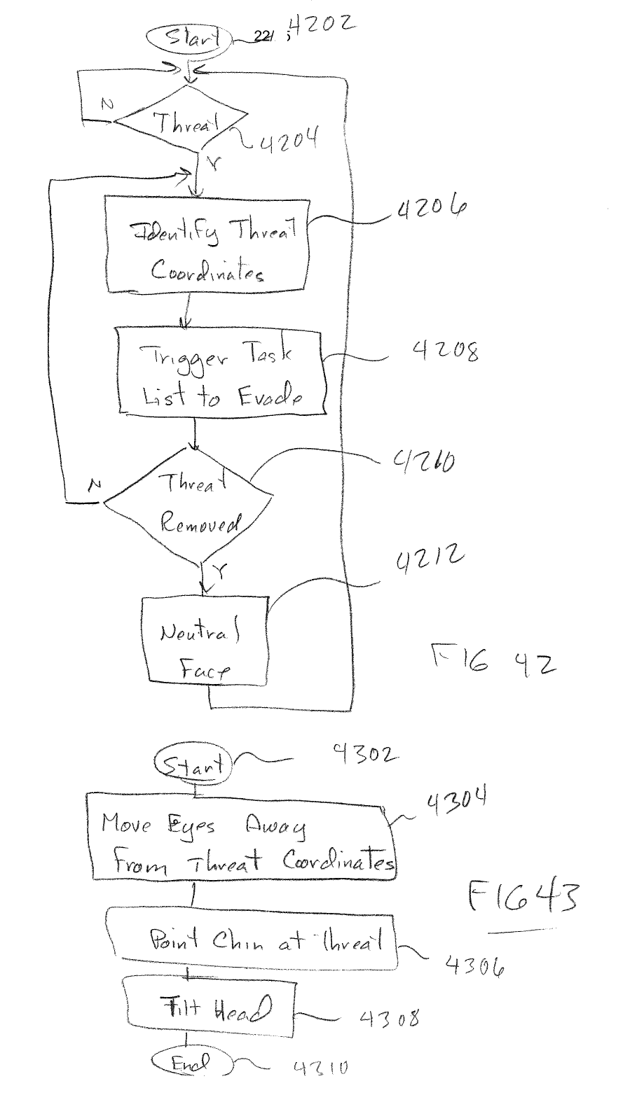

Referring now to FIG. 41, there is illustrated a flow chart depicting the task list operation of block 4006. The program is initiated at a block 4102 and then proceeds to a function block 4104 to attempt to move the eyes without moving the head, i.e., there was a certain latitude provided wherein the eyes can move a certain direction off center without moving the head. However, there is a maximum angle at which the eyes can exist and, if this angle is exceeded, as determined by a decision block 4106, the program will flow along a “y” path to a function block 4108 to move the head in the direction of the object. This can be right or left, up or down, or any direction in between. The program then flows to a decision block 4110 to determine if the object is within view, i.e., the angle of the eyes is within the acceptable range. If not, the program will flow along the “n” path back to the input of the function block 4104. As long as it is within view, the program will remain in a loop around the decision block 41 10.

Referring now to FIG. 42, there is illustrated a flow chart depicting threat assessment. This is initiated at a block 4202 and then proceeds to a decision block 4204 to determine if a threat exists. When the threat exists, the program flows upon the “y” path to a function block 4206 to identify the coordinates of the threat. The program then flows to a function block 4208 to trigger the task list for evading the threat and then to a decision block 4210 to determine if the threat has been removed after the evasion has occurred. If not, the program will continue to flow back to the input of the function block 4206. Once the threat has been removed, the program flows to a function block 4212 in order to place the expression and position of the face back at the neutral face position, i.e., staring forward with a “blank” look on the face.

Referring now to FIG. 43, there is illustrated a flow chart depicting the operation of the trigger task list, which is initiated at a block 4302 and then proceeds to a function block 4304 in order to move the eyes away from the threat coordinates. Since this particular example is only limited to movement of the head, without movement of the rest of the body, the most vulnerable portions of the human body in that situation are the eyes. The normal reaction is to always move the eyes away from the threat or in general protect them in any manner possible, such as placing the hand over the eyes. The eyes are moved as far away as possible and also the chin is pointed at the threat, as indicated by function block 4306 and then the head tilted to provide the maximum angle at which the eyes will be at the most remote point away from the threat, this indicated by a function block 4308. Once this action has been completed, the program flows to an END block 4310.

STATE MACHINE CONTROL FLAGS

| Conditionals (Ints) | Intent | Used By |
|---|---|---|
| Cdx_Auto_Pass | Always set to 1 | (All FSM's?) |
| Cdx_Mode_Live | Mode is being changed to live. | Mode_Handler |
| Cdx_Mode_Static | Mode is being changed to static | Mode_Handler |
| Cdx_Mode_Script | Mode is being changed to script. | Mode_Handler |
| Cdx_Orientate | The neuric needs to orientate | FSM_Master |
| Cdx_Sleep | The neuric is sleeping | FSM_Master |
| Cdx_Bored | The neuric is bored | FSM_Master |
| Cdx_Idle_Timeout | Set when in idle mode too long | FSM_Master |
| Cdx_Physical_Need | Neuric has a physical need | FSM_Master |
| Cdx_Mental_Need | Neuric has a mental need | FSM_Master |
| Cdx_Spiritual_Need | Neuric has a spiritual need | FSM_Master |
| Cdx_Location_Needed | Neuric needs to know location | FSM_Master |
| Cdx_Identity_Needed | Neuric needs to know identity | FSM_Master |
| Cdx_Burst_Keyword | Holds a keyword enum value | FSM_Master |
| Cdx_Channel | | FSM_Master |
| Cdx_Desire | | FSM_Master |
| Cdx_Resolve_Thought | | FSM_Master |
| Cdx_New_Thought_Obj | | FSM_Master |
| Cdx_New_Recognition_Level | Level of object/event recognition | FSM_Decision_Process |
| | has improved. | |
| Cdx_Evasion_Mode | Start up FSM_Evade. | FSM_Decision_Process |
| Cdx_Emot_Threat | An emotional threat was | FSM_Implications |
| | perceived. | |
| Cdx_Resolve_Env | The Environment needs to be | FSM_Resolve_Env |
| | resolved. | FSM_Master |
| | | FSM_Decision_Process |
| Cdx_No_Input_Available | There is no current source of | FSM_Sensory_Input |
| | sensory data to use for | |
| | resolution. | |
| Cdx_Expected_Obj | Indicates that the object is as | FSM_Resolve_Env |
| | expected. | FSM_Implications |
| Cdx_Unexpected_Exper | Neuron ID of unexpected | FSM_Resolve_Env |
| | experience in our environment. | FSM_Implications |
| Cdx_Unexpected_Obj | Object in the environment is | FSM_Resolve_Env |
| | unexpected. | FSM_Implications |
| Cdx_Others_Present | Other people were present. | FSM_Implications |
| Cdx_Immediate_Threat | Object is deemed an immediate | FSM_Sensory_Input |
| | threat. | FSM_Implications |
| | | FSM_Decision_Process |
| Cdx_Obj_Identified | Object was conclusively | FSM_Sensory_Input |
| | identified. | FSM_Decision_Process |
| Cdx_Evasion_Unlikely | Evation is unlikely. E.g., too fast, | FSM_Decision_Process |
| | too close... | |
| Cdx_New_Sensory_Data | There is new sensory data | FSM_Sensory_Input |
| | present | FSM_Master |
| Cdx_Get_Sensory_Data | Indicates we want to process | FSM_Sensory_Input |
| | sensory data that is available. | |
| Cdx_Processing_Input | Currently processing sensory | FSM_Sensory_Input |
| | input | |
| Cdx_Possible_Threat | The object is a possible threat. | FSM_Sensory_Input |
| Cdx_Resolve_Obj | An environmental object needs | FSM_Resolve_Env |
| | to be resolved. | |
| Cdx_On_Collision_Course | Object is on collision course with | FSM_Sensory_Input |
| | neuric. | FSM_Decision_Process |
| Cdx_Env_Obj_Chg | Indicates that an object in the | FSM_Sensory_Input |
| | environment has changed states. | FSM_Resolve_Env |
| | | FSM_Decision_Process |
| | | FSM_Implications |
| Cdx_New_Env_Obj | Indicates that a new object has | FSM_Sensory_Input |
| | entered the environment. | FSM_Resolve_Env |
| | | FSM_Decision_Process |
| | | FSM_Implications |
| Cdx_New_Env | Neuron ID of new environment. | FSM_Resolve_Env |
| | | FSM_Decision_Process |
| Cdx_Loud_Noise | Simulated sound. | FSM_Sensory_Input |
| | | FSM_Master |
| Cdx_Obj_Experience | Indicates the neuric has | FSM_Resolve_Env |
| | experiences | |
| | Associated with the object | |
| Cdx_Do_Implications | Starts the Implications FSM | FSM_Resolve_Env |
| | | FSM_Implications |
| Cdx_Text_Input | Wakes neuric from sleep when | FSM_Master |
| | text is inputted. | |

| To Do Flags (chars) | Usage |
|---|---|
| To_Do_Resolve_Thought | Initiate the Recognition process. |
| To_Do_Resolve_Obj | Initiate object resolution process. |
| To_Do_Discern_Part | Discern a part of an object. |
| To_Do_Discern_Threat | Discern the immediate threat level |
| To_Do_Resolve_Expers | Resolve the experiences and compare |
| | to expected. |
| To_Do_Set_Env_Expectations | Remember the environment entered |
| | and set expectations. |
| To_Do_Check_Expectations | Compare an object or experience |
| | with |
| | Expectations. |
| To_Do_Indentify_Object | Identify an object from discernable |
| | parts and properties. |
| To_Do_Discern_State_Chg | Processes an environment object |
| | state change. |
| To_Do_Identify_Input | Process new sensory data. |

| Finite State Machine | Usage |
|---|---|
| FSM_Master | Track outermost state. |
| FSM_Conversation | Track the state of conversation. |
| FSM_Resolve_Env | Track the state of resolving a delta in |
| | “Environment”. |
| FSM_Resolve_Thought | Track the state of resolving a delta in |
| | “Thought”. |
| FSM_Decision_Process | Track the decision process state |
| FSM_Implications | Track the state of the object |
| | implications process. |
| FSM_Evade | Track the evasion process. |
| FSM_Sensory_Input | Track the processing of sensory |
| | input. |

Realtime Clock (RTC) Handler

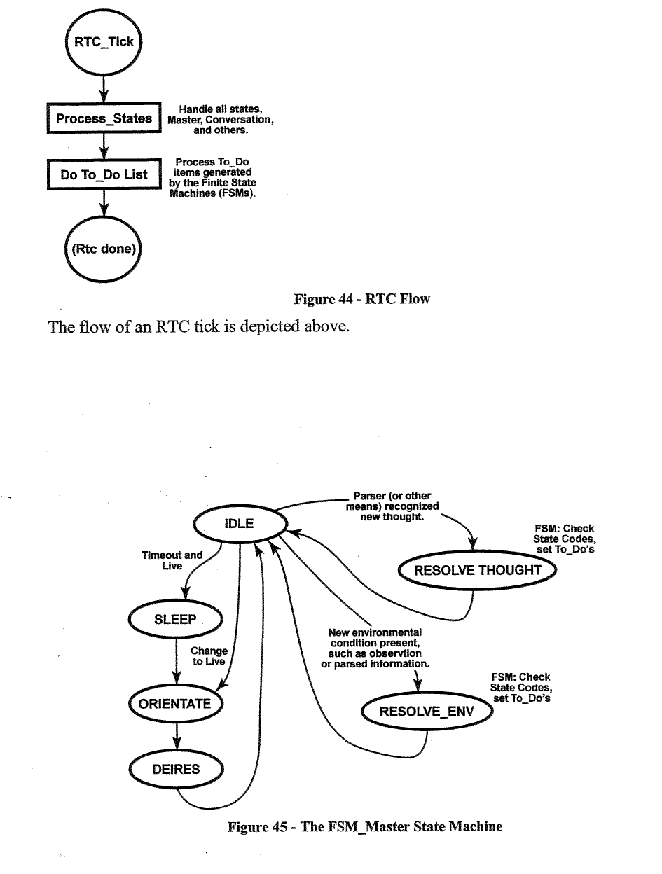

Referring to FIG. 44, there is illustrated the realtime clock handler. The realtime clock interrupt happens every 10 msecs. Several internal counters are maintained in the Analyzer to permit selected operations to occur at regular intervals, such as ever 30 msecs or every 250 msecs (0.25 secs).

The Process_States reference systematically references all state machines to update them. Each such FSM looks at the above control flags to see if it has anything to do, and sets appropriate ‘To_Do’ flags if need be. The call does nothing if there is nothing to do.

The FSM_MASTER State Machine

Referring to FIG. 45, the master FSM calls upon the RESOLVE_THOUGHT and RESOLVE_ENV FSMs to handle detailed issues related to resolving unknowns initiated from the environment or from other parts of the brain. This state machine handles mode changes between Live and other modes

FSM_DECISION_PROCESSES State Machine

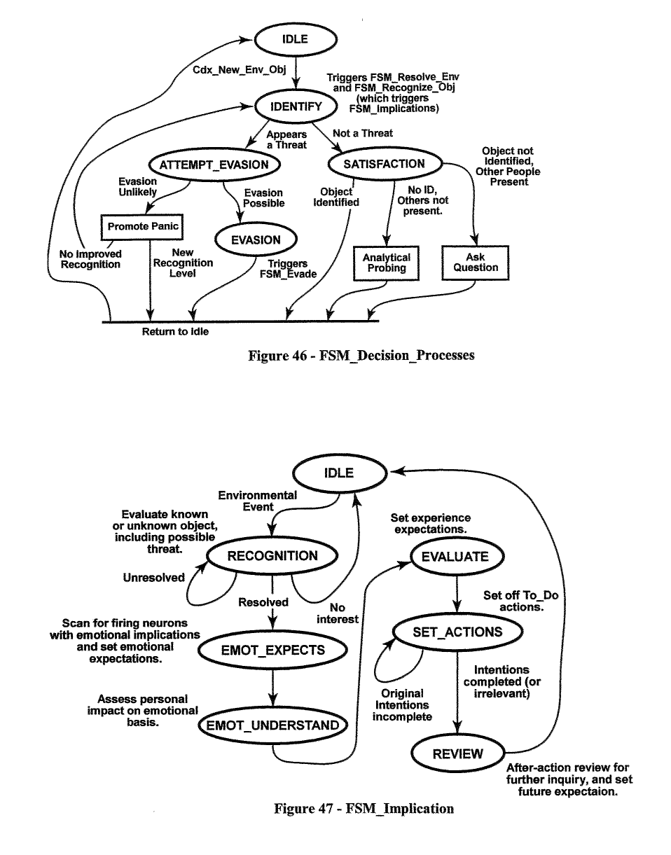

Referring now to FIG. 46, there is illustrated a FSM Decision Process State Machine. This machine is the entry point of processing for new items encountered in the environment. It is rather the Mother of All State Machines in the information this process, and kicks off a number of subordinate state machines that perform various tasks.

The IDENTIFY state triggers a cascade of three state machines, topmost of which is FSM_Resolve_Env. Between these FSMs, various elements of the recognition process are recorded as flags. Those are prefixed with Cdx_ and control the flow of other FSMs.

All FSMs have an IDLE state and remain in IDLE until a controlling flag goes true. At that point, the flag is left true until that FSM returns to its IDLE state. The FSM that originally set that flag awaits its clearing before altering continuing to its next state.

Threat Handling

In the IDENTIFY state, the invoked FSMs evaluate both physical and emotional threat conditions. The response is one of evasion, but if that is not possible (E.g., passage is blocked, it's moving too fast, it can't be seen . . . ), the emotion of panic is promoted. Further, if recognition is not decent, control returns to the IDENTIFY state to further identify the threat. If recognition is reasonable, the increase of panic is the only action, and the state returns to IDLE.

When evasion is possible, an FSM_Evade process is initiated to take action. When that action (E.g., jerk away, yelp, run 20 feet away . . . ) is completed, the FSM returns to the IDLE state.

Non-Threat Handling

When the object is identified and is not a (known) threat, if other people are present, they will be asked a question to identify the object. If they are not present, analytical probing will be used to decide the identity of the object. After either such attempt, the FSM returns to IDLE.

The FSM_IMPLICATION State Machine

Referring now to FIG. 47, there is illustrated the FSM_Implication State Machine. When it is understood that some unknown environmental event has been introduced, this FSM evaluates it and takes initial needed action.

When processing needs be suspended pending receipt of further information, that process section is placed in its own state. Processes occurring within each state are described in the sections that follow.

Idle State

Stay here doing nothing until an external event occurs, such as introduction of an object into the environment.

Recognition State

Attempt a cursory recognition of the object
Assess physical threat—Is it coming at me or is a known threat?
Assess emotional threat—Is it threat to well-being, honor, rightness or identity?
Assess curiosity—Are you even curious and have no interest?
Assess ordinariness—Is it ordinary or routine and understood regardless of need for action?
Assess WWWWWH—Preliminary assessment of who, what, when, where, why and how
Assess Relevance—Is it important? Does it matter?
   These are made from information on hand or suggested by inspection of related firing neurons.
   EMOT_EXPECTS State

The context pool may now be firing neurons that have emotional implications. Scan context pool for these relevant emotional connections, some of which are only fired by _uncertainty. Set off initial firing of connected emotions as a reaction. E.g., I misinterpreted shoe laces as a black spider because I saw a tarantula recently. Most of this is done by chasing emotion relationals connected with the event, typically via the Cull_Neurons reference.

EMOT_UNDERSTAND State

Assess the relevance of the event/object to my current emotional state.
Assess significance of location—Is the location significant, relevant or (emotionally) important?
Will this disrupt my intentions—Are my intentions so strong that I should be concerned of disrupting them with this event? Assess whether or not to set “_Cancel_My_Intention.”
Assess emotional relevance—Is there emotional content connected to the event?
Assess emotional security—Am I emotionally secure relative to emotional threat? Possibly initiate a gripe, bluster or complaint, or lash out.
Assess physical security—Am I physically secure relative to physical threat? Jerk away and otherwise move out of the way or towards security. Assess whether or not it interrupts my footpath and set “_Cancel_My_Motion.”
Assess welcome distraction—Is this a welcome distraction from my present intention (or lack of activity)?
Assess undesired disruption—Is this an undesired disruption of my present focus?
Assess emotional response—Is this due to carelessness? Is it a ‘care package’ arrival that fulfills me?
   Evaluate State

We now know what we have and are dealing with unknowns or with a known. Either way, set experiential expectations. Initial reactions are now (naturally) bleeding off but it may be necessary to ‘artificially’ dampen selected emotion firings.
Identify all knowns—Pose question to probe each known. Move relevance of the event to the current topic of interest.
Identify facts about any unknowns—Pose question to probe each unknown area or each uncertainty.
Bleed initial reactions—(May not be needed.)
Assess impact on others—Are others affected by it? Are others hit? This is temperament-dependent, with Choleric or Sanguine having lower interests in such impact.
   SET_ACTIONS State
   Decide what (else) needs to be done and then do it.
If it fills physical need—(TBD)
If it fills emotional need—(TBD)
If it fills spiritual need—(TBD)
Issue exclamatory—If others are present, optionally issue an exclamatory or other verbal response, or initiate a dialog with them about the object/subject.
If time to evaluate is relevant—The time needed to evaluate what's happening may be more than 1 can or want to give up. Determine what actions (or cancellations) I need to make.
Does it require something of me?—Once this is determined, assess my sense of responsibility or decide it's not my problem.
Is other intelligence involved ?—If a person threw the box, should I respond? Is a defensive move (strategy) needed? If so, kick of the relevant FSM/process. _cause, _who

Before returning from this state, ensure that all needed future activity has been initiated. If personal intention was pending when the event occurred, schedule a review to follow completion of the intention (unless the intention was cancelled during the event).

Review State

Revaluate things following completion of intentions. Internal Activity: Use learning processes, observations, conclusions, all weighted towards the emotional knowledge and experience gained. External Activity: Same as Internal, but via communication with others.
Evaluate how we are now feeling (about the event)—_guilt, _shame, _thanks, _grateful, _resentful? Schedule To_Do actions to deal with these as appropriate.
Compare outcome against preliminary expectations—Compare current emotions against the initial expectations for the experience.
Evaluate what is still unknown—If the object is yet unknown, ask questions (if others present) or remark about it as a means of soliciting understanding.
Evaluate what was learned—Form any conclusions and add relationals to the event or object, as appropriate to extend its context.
Set future expectations about the experience/event/object—Based upon the above, set future expectations for the experience.
Set resolution and closure—Set resolution by suppressing any emotional left-overs.

At this point, the subject should be considered closed, except that future events may have been scheduled to resolve otherwise-open matters. No further immediate processing on the matter should be needed, so go idle.

FSM_RESOLVE_ENV

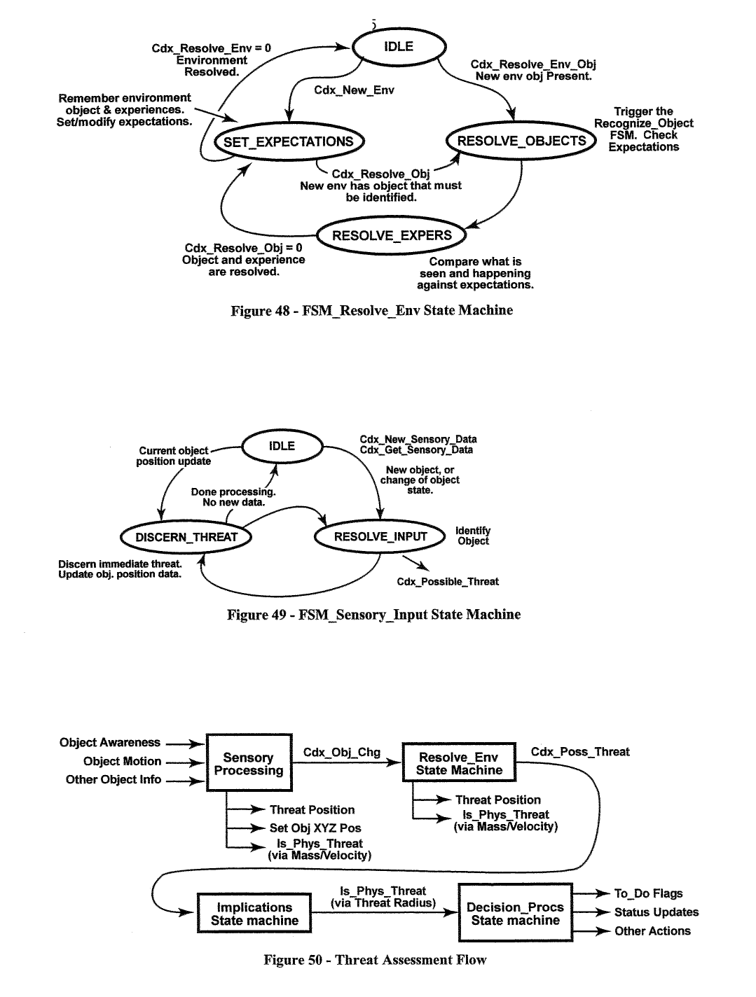

Referring now to FIG. 48, there is illustrated the resolve environment machine. The resolve environment state machine is called whenever the environment is changed, something in the environment changes, or a new object enters the environment.

Idle State

Stay here doing nothing until an external event occurs.

IDENTIFY_INPUT State

Wait here while the Sensory Input FSM processes the input data. When that state machine is finished, we will have one of three things:
Cdx_New_Env_Obj—a new object in the environment.
Cdx_Env Obj_Chg—an object in the environment has changed states.
Cdx_New_Env—we have entered a new environment.
   RESOLVE_OBJECTS State

After the object has been identified, we check it against our expectations for this environment. If this is an object that has changed states, we discern the state change and process the implications accordingly.

RESOLVE_EXPERS State

Compare the expected experiences with this object to what is actually occurring.

SET_EXPECTATIONS State

Remember the environment from previous experiences. If we have entered a new environment,

We will expect certain objects to be present and experiences to happen based on past experiences in the environment.
Remember environment—recall the objects, experiences, and emotions associated with the environment that we are in or entering.
Set expectations for the environment—set expectations based on recollections and their relevance.
Modify expectations for the environment—modify expectations based on the unexpected objects or experiences and emotions.
   FSM_SENSORY_INPUT State Machine

Referring now to FIG. 49, a FSM Sensory Input State machine is illustrated. This FSM checks the sensory input buffers for new data, and processes the data to identify it when possible.

This FSM primarily considers whether or not a new object in the environment (or one whose state has changed) is a threat, and tracks its position.

Idle State

Stay in IDLE until there is data available to process. If the incoming data is a position update, it is processed immediately. If it is a state change or a different object, we must wait until the previous information has been processed or we have decided that we need more information.

RESOLVE_INPUT State

Process the incoming data. The first step is to identify which environmental object we are receiving data for, or create a new one and identify it from its properties.

DISCERN_THREAT State

Assess immediate physical threat. This is determined based on physical motion, path of motion, speed, size and weight of the object.
Discern motion of the object—Is it moving?
Discern path of motion—Is it on a collision course with me?
Discern speed—how much time do I have?
Discern size and weight—is it large enough, fast enough, and heavy enough to cause physical damage? If so, it doesn't matter what it is, if we are going to evade it, do so now.
   Threat Assessment Flow

Refer now to FIG. 50, there is illustrated the general flow of threat assessment from sensory detection of the object (or event) to the taking of action. Some of the relevant conditions sensed or defined are shown.

The information is passed off from state machine (FSM) to state machine until explicit action for the object has been taken. Incoming awareness of an object turns it into an experience with associated emotions.

If a similar experience has occurred in the past, some items such as physical threat level will have been remembered for the object in the form of relationals. Other such information may be stored in the experience memory block.

What is claimed is:

1. A method for modeling human emotion for emulating human behavior, comprising the steps of:
recognizing the existence of a condition capable of being sensed at least in the abstract in a surrounding environment in which the human behavior is emulated;
representing a plurality of human emotions, each with a temporally varying emotion level;
representing the condition as having a predetermined relationship with respect to one or more of a linked one of the plurality of human emotions, the predetermined relationship defining the effect that the recognized existence of the condition will have on the linked one or more of the plurality of human emotions;
the step of recognizing resulting in a temporal change to the temporally varying emotion level of the linked one of the plurality of human emotions, such that the presence of conditions in the surrounding environment is reflected in the temporally varying emotion levels of one or more of the represented human emotions; and
utilizing the emotion levels to parameterize the operation of a system.

2. The method of claim 1, wherein the system comprises an external expression of the associated human emotion.

3. The method of claim 2, wherein the eternal expression of human emotion is expressed with an animation engine for modifying the appearance of a rendered character in an animated production.

4. The method of claim 2, wherein the external expression of human emotion is expressed with a robotic engine for modifying the appearance of a robot.

5. The method of claim 1, wherein the representing the condition comprises the step of storing a plurality of relationships between a node associated with the condition and one or more of the plurality of human emotions and the associated temporally varying emotion level, each of the stored relationships having a defined weighted effect thereon as a function of an intensity of the associated condition.

6. The method of claim 1, wherein each of the predetermined relationships is affected by the strength of the recognized condition.

7. The method of claim 6, and further comprising the step of modifying the predetermined relationship as a function of the strength of the recognized condition after recognition thereof, but after the step of utilizing.

8. The method of claim 1, wherein a plurality of conditions are recognized and the strength of one of the predetermined relationships is a function of at least two of recognized conditions, such that the presence of the at least two recognized conditions will result in a different relationship.

10. A method for modeling human physical behavior and actions, comprising the steps of:
defining a brain emulation that is represented by a plurality of nodes each representing a concept, and interconnecting relationships between select ones of the concepts, which brain emulation is operable to receive sensory information and process such sensory information and capable of communication the outcome of such processing;
training the brain emulation in a training mode to establish the relationships between concepts in response to training information input thereto that is designed to impart predetermined meaning to the one or more concepts in the brain emulation;
operating in an operational mode after training to receive information either directly or through received sensory information; and
process the received information based on the existing interconnecting relationships to influence the outcome.

11. The method of claim 10, wherein received information includes information about a surrounding environment and changes thereto.

12. The method of claim 10, wherein the received information is operable to affect the existing interconnecting relationships.

13. The method of claim 10, wherein the outcome comprises the execution of a physical action and the received information comprises a command to execute such action.

14. The method of claim 10, wherein the received information is capable of defining a situational scenario and the interconnecting relationships are capable of effecting the outcome which represents a response to such situational scenario.
